(19) United States
(12) Patent Application Publication
(10) Pub. No.: US 2019/0308181 A1
(43) Pub. Date: Oct. 10, 2019

(54) Mixed Catalyst Systems Containing Iron Tridentate Carbenes and Methods for Making Polymer Products Using Same

(71) Applicant: ExxonMobil Chemical Patents Inc., Baytown, TX (US)

(72) Inventors: Matthew W. Holtcamp, Huffman, TX (US); Subramaniam Kuppuswamy, Mont Belvieu, TX (US); Matthew S. Bedoya, Humble, TX (US)

(21) Appl. No.: 16/372,784

(22) Filed: Apr. 2, 2019

Related U.S. Application Data
(60) Provisional application No. 62/655,071, filed on Apr. 9, 2018.

(51) Int. Cl. B01J 31/22; C08F 4/60; C08F 210/02; C08F 4/02; C08F 4/602; C08F 210/16; B01J 31/18

(52) U.S. Cl. CPC B01J 31/2273; C08F 4/60144; C08F 210/02; C08F 4/025; C08F 4/6028; B01J 2231/125; C08F 4/60113; B01J 31/181; B01J 2531/842; B01J 2531/0241; C08F 210/16

(57) ABSTRACT

Disclosed herein are mixed catalyst systems including iron-containing catalyst compounds having a carbene ligand and another catalyst compound, as well as at least one activator. The iron-containing catalyst compounds can be asymmetric, while the other catalyst compound can be symmetric. In some embodiments, the other catalyst compound can be an iron-containing catalyst with a bisiminopyridyl ligand, which does not typically incorporate comonomers in copolymer synthesis. Processes for production of an ethylene alpha-olefin copolymers using these mixed catalyst systems are also disclosed. Ethylene-alpha-olefin copolymers so formed can have at least a portion of their alpha-olefin comonomer distribution increasing with increasing molecular weight, indication orthogonal compositional distribution.

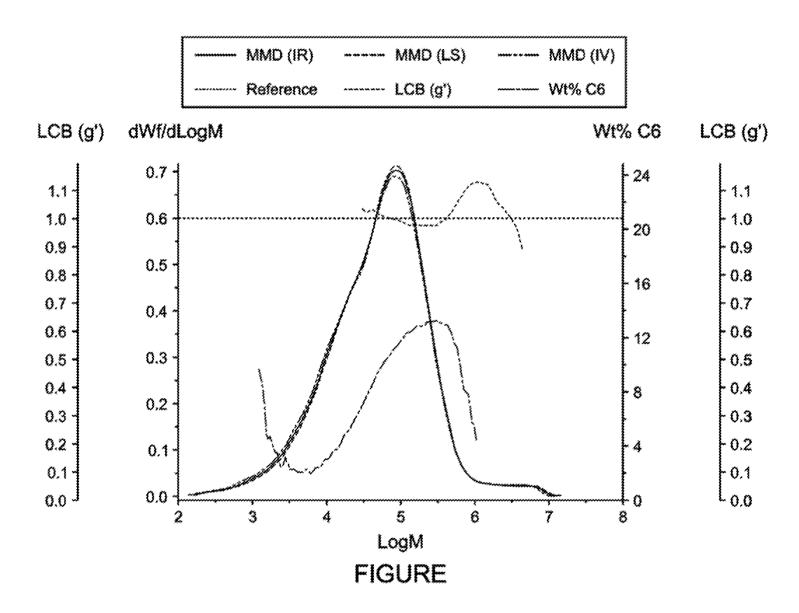

### PRIORITY CLAIM

This application claims priority to and the benefit of U.S. Ser. No. 62/655,071, filed Apr. 9, 2018 is incorporated by reference in its entirety.

### FIELD OF THE INVENTION

The present disclosure provides mixed catalyst systems involving tridentate carbene transition metal complexes as well as at least one other catalytic compound and at least one activator, and their use in processes for polymerizing olefins.

### BACKGROUND OF THE INVENTION

Polyolefins are widely used commercially because of their robust physical properties. For example, various types of polyethylenes, including high density, low density, and linear low density polyethylenes, are some of the most commercially useful. Polyolefins are typically prepared with a catalyst that polymerizes olefin monomers. Therefore, there is interest in finding new catalysts and catalyst systems that provide polymers having improved properties.

Low density polyethylene is generally prepared at high pressure using free radical initiators, or in gas phase processes using Ziegler-Natta or vanadium catalysts. Low density polyethylene typically has a density in the range of 0.916 g/cm³ to 0.950 g/cm³. Typical low density polyethylene produced using free radical initiators is known in the industry as “LDPE”. LDPE is also known as “branched” or “heterogeneously branched” polyethylene because of the relatively large number of long chain branches extending from the main polymer backbone. Polyethylene in the same density range, e.g., 0.916 g/cm³ to 0.940 g/cm³, which is linear and does not contain long chain branching, is known as “linear low density polyethylene” (“LLDPE”) and is typically produced by conventional Ziegler-Natta catalysts or with metallocene catalysts. “Linear” means that the polyethylene has few, if any, long chain branches, typically referred to as a g′ᵥᵢₛ value of 0.97 or above, such as 0.98 or above. Polyethylenes having still greater density are the high density polyethylenes (“HDPEs”), e.g., polyethylenes having densities greater than 0.940 g/cm³, and are generally prepared with Ziegler-Natta catalysts or chrome catalysts. Very low density polyethylenes (“VLDPEs”) can be produced by a number of different processes yielding polyethylenes having a density less than 0.916 g/cm³, typically 0.890 g/cm³ to 0.915 g/cm³ or 0.900 g/cm³ to 0.915 g/cm³.

Polyolefins, such as polyethylene, which have high molecular weight, generally have desirable mechanical properties over their lower molecular weight counterparts. However, high molecular weight polyolefins can be difficult to process and can be costly to produce. Polyolefin compositions having a bimodal molecular weight distribution are desirable because they can combine the advantageous mechanical properties of a high molecular weight fraction of the composition with the improved processing properties of a low molecular weight fraction of the composition. Unless otherwise indicated, as used herein, “high molecular weight” is defined as a number average molecular weight (Mn) value of 100,000 g/mol or more. “Low molecular weight” is defined as an Mn value of less than 100,000 g/mol.

Useful polyolefins, such as polyethylene, typically have a comonomer, such as hexene, incorporated into the polyethylene backbone. These copolymers provide varying physical properties compared to polyethylene alone and are typically produced in a low pressure reactor, utilizing, for example, solution, slurry, or gas phase polymerization processes. Polymerization may take place in the presence of catalyst systems such as those employing a Ziegler-Natta catalyst, a chromium based catalyst, or a metallocene catalyst. The comonomer content of a polyolefin (e.g., wt % of comonomer incorporated into a polyolefin backbone) influences the properties of the polyolefin (and composition of the copolymers) and is influenced by the polymerization catalyst. Unless otherwise indicated, as used herein, “low comonomer content” is defined as a polyolefin having less than 8 wt % of comonomer based upon the total weight of the polyolefin. As used herein, “high comonomer content” is defined as a polyolefin having greater than or equal to 8 wt % of comonomer based upon the total weight of the polyolefin.

A copolymer composition, such as a resin, has a composition distribution, which refers to the distribution of comonomer that forms short chain branches along the copolymer backbone. When the amount of short chain branches varies among the copolymer molecules, the composition is said to have a “broad” composition distribution. When the amount of comonomer per 1,000 carbons is similar among the copolymer molecules of different chain lengths, the composition distribution is said to be “narrow”.

Like comonomer content, the composition distribution influences the properties of a copolymer composition, for example, stiffness, toughness, environmental stress crack resistance, and heat sealing, among other properties. The composition distribution of a polyolefin composition may be readily measured by, for example, Temperature Rising Elution Fractionation (TREF) or Crystallization Analysis Fractionation (CRYSTAF).

Polyolefin compositions preferably have broad composition distributions that include a first polyolefin component having low molecular weight and low comonomer content while a second polyolefin component has a high molecular weight and high comonomer content. Compositions having this broad orthogonal composition distribution (BOCD) in which the comonomer is incorporated predominantly in the high molecular weight chains can provide improved physical properties, for example toughness properties and environmental stress crack resistance (ESCR).

Also, like comonomer content, a composition distribution of a copolymer composition is influenced by the identity of the catalyst used to form the polyolefins of the composition. Ziegler-Natta catalysts and chromium based catalysts generally produce compositions with broad composition distributions, whereas metallocene catalysts typically produce compositions with narrow composition distributions.

Nonetheless, polyolefin compositions formed by catalysts capable of forming high molecular weight polyolefins typically also have a broad molecular weight distribution (MWD), as indicated by high polydispersity indices, and/or the polyolefins are of such high molecular weight (e.g., Mw of 1,500,000) as to have processing difficulties due to hardness. Furthermore, catalysts capable of forming high molecular weight polyolefins typically have low activity (e.g., amount of desirable polymer produced per a period of time).

Iron-containing catalysts have been shown to be high activity catalysts capable of forming polyethylene. Typical iron-containing catalysts have a nitrogen atom of a heterocyclic moiety (such as pyridine) that chelates the iron atom. More specifically, iron-containing catalysts are typically tridentate in that they have a pyridyl ligand and two imine ligands that each chelate the iron atom. Chelation of a nitrogen atom of the pyridyl and imine ligands to the iron atom occurs via the lone pair of t-electrons on each of the nitrogen atoms. Such iron-containing catalysts, for example 2,6-bis(imino)pyridyliron(II) dihalide, typically provide low molecular weight polymers. (W. Zhang, et al., Dalton Trans., 2013, 42, pp. 8988-8997; B. L. Small, Acc. Chem. Res., 2015, 48, pp. 2599-2611). Other iron-containing catalysts include 2-[1-(2,6-dibenzhydryl-4-methylphenylimino)ethyl]-6-[1-(aryl-imino)-ethyl]pyridyl iron catalysts. Some of these catalysts have relatively high activity but produce low molecular weight polymers and don't incorporate linear alpha olefins with narrow molecular weight distribution. Other of these catalysts produce high molecular weight polymers with broad molecular weight distribution but have low activity. (Id.) Attempts to substitute the pyridyl moiety of the iron-containing catalysts with, for example, pyrrole (e.g., fluorene) or carbazole results in catalyst inactivity. (Id., at 8990.) In addition, substituting the pyridyl moiety of the iron-containing catalysts with diphenylamide or phosphinebisimine provides very low catalyst activity. (Id.) Furthermore, syntheses involving thiophene, triazine, bis(imino)diphenylether, or bis(imino)diphenylthioether (as a replacement for the pyridyl moiety) do not form iron complexes.

There is a need for iron-containing catalysts having high activity and capable of forming polyolefins, for example, with high molecular weight and high comonomer content.

References of interest include: B. L. Small, Acc. Chem. Res., 2015, 48, pp. 2599-2611; W. Zhang, et al., Dalton Trans., 2013, 42, pp. 8988-8997; U.S. Pat. Nos. 7,666,959; 8,252,875; and B. A. Schaefer, G. W. Margulieux, P. J. Chrik, Bull. Jpn. Soc. Coord. Chem., 2016, 67, pp. 19-29; B. A. Schaefer, G. W. Margulieux, M. A. Tiedemann, B. L. Small, P. J. Chrik, Organometallics, 2015, 34, pp. 5615-5623.

### SUMMARY OF THE INVENTION

The present disclosure provides processes for the production of an ethylene alpha-olefin copolymer comprising: polymerizing ethylene and at least one C₃-C₂₀ alpha-olefin by contacting the ethylene and the at least one C₃-C₂₀ alpha-olefin with a mixed catalyst system comprising at least one activator, a first catalyst compound, and a second catalyst compound different from the first catalyst compound, the polymerizing occurring in at least one gas phase reactor or at least one slurry phase at a reactor pressure of from 0.7 to 70 bar and a reactor temperature from 20° C. to 150° C. to form an ethylene alpha-olefin copolymer;

the first catalyst compound represented by Formula (I):

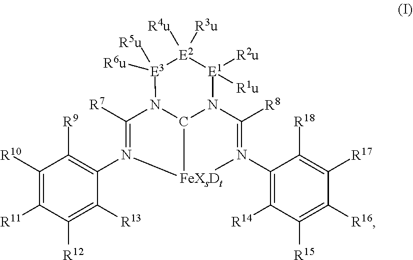

wherein:

each of R¹, R², R³, R⁴, R⁵, R⁶, R⁹, R¹⁰, R¹¹, R¹², R¹³, R¹⁴, R¹⁵, R¹⁶, R¹⁷, and R¹⁸ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, alkylaryl wherein alkyl has from 1 to 10 carbon atoms and aryl has from 6 to 20 carbon atoms, —NR′₂, —OR′, halogen, —NO₂, —SiR′₃, or five-, six-, or seven-membered heterocyclyl comprising at least one atom selected from N, P, O, and S, wherein R¹, R², R³, R⁴, R⁵, R⁶, R⁹, R¹⁰, R¹¹, R¹², R¹³, R¹⁴, R¹⁵, R¹⁶, R¹⁷, and R¹⁸ are optionally substituted by halogen, —NO₂, —CF₃, —CF₂CF₃, —CH₂CF₃, —NR′₂, —OR′, or —SiR″₃, wherein each R′ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR″₃, wherein R′ is optionally substituted by halogen, or two R′ radicals optionally bond to form a five- or six-membered ring, wherein each R″ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or two R″ radicals optionally bond to form a five- or six-membered ring;
each of R⁷ and R⁸ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or five-, six-, or seven-membered heterocyclyl comprising at least one atom selected from N, P, O, and S, wherein each of R⁷ and R⁸ is optionally substituted by halogen, —NR′₂, —OR′, or —SiR″₃, wherein R⁷ optionally bonds with R⁵ or R⁶, and R⁸ optionally bonds with R¹ or R², in each case to independently form a five-, six- or seven-membered ring;
each of E¹, E², and E³ is independently carbon, nitrogen, or phosphorus;
u is 1 for R¹u and R²u if E¹ is carbon, u is 1 for R³u and R⁴u if E² is carbon, and u is 1 for R⁵u and R⁶u if E³ is carbon;
u is 0 for R²u and 1 for R¹u if E¹ is nitrogen or phosphorus, u is 0 for R⁴u and 1 for R³u if E² is nitrogen or phosphorus, and u is 0 for R⁶u and 1 for R⁵u if E³ is nitrogen or phosphorus;

each X is independently fluorine, chlorine, bromine, iodine, hydrogen, C₁-C₂₀-alkyl, C₂-C₁₀-alkenyl, C₆-C₂₀-aryl, arylalkyl wherein alkyl has from 1 to 10 carbon atoms and aryl has from 6 to 20 carbon atoms, —NR′″₂, —OR′″, —SR′″, —SO₃R′″, —OC(O)R′″, —CN, —SCN, β-diketonate, —CO, —BF₄⁻, —PF₆⁻ or bulky non-coordinating anions, or the radicals X are bonded with one another, wherein each R′″ is independently hydrogen, C₁-C₂₀-alkyl, C₂-C₂₀-alkenyl, C₆-C₂₀-aryl, arylalkyl where alkyl has from 1 to 10 carbon atoms and aryl has from 6 to 20 carbon atoms, or —SiR″″₃, wherein R′″can be substituted by halogen or nitrogen- or oxygen-containing groups or two R′″radicals optionally bond to form a five- or six-membered ring, wherein each R″″ is independently hydrogen, C₁-C₂₀-alkyl, C₂-C₂₀-alkenyl, C₆-C₂₀-aryl or arylalkyl where alkyl has from 1 to 10 carbon atoms and aryl has from 6 to 20 carbon atoms, wherein R″″ can be substituted by halogen or nitrogen- or oxygen-containing groups or two R″″ radicals optionally bond to form a five- or six-membered ring;

s is 1, 2, or 3;

D is a neutral donor; and

t is 0, 1, or 2;

the second catalyst compound represented by formula (IV):

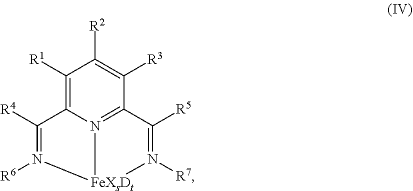

wherein:
each of R¹, R², and R³ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O and S; wherein any one or more of R¹, R², and R³ are optionally substituted by halogen, —CF₃, —CF₂CF₃, —CH₂CF₃, —NO₂, —NR′₂, —OR′, or —SiR″₃; wherein each R′ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR″₃; wherein any one or more R′ radicals is optionally substituted by halogen, or two R′ radicals optionally bond to form a five- or six-membered ring; wherein each R″ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms; wherein two R″ radicals optionally bond to form a five- or six-membered ring;

each of R⁴ and R⁵ is independently C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or five-, six-, or seven-membered heterocyclyl comprising at least one atom selected from N, P, O, and S; wherein each of R⁴ and R⁵ is optionally individually substituted by halogen, —NR′₂, —OR′, or —SiR″₃; wherein R⁴ optionally bonds with R¹, and/or wherein R⁵ optionally bonds with R³, in each case to independently form a five-, six- or seven-membered ring;

each of R⁶ and R⁷ is independently C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O and S; wherein each of R⁴ and R⁵ is optionally individually substituted by halogen, —CF₃, —CF₂CF₃, —CH₂CF₃, —NO₂, —NR′₂, —OR′, or —SiR″₃;

each X is independently fluorine, chlorine, bromine, iodine, hydrogen, C₁-C₂₀-alkyl, C₂-C₁₀-alkenyl, C₆-C₂₀-aryl, arylalkyl where alkyl has from 1 to 10 carbon atoms and aryl has from 6 to 20 carbon atoms, —NR′″₂, —OR′″, —SR′″, —SO₃R′″, —OC(O)R′″, —CN, —SCN, β-diketonate, —CO, —BF₄, —PF₆—, or bulky non-coordinating anions, wherein X radicals are optionally bonded with one another; wherein each R′″ is independently hydrogen, C₁-C₂₀-alkyl, C₂-C₂₀-alkenyl, C₆-C₂₀-aryl, arylalkyl where alkyl has from 1 to 10 carbon atoms and aryl has from 6 to 20 carbon atoms, or —SiR″″₃; wherein one or more R′″ is optionally substituted by halogen or nitrogen- or oxygen-containing groups, or two R′″radicals optionally bond to form a five- or six-membered ring; wherein each R″″ is independently hydrogen, C₁-C₂₀-alkyl, C₂-C₂₀-alkenyl, C₆-C₂₀-aryl or arylalkyl where alkyl has from 1 to 10 carbon atoms and aryl has from 6 to 20 carbon atoms; wherein one or more R″″ is optionally substituted by halogen or nitrogen- or oxygen-containing groups, or two R″″ radicals optionally bond to form a five- or six-membered ring;

s is 1, 2, or 3;

D is a neutral donor; and

t is 0, 1 or 2.

In broad terms, aspects of this invention relate to novel mixed catalyst systems, methods for polymerizing olefins comprising contacting such mixed catalyst systems including an activator with one or more monomers, and polymer compositions produced by the methods described herein, inter alia.

Further areas of applicability will become apparent from the description provided herein. The description and specific examples in this summary are intended for purposes of illustration only and are not intended to limit the scope of the present disclosure.

### BRIEF DESCRIPTION OF THE DRAWING

The FIG. shows a graphic representation of a 4D gel permeation chromatography (GPC) analysis of an ethylene-hexene copolymer formed by a mixed catalyst system, according to one embodiment.

### DETAILED DESCRIPTION

Catalyst systems of the present disclosure can be mixed, i.e., can contain two or more different catalyst compounds, a first catalyst compound and a second catalyst compound. The first catalyst compound can advantageously be an iron-containing compound having a carbene ligand, such as a bisiminocarbene. The first catalyst compound can additionally or alternatively be asymmetric with respect to ligands and/or with respect to electron donation. In some embodiments, the bisiminocarbene ligands connected to each of the imide carbons of the first catalyst can be different from each other, and/or the bisiminocarbene ligands connected to each of the imide nitrogens of the first catalyst can be different from each other. In some embodiments, all four of the bisiminocarbene ligands connected to the two imide carbons and to the two imide nitrogens of the first catalyst can be different from each other. In some embodiments, the bisiminocarbene ligands connected to the imide carbons can be electron donating on one side of the first catalyst and electron deficient on the other side of the first catalyst. The second catalyst compound may be any catalyst that is be compatible with the first catalyst compound (e.g., compatibility can be evaluated through well-known screening methods such as by ¹H or ¹³C NMR). In some embodiments, the second catalyst compound can also be an iron-containing compound, preferably a pyridyl ligand such as a bisiminopyridine. The second catalyst compound can additionally or alternatively be symmetric (e.g., with respect to ligands and electron donation). In some embodiments, catalyst systems of the present disclosure provide catalyst productivity values of 400 gPg supported cat⁻¹ hr⁻¹ or greater and can catalyze polyolefins, such as polyethylene (co)polymers, having comonomer content of 5 wt % or greater, a g′ᵥᵢₛ value of 0.95 or greater, and an orthogonal composition distribution.

The specification describes catalyst systems containing first and second catalysts that can be transition metal complexes. The term complex is used to describe molecules in which an ancillary ligand is coordinated to a central transition metal atom. The ancillary ligand is typically bulky and stably bonded to the transition metal so as to maintain its influence during use of the catalysts in the catalyst system, such as for polymerization. The ancillary ligand may be coordinated to the transition metal by covalent bond and/or electron donation coordination or intermediate bonds. The transition metal complexes are generally subjected to activation to perform their polymerization or oligomerization function using an activator which is believed to create a cation as a result of the removal of an anionic group, often referred to as a leaving group, from the transition metal.

### Definitions

As used herein, an “electron deficient side” or “electron withdrawing side” of a catalyst can be a portion of a catalyst that has one or more electron withdrawing groups (such as one, two, three, or more) such that the electron deficient side withdraws electron density toward it and away from an opposing, electron rich side of the catalyst.

As used herein, an “electron rich side” or “electron donating side” of a catalyst can be a portion of a catalyst that has one or more electron donating groups (such as one, two, three, or more) such that the electron rich side donates electron density toward an opposing, electron deficient side of the catalyst.

For the purposes of the present disclosure, the numbering scheme for the Periodic Table Groups is used as described in Chemical and Engineering News, 63(5), pg. 27 (1985). Therefore, a “Group 8 metal” is an element from Group 8 of the Periodic Table, e.g., Fe.

The following abbreviations are used through this specification: dme is 1,2-dimethoxyethane, Me is methyl, Ph is phenyl, Et is ethyl, Pr is propyl, iPr is isopropyl, n-Pr is normal propyl, cPr is cyclopropyl, Bu is butyl, iBu is isobutyl, tBu is tertiary butyl, p-tBu is para-tertiary butyl, nBu is normal butyl, sBu is sec-butyl, TMS is trimethylsilyl, TIBAL is triisobutylaluminum, TNOAL is tri(n-octyl)aluminum, MAO is methylalumoxane, p-Me is para-methyl, Ph is phenyl, Bn is benzyl (i.e., CH₂Ph), THF (also referred to as thf) is tetrahydrofuran, RT is room temperature (and is 23° C. unless otherwise indicated), tol is toluene, EtOAc is ethyl acetate, and Cy is cyclohexyl.

The term “substituted” means that at least one hydrogen atom has been replaced with at least a non-hydrogen group, such as a hydrocarbyl group, a heteroatom, or a heteroatom containing group, such as halogen (such as Br, C₁, F or I) or at least one functional group such as —NR*₂, —OR*, —SeR*, —TeR*, —PR*₂, —AsR*₂, —SbR*₂, —SR*, —BR*₂, —SIR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring.

The terms “hydrocarbyl radical,” “hydrocarbyl,” “hydrocarbyl group,” “alkyl radical,” and “alkyl” are used interchangeably throughout this disclosure. Likewise, the terms “group,” “radical,” and “substituent” are also used interchangeably in this disclosure. For purposes of this disclosure, “hydrocarbyl radical” is defined to be C₁-C₁₀₀ radicals, that may be linear, branched, or cyclic, and when cyclic, aromatic or non-aromatic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted hydrocarbyl radicals are radicals in which at least one hydrogen atom of the hydrocarbyl radical has been substituted with at least a non-hydrogen group, such as a hydrocarbyl group, a heteroatom, or a heteroatom containing group, such as halogen (such as Br, C₁, F or I) or at least one functional group such as —NR*₂, —OR*, —SeR*, —TeR*, —PR*₂, —AsR*₂, —SbR*₂, —SR*, —BR*₂, —SIR*, —SiR*₃, —GeR*, —GeR*₃, —SnR*, —SnR*₃, —PbR*₃, and the like, or where at least one heteroatom has been inserted within a hydrocarbyl ring.

The term “alkenyl” means a straight-chain, branched-chain, or cyclic hydrocarbon radical having one or more carbon-carbon double bonds. These alkenyl radicals may be substituted. Examples of suitable alkenyl radicals can include ethenyl, propenyl, allyl, 1,4-butadienyl, cyclopropenyl, cyclobutenyl, cyclopentenyl, cyclohexenyl, cyclooctenyl, and the like including their substituted analogues.

The term “arylalkenyl” means an aryl group where a hydrogen has been replaced with an alkenyl or substituted alkenyl group. For example, styryl indenyl is an indene substituted with an arylalkenyl group (a styrene group).

The term “alkoxy,” “alkoxyl,” or “alkoxide” means an alkyl ether or aryl ether radical wherein the term alkyl is as defined above. Examples of suitable alkyl ether radicals can include methoxy, ethoxy, n-propoxy, iso-propoxy, n-butoxy, iso-butoxy, sec-butoxy, tert-butoxy, phenoxy, and the like.

The term “aryl” or “aryl group” means a carbon-containing aromatic ring and the substituted variants thereof can include phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

The term “arylalkyl” means an aryl group where a hydrogen has been replaced with an alkyl or substituted alkyl group. For example, 3,5′-di-tert-butyl-phenyl indenyl is an indene substituted with an arylalkyl group.

The term “alkylaryl” means an alkyl group where a hydrogen has been replaced with an aryl or substituted aryl group. For example, phenethyl indenyl is an indene substituted with an ethyl group bound to a benzene group.

Reference to an alkyl, alkenyl, alkoxide, or aryl group without specifying a particular isomer (e.g., butyl) expressly discloses all isomers (e.g., n-butyl, iso-butyl, sec-butyl, and tert-butyl), unless otherwise indicated.

The term “ring atom” means an atom that is part of a cyclic ring structure. Accordingly, a benzyl group has six ring atoms and tetrahydrofuran has 5 ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

For purposes of the present disclosure, a “catalyst system” is a combination of at least one catalyst compound, an activator, and an optional support material. The catalyst systems may further comprise one or more additional catalyst compounds. For the purposes of the present disclosure, when catalyst systems are described as comprising neutral stable forms of the components, it is well understood by one of ordinary skill in the art, that the ionic form of the component is the form that reacts with the monomers to produce polymers. Catalysts represented by Formula (I), Formula (II), and Formula (III) of the present disclosure are intended to embrace ionic (e.g., cationic) forms, alkyl migration products, and neutral radical anionic products (see B. A. Schaefer, G. W. Margulieux, P. J. Chrik, Bull. Jpn. Soc. Coord. Chem., 2016, 67, 19-29; B. A. Schaefer, G. W. Margulieux, M. A. Tiedemann, B. L. Small, P. J. Chrik, Organometallics, 2015, 34, 5615-5623) thereof of the compounds in addition to the neutral forms of the compounds.

“Neutral radical anionic product” is a neutral complex containing a radical anion (e.g., a radical anion may reside on the ligand structure).

“Complex” as used herein, is also often referred to as catalyst precursor, precatalyst, catalyst, catalyst compound, transition metal compound, or transition metal complex. These words are used interchangeably. Activator and cocatalyst are also used interchangeably.

A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In some embodiments, a co-activator can be pre-mixed with the transition metal compound to form an alkylated transition metal compound.

Noncoordinating anion (NCA) means an anion either that does not coordinate to the catalyst metal cation or that does coordinate to the metal cation, but only weakly. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. An NCA coordinates weakly enough that a neutral Lewis base, such as an olefinically or acetylenically unsaturated monomer can displace it from the catalyst center. Any metal or metalloid that can form a compatible, weakly coordinating complex may be used or contained in the noncoordinating anion. Suitable metalloids can include boron, aluminum, phosphorus, and silicon. The term non-coordinating anion activator includes neutral activators, ionic activators, and Lewis acid activators.

In the description herein, a catalyst may be described as a catalyst precursor, a precatalyst compound, catalyst compound or a transition metal compound, and these terms are used interchangeably. A polymerization catalyst system is a catalyst system that can polymerize monomers into polymer. An “anionic ligand” is a negatively charged ligand which donates one or more pairs of electrons to a metal ion. A “neutral donor ligand” is a neutrally charged ligand which donates one or more pairs of electrons to a metal ion.

A metallocene catalyst is defined as an organometallic compound with at least one t-bound cyclopentadienyl moiety or substituted cyclopentadienyl moiety (such as indene or fluorine, and substituted variants thereof) and more frequently two t-bound cyclopentadienyl moieties or substituted cyclopentadienyl moieties (such as indene or fluorine, and substituted variants thereof).

For purposes of the present disclosure, in relation to catalyst compounds, the term “substituted” means that a hydrogen group has been replaced with a hydrocarbyl group, a heteroatom, or a heteroatom containing group. For example, methyl phenyl is a phenyl group substituted with a methyl group.

“Catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat⁻¹ hr⁻¹. “Conversion” is the amount of monomer that is converted to polymer product, and is reported as mol % and is calculated based on the polymer yield and the amount of monomer fed into the reactor. “Catalyst activity” is a measure of the level of activity of the catalyst and is reported as the mass of product polymer (P) produced per mole (or mmol) of catalyst (cat) used (kgP/molcat or gP/mmolCat), and catalyst activity can also be expressed per unit of time, for example, per hour (hr).

For purposes herein an “olefin,” alternatively referred to as “alkene,” is a linear, branched, or cyclic compound comprising carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have a “propylene” content of 35 wt % to 55 wt %, it is understood that the mer unit in the copolymer is derived from propylene in the polymerization reaction and the derived units are present at 35 wt % to 55 wt %, based upon the weight of the copolymer.

For purposes herein a “polymer” has two or more of the same or different monomer (“mer”) units. A “homopolymer” is a polymer having mer units that are the same. A “copolymer” is a polymer having two or more mer units that are different from each other. A “terpolymer” is a polymer having three mer units that are different from each other. “Different” in reference to mer units indicates that the mer units differ from each other by at least one atom or are different isomerically. Accordingly, copolymer, as used herein, can include terpolymers and the like. An oligomer is typically a polymer having a low molecular weight, such an Mn of less than 25,000 g/mol, or less than 2,500 g/mol, or a low number of mer units, such as 75 mer units or less or 50 mer units or less. An “ethylene polymer” or “ethylene copolymer” or “polyethylene” is a polymer or copolymer comprising at least 50 mole % ethylene derived units, a “propylene polymer” or “propylene copolymer” or “polypropylene” is a polymer or copolymer comprising at least 50 mole % propylene derived units, and so on.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn.

The term “continuous” means a system that operates without interruption or cessation for a period of time, preferably where reactants are continually fed into a reaction zone and products are continually or regularly withdrawn without stopping the reaction in the reaction zone. For example, a continuous process to produce a polymer would be one where the reactants are continually introduced into one or more reactors and polymer product is continually withdrawn.

A “solution polymerization” means a polymerization process in which the polymerization is conducted in a liquid polymerization medium, such as an inert solvent or monomer(s) or their blends. A solution polymerization is typically homogeneous. A homogeneous polymerization is one where the polymer product is dissolved in the polymerization medium. Such systems are preferably not turbid as described in J. Vladimir Oliveira, C. Dariva and J. C. Pinto, Ind. Eng. Chem. Res., 2000, 39, 4627-4633.

A bulk polymerization means a polymerization process in which the monomers and/or comonomers being polymerized are used as a solvent or diluent using little or no other inert solvent or diluent. A small fraction of inert solvent might be used as a carrier for catalyst and scavenger. A bulk polymerization system contains less than about 25 wt % of inert solvent or diluent, such as less than about 10 wt %, such as less than about 1 wt %, such as 0 wt %.

### Mixed Catalyst Systems

In preferred embodiments, two or more different catalyst compounds may be present in the catalyst system used herein. In preferred embodiments, two or more different catalyst compounds are present in the reaction zone where the process(es) described herein occur. When two transition metal based (metallocene) catalysts are used in one reactor as a mixed catalyst system, the first and second catalyst compounds can preferably be chosen to be compatible. It is preferable to use the same activator for the first and second catalyst compounds; however, two different activators, such as a non-coordinating anion activator and an alumoxane, can be used in combination, if desired.

The first and second catalyst compounds (pre-catalysts) in the mixed catalyst systems according to the present disclosure may be used in any ratio. Preferred molar ratios of (A) first catalyst compound(s) to (B) second catalyst compound(s) fall within the range of (A:B) 1:1000 to 1000:1, e.g., 1:100 to 500:1, 1:10 to 200:1, 1:1 to 100:1, 1:1 to 75:1, or 5:1 to 50:1. The particular ratio chosen can depend inter alia on the exact pre-catalysts chosen, the method of activation, and the end product desired. In a particular embodiment, when using the two different types of pre-catalysts, where both are activated with the same activator, useful mole percents, based upon the molecular weight of the pre-catalysts, can be 10 to 99.9% A to 0.1 to 90% B, e.g., 25 to 99% A to 0.5 to 75% B, 50 to 99% A to 1 to 50% B, or 75 to 99% A to 1 to 25% B.

### First Catalyst Compound(s) (A)

The initial part to a catalyst system described herein is a first catalyst compound. The first catalyst compound used in the process of the present disclosure for making oligomeric or polymeric products generally is an iron-containing catalyst that may be asymmetric and/or that may have a carbene ligand such as a bisiminocarbene, as represented by formula (I) below:

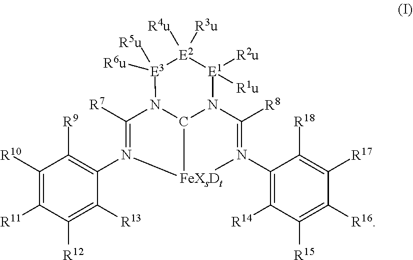

In formula (I), each of R¹, R², R³, R⁴, R⁵, R⁶, R⁹, R¹⁰, R¹¹, R¹², R¹³, R¹⁴, R¹⁵, R¹⁶, R¹⁷ and R¹⁸ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O and S; in some embodiments, any one or more of R¹, R², R³, R⁴, R⁵, R⁶, R⁹, R¹⁰, R¹¹, R¹², R¹³, R¹⁴, R¹⁵, R¹⁶, R¹⁷, and R¹⁸ can optionally be substituted by halogen, —CF₃, —CF₂CF₃, —CH₂CF₃, —NO₂, —NR′₂, —OR′, or —SiR″₃.

If any R′ moieties are present in formula (I), each R′ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR″₃; in some embodiments any one or more R′ radicals can be optionally substituted by halogen, or two R′ radicals can optionally bond to form a (five- or six-membered) ring. If any R″ moieties are present in formula (I), each R″ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms; in some embodiments, two R″ radicals can optionally bond to form a (five- or six-membered) ring.

In formula (I), R⁷ and R⁸ represent moieties (or ligands) bonded to the imine carbons; in a preferred embodiment, they are asymmetric in composition (i.e., not the same; and they are optionally also asymmetric with respect to electron donation/withdrawal). Each of R⁷ and R⁸ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or five-, six-, or seven-membered heterocyclyl comprising at least one atom selected from N, P, O, and S; in some embodiments, each of R⁷ and R⁸ may optionally be individually substituted by halogen, —NR′₂, —OR′, or —SiR″₃. In some embodiments, R⁷ may optionally bond with R⁵ or R⁶, and/or R⁸ may optionally bond with R¹ or R², in each case to independently form a (five-, six- or seven-membered) ring.

In formula (I), each of E¹, E², and E³ can independently be carbon, nitrogen, or phosphorus. In some embodiments, u is 1 for R¹u and R²u if E¹ is carbon, u is 1 for R³u and R⁴u if E² is carbon, and u is 1 for R⁵u and R⁶u if E³ is carbon. In some embodiments, u is 0 for R²u and 1 for R¹u if E¹ is nitrogen or phosphorus, u is 0 for R⁴u and 1 for R³u if E² is nitrogen or phosphorus, and u is 0 for R⁶u and 1 for R⁵u if E³ is nitrogen or phosphorus. In some embodiments, each of E¹, E², and E³ is carbon, u is 1 for R¹u, R²u, R³u, R⁴u, R⁵u, and R⁶u. In some embodiments, each of R¹, R², R³, R⁴, R⁵, and R⁶ can independently be hydrogen or C₁-C₂₂-alkyl (e.g., is hydrogen).

In formula (I), each X can independently be a halogen (e.g., fluorine, chlorine, bromine, or iodine), hydrogen, C₁-C₂₀-alkyl, C₂-C₁₀-alkenyl, C₆-C₂₀-aryl, arylalkyl where alkyl has from 1 to 10 carbon atoms and aryl has from 6 to 20 carbon atoms, —NR′″₂, —OR′″, —SR′″, —SO₃R′″, —OC(O)R′″, —CN, —SCN, β-diketonate, —CO, —BF₄, —PF₆, or bulky non-coordinating anions, and the X radicals can optionally be bonded with one another. In some embodiments, each X can independently be fluorine, chlorine, bromine, iodine, or C₁-C₂₀-alkyl (e.g., methyl, ethyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, or sec-decyl).

If any R′″moieties are present in formula (I), each R′″can independently be hydrogen, C₁-C₂₀-alkyl, C₂-C₂₀-alkenyl, C₆-C₂₀-aryl, arylalkyl where alkyl has from 1 to 10 carbon atoms and aryl has from 6 to 20 carbon atoms, or —SiR″″₃; in some embodiments, one or more R′″can be substituted by halogen or nitrogen- or oxygen-containing groups, or two R′″radicals can optionally bond to form a (five- or six-membered) ring. If any R″″ moieties are present in formula (I), each R″″ can independently be hydrogen, C₁-C₂₀-alkyl, C₂-C₂₀-alkenyl, C₆-C₂₀-aryl or arylalkyl where alkyl has from 1 to 10 carbon atoms and aryl has from 6 to 20 carbon atoms; in some embodiments, one or more R″″ can be substituted by halogen or nitrogen- or oxygen-containing groups, or two R″″ radicals can optionally bond to form a (five- or six-membered) ring.

In formula (I), s is 1, 2, or 3, D is a neutral donor, and t is 0, 1 or 2. Preferably, t is 0, in which case D is absent. In at least one embodiment, D is a neutral donor such as a neutral Lewis base or Lewis acid, for example, amines, alcohols, ethers, ketones, aldehydes, esters, sulfides or phosphines, which can be bonded with the iron center or can still be contained in the complex as residual solvent from the preparation of the iron complexes.

Without being bound by theory, it is thought that the carbon atom (of the pyrimidine ring between the two nitrogens) bonded to the iron atom can be in the form of divalent carbon (carbene) with a lone pair of electrons that, when bound to the iron atom, can be stabilized by the nitrogen atoms in the alpha positions relative to the carbon atom. σ-orbital electrons of the carbene carbon can donate electron density to the metal center, unlike the weak σ-donation and t-acceptor character of pyridyl-based iron complexes.

In some embodiments, the first catalyst compound used in the process of the present disclosure for making oligomeric or polymeric products can be an iron-containing catalyst alternatively represented by formula (Ia) below:

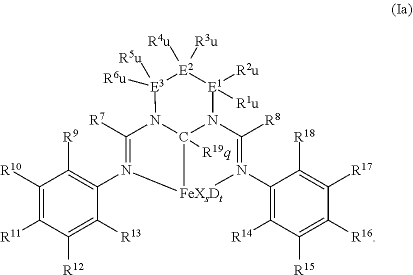

In formula (Ia), each of the moieties can be as in formula (I), except the carbene carbon in the pyrimdinyl ring can be bonded to R¹⁹q. In formula (Ia), R¹⁹ can be a C₁-C₂₀ alkyl, and q can be 1 or 0. If q is 1, R¹⁹ can preferably be methyl.

In some embodiments, the first catalyst compound represented by formula (I) or formula (Ia) has an electron donating side. In such electron donating side embodiments, each of R⁹, R¹⁰, R¹¹, R¹², and R¹³ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, —SiR″₃, or five-, six-, or seven-membered heterocyclyl comprising at least one atom selected from N, P, O, and S. In such electron donating side embodiments, each of R⁹, R¹⁰, R¹¹, R¹², and R¹³ can preferably and independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or alkylaryl where alkyl has from 1 to 10 carbon atoms and aryl has from 6 to 20 carbon atoms. In some such electron donating side embodiments, one or more of R⁹, R¹⁰, R¹¹, R¹², and R¹³ can be substituted by —NR′₂, —OR′, or —SiR″₃.

In such electron donating side embodiments, R⁷ can be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or five-, six-, or seven-membered heterocyclyl comprising at least one atom selected from N, P, O, and S; in some such electron donating side embodiments, R⁷ can optionally be substituted by —NR′₂, —OR′, or —SiR″₃. In some such electron donating side embodiments, R⁷ can be phenyl or C₁-C₁₀-alkyl (e.g., methyl, ethyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, or sec-decyl). In at least one embodiment, R⁷ is methyl.

In some additional or alternative embodiments, the catalyst represented by formula (I) or formula (Ia) has an electron withdrawing side. In such electron withdrawing side embodiments, each of R¹⁴, R¹⁵, R¹⁶, R¹⁷ and R¹⁸ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃, or five-, six-, or seven-membered heterocyclyl comprising at least one atom selected from N, P, O, and S. In such electron withdrawing side embodiments, one or more of R¹⁴, R¹⁵, R¹⁶, R¹⁷, and R¹⁸ can be independently substituted by —NO₂, —CF₃, —CF₂CF₃, —CH₂CF₃, halogen, —NR′₂, —OR′, or —SiR″₃. In such electron withdrawing side embodiments, each of R¹⁴, R¹⁵, R¹⁶, R¹⁷, and R¹⁸ can preferably and independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or alkylaryl where alkyl has from 1 to 10 carbon atoms and aryl has from 6 to 20 carbon atoms; in some such electron withdrawing side embodiments, at least one of R¹⁴, R¹⁵, R¹⁶, R¹⁷, and R¹⁸ can be substituted by —NO₂, —CF₃, —CF₂CF₃, —CH₂CF₃, halogen, —NR′₂, —OR′, or —SiR″₃ (where R′ and R″ are as defined above). In some such electron withdrawing side embodiments, at least one of R¹⁴, R¹⁵, R¹⁶, R¹⁷, and R¹⁸ can be halogen or C₁-C₂₂-alkyl substituted with one or more halogen atoms. In some such electron withdrawing side embodiments, each of R¹⁴, R¹⁵, R¹⁶, R¹⁷, and R¹⁸ can be halogen or trihalomethyl, such as trichloromethyl or trifluoromethyl.

In such electron withdrawing side embodiments, R⁸ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, or five-, six- or seven-membered heterocyclyl comprising at least one atom selected from N, P, O, and S; in some such electron withdrawing side embodiments, R⁸ can optionally be substituted by —NO₂, —CF₃, —CF₂CF₃, —CH₂CF₃, halogen, —NR′₂, —OR′, or —SiR″₃ (where R′ and R″ are as defined above). In some such electron withdrawing side embodiments, R⁸ is C₆-aryl substituted with one, two, three, four, or five halogen atoms, such as fluorine or chlorine. In some such electron withdrawing side embodiments, R⁸ is arylalkyl substituted with one, two, three, four, or five halogen atoms (the substitutions occurring on the aryl and or the alkyl of the arylalkyl). In some such electron withdrawing side embodiments, R⁸ is -Ph(X)ₙ, where each X is independently haloalkyl, such as trichloromethyl or trifluoromethyl, n is 0, 1, 2, 3, 4, or 5, and Ph is phenyl. In preferred embodiments of formula (I) and/or formula (Ia), R⁷ and R⁸ are not both methyl at the same time as all four of R⁹, R¹³, R¹⁴, and R¹⁸ are methyl or isopropyl.

In some embodiments, the first catalyst compound used in the process of the present disclosure for making oligomeric or polymeric products can be an iron-containing catalyst alternatively represented by formula (II) below:

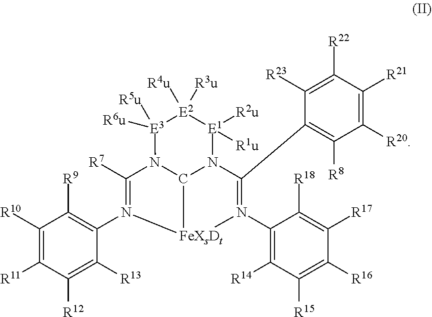

In formula (II), each of the moieties can be as in formula (I), except that the R⁸ moiety in formula (I) is replaced with a phenyl radical having pendant moieties R⁸, R²⁰, R²¹, R²², and R²³. In formula (II), each of R⁸, R²⁰, R²¹, R²², and R²³ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O, and S; in some embodiments of formula (II), one or more of R⁸, R²⁰, R²¹, R²², and R²³ can optionally be substituted by halogen, —NO₂, —CF₃, —CF₂CF₃, —CH₂CF₃, —NR′₂, —OR′, or —SiR″₃.

In some embodiments, the first catalyst compound represented by formula (II) has an electron donating side. In such electron donating side embodiments, each of R⁹, R¹⁰, R¹¹, R¹², and R¹³ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, —SiR″₃, or five-, six-, or seven-membered heterocyclyl comprising at least one atom selected from N, P, O, and S. In such electron donating side embodiments, each of R⁹, R¹⁰, R¹¹, R¹², and R¹³ can preferably and independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or alkylaryl where alkyl has from 1 to 10 carbon atoms and aryl has from 6 to 20 carbon atoms. In some such electron donating side embodiments, one or more of R⁹, R¹⁰, R¹¹, R¹², and R¹³ can be substituted by —NR′₂, —OR′, or —SiR″₃.

In such electron donating side embodiments, R⁷ can be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or five-, six-, or seven-membered heterocyclyl comprising at least one atom selected from N, P, O, and S; in some such electron donating side embodiments, R⁷ can optionally be substituted by —NR′₂, —OR′, or —SiR″₃. In some such electron donating side embodiments, R⁷ can be phenyl or C₁-C₁₀-alkyl (e.g., methyl, ethyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, or sec-decyl). In some embodiments, R⁷ is methyl. In some embodiments, R⁷ is substituted phenyl represented by the structure:

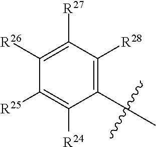

where each of R²⁴, R²⁵, R²⁶, R²⁷, and R²⁸ can independently be hydrogen, C₁-C₁₀-alkyl, —OR′, where R′ is hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR″₃; in some such embodiments, each of R²⁴, R²⁵, R²⁶, R²⁷, and R²⁸ can independently be hydrogen or C₁-C₁₀-alkyl (e.g., methyl, ethyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, or sec-decyl).

In some additional or alternative embodiments, the catalyst represented by formula (II) has an electron withdrawing side. In such electron withdrawing side embodiments, each of R⁸, R¹⁴, R¹⁵, R¹⁶, R¹⁷, R¹⁸, R²⁰, R²¹, R²², and R²³ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃, or five-, six-, or seven-membered heterocyclyl comprising at least one atom selected from N, P, O, and S. In such electron withdrawing side embodiments, one or more of R⁸, R¹⁴, R¹⁵, R¹⁶, R¹⁷, R¹⁸, R²⁰, R²¹, R²², and R²³ can be independently substituted by —NO₂, —CF₃, —CF₂CF₃, —CH₂CF₃, halogen, —NR′₂, —OR′, or —SiR″₃. In such electron withdrawing side embodiments, each of R⁸, R¹⁴, R¹⁵, R¹⁶, R¹⁷, R¹⁸, R²⁰, R²¹, R²², and R²³ can preferably and independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or alkylaryl where alkyl has from 1 to 10 carbon atoms and aryl has from 6 to 20 carbon atoms; in some such electron withdrawing side embodiments, at least one of R⁸, R¹⁴, R¹⁵, R¹⁶, R¹⁷, R¹⁸, R²⁰, R²¹, R²², and R²³ can be substituted by —NO₂, —CF₃, —CF₂CF₃, —CH₂CF₃, halogen, —NR′₂, —OR′, or —SiR″₃ (where R′ and R″ are as defined above). In some such electron withdrawing side embodiments, at least one of R⁸, R¹⁴, R¹⁵, R¹⁶, R¹⁷, R¹⁸, R²⁰, R²¹, R²², and R²³ can be hydrogen, halogen or C₁-C₂₂-alkyl substituted with one or more halogen atoms. In some such electron withdrawing side embodiments, each of R⁸, R¹⁴, R¹⁵, R¹⁶, R¹⁷, R¹⁸, R²⁰, R²¹, R²², R²³ can be hydrogen, C₁-C₁₀ alkyl, halogen, or trihalomethyl, such as trichloromethyl or trifluoromethyl. In some such electron withdrawing side embodiments, each of R⁸, R²⁰, R²¹, R²², and R²³ can be halogen or trihalomethyl, such as trichloromethyl or trifluoromethyl, and each of R¹⁴, R¹⁵, R¹⁶, R¹⁷, and R¹⁸ can be hydrogen, C₁-C₁₀ alkyl, or halogen. In some such electron withdrawing side embodiments, at least one of R⁸, R²⁰, R²¹, R²², and R²³ can be halogen or trihalomethyl, such as trichloromethyl or trifluoromethyl, and at least one of R¹⁴, R¹⁵, R¹⁶, R¹⁷, and R¹⁸ can be C₁-C₁₀ alkyl or halogen.

In some embodiments, the first catalyst compound used in the process of the present disclosure for making oligomeric or polymeric products can be an iron-containing catalyst alternatively represented by formula (III) below:

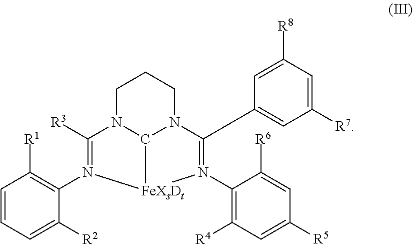

In formula (III), each of the moieties can be as in formula (II), except that there are fewer variable pendant moieties, and the variable pendant moieties that remain have been renumbered. In formula (III), each of R¹, R², R⁴, R⁵, R⁶, R⁷, and R⁸ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃, or five-, six-, or seven-membered heterocyclyl comprising at least one atom selected from N, P, O and S; in some embodiments, R¹, R², R⁴, R⁵, R⁶, R⁷, and R^{s} can optionally be substituted by halogen, —NO₂, —CF₃, —CF₂CF₃, —CH₂CF₃, —NR′₂, —OR′, or —SiR″₃.

In formula (III), R³ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or five-, six-, or seven-membered heterocyclyl comprising at least one atom selected from N, P, O, and S; in some embodiments, R³ can optionally be substituted by halogen, —NR′₂, —OR′, or —SiR″₃; in some embodiments, R³ can optionally bond with the carbon at the 4-position (which can also be numbered as the 6-position) of the bisimino(carbene) ring to form a (five-, six-, or seven-membered) ring.

In formula (III), each X can independently be a halogen (e.g., fluorine, chlorine, bromine, or iodine), hydrogen, C₁-C₂₀-alkyl, C₂-C₁₀-alkenyl, C₆-C₂₀-aryl, arylalkyl where alkyl has from 1 to 10 carbon atoms and aryl has from 6 to 20 carbon atoms, —NR′″₂, —OR′″, —SR′″, —SO₃R′″, —OC(O)R′″, —CN, —SCN, β-diketonate, —CO, —BF₄, —PF₆, or bulky non-coordinating anions, and the X radicals can optionally be bonded with one another. In some embodiments, each X can independently be fluorine, chlorine, bromine, iodine, or C₁-C₂₀-alkyl (e.g., methyl, ethyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, or sec-decyl).

In some embodiments, the first catalyst compound represented by formula (III) has an electron donating side. In such electron donating side embodiments, each of R¹ and R² can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, —SiR″₃, or five-, six-, or seven-membered heterocyclyl comprising at least one atom selected from N, P, O and S. In such electron donating side embodiments, each of R¹ and R² can preferably and independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or alkylaryl where alkyl has from 1 to 10 carbon atoms and aryl has from 6 to 20 carbon atoms. In some such electron donating side embodiments, R¹ and R² can be substituted by —NR′₂, —OR′, or —SiR″₃.

In such electron donating side embodiments, R³ can be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or five-, six-, or seven-membered heterocyclyl comprising at least one atom selected from N, P, O, and S; in some such electron donating side embodiments, R⁷ can optionally be substituted by —NR′₂, —OR′, or —SiR″₃. In such electron donating side embodiments, R³ can be substituted or unsubstituted phenyl or C₁-C₁₀-alkyl (e.g., methyl, ethyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, or sec-decyl). In at least one embodiment, R³ is methyl. In at least one embodiment, R³ is substituted phenyl represented by the structure:

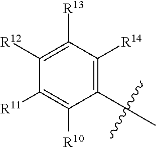

where each of R¹⁰, R¹¹, R¹², R¹³, and R¹⁴ can be independently hydrogen, C₁-C₁₀-alkyl, —OR′, where R′ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR″₃; in such embodiments, R′ can optionally be substituted by halogen, or two R′ radicals can optionally bond to form a (five- or six-membered) ring. In some such embodiments, each of R¹, R¹¹, R¹², R¹³, and R¹⁴ can independently be hydrogen or C₁-C₁₀-alkyl (e.g., methyl, ethyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, or sec-decyl).

In some additional or alternative embodiments, the catalyst represented by formula (II) has an electron withdrawing side. In such electron withdrawing side embodiments, each of R⁴, R⁵, R⁶, R⁷, and R⁸ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃, or five-, six-, or seven-membered heterocyclyl comprising at least one atom selected from N, P, O, and S; in some such electron withdrawing side embodiments, R⁴, R⁵, R⁶, R⁷, and R⁸ can be independently substituted by —NO₂, —CF₃, —CF₂CF₃, —CH₂CF₃, halogen, —NR′₂, —OR′, or —SiR″₃. In such electron withdrawing side embodiments, each of R⁴, R⁵, R⁶, R⁷, and R⁸ can preferably and independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or alkylaryl where alkyl has from 1 to 10 carbon atoms and aryl has from 6 to 20 carbon atoms; in some such electron withdrawing side embodiments, at least one of R⁴, R⁵, R⁶, R⁷, and R⁸ can be substituted by —NO₂, halogen, —NR′₂, —OR′, or —SiR″₃. In some embodiments, R⁴, R⁵, R⁶, R⁷, and R⁸ can independently be halogen, hydrogen, or C₁-C₂₂-alkyl substituted with one or more halogen atoms. In some embodiments, each of R⁴, R⁵, R⁶, R⁷, and R⁸ can be C₁-C₁₀ alkyl, halogen, or trihalomethyl, such as trichloromethyl or trifluoromethyl. In some embodiments, each of R⁷ and R⁸ can be halogen or trihalomethyl, such as trichloromethyl or trifluoromethyl, and each of R⁴, R⁵, and R⁶ can be hydrogen, C₁-C₁₀ alkyl, or halogen. In some embodiments, each of R⁷ and R⁸ can be halogen or trihalomethyl, such as trichloromethyl or trifluoromethyl, and each of R⁴, R⁵, and R⁶ can be C₁-C₁₀ alkyl or halogen.

In some preferred embodiments, the first catalyst compound represented by formula (I), formula (II), or formula (III) can be one or more of the following.

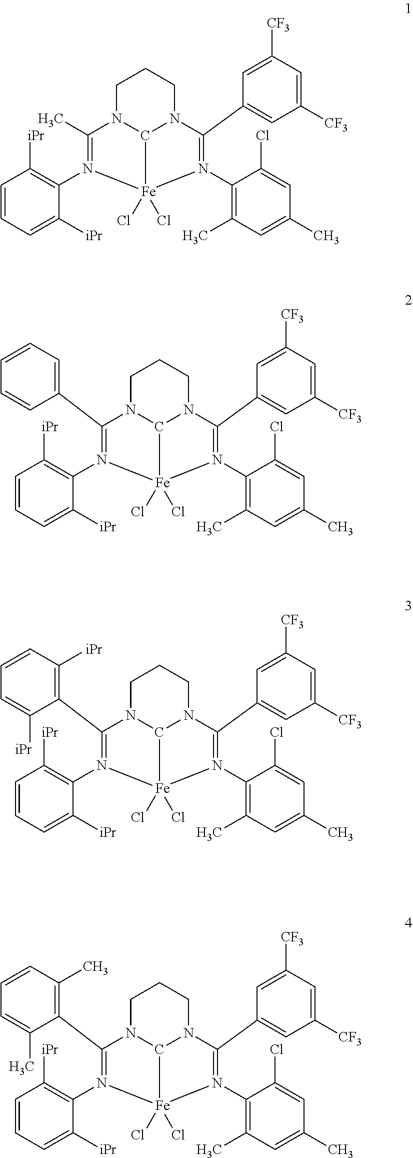

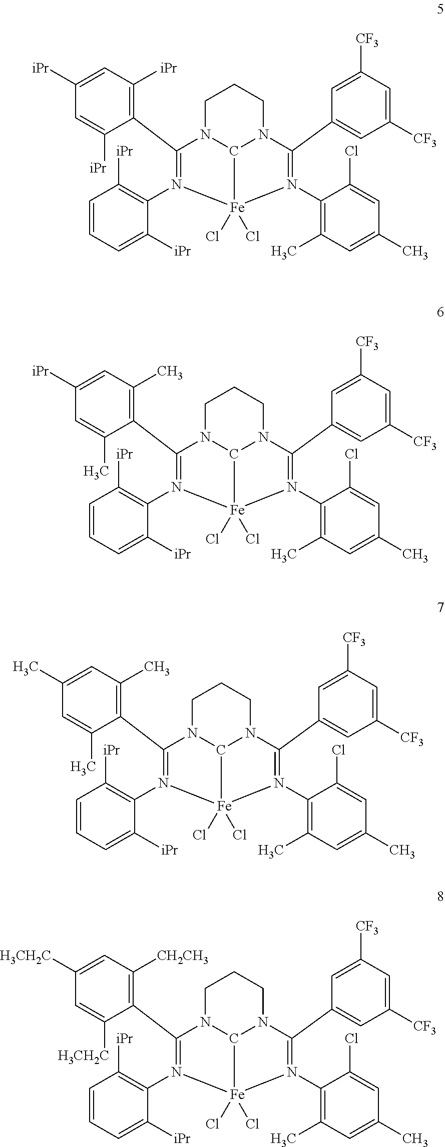

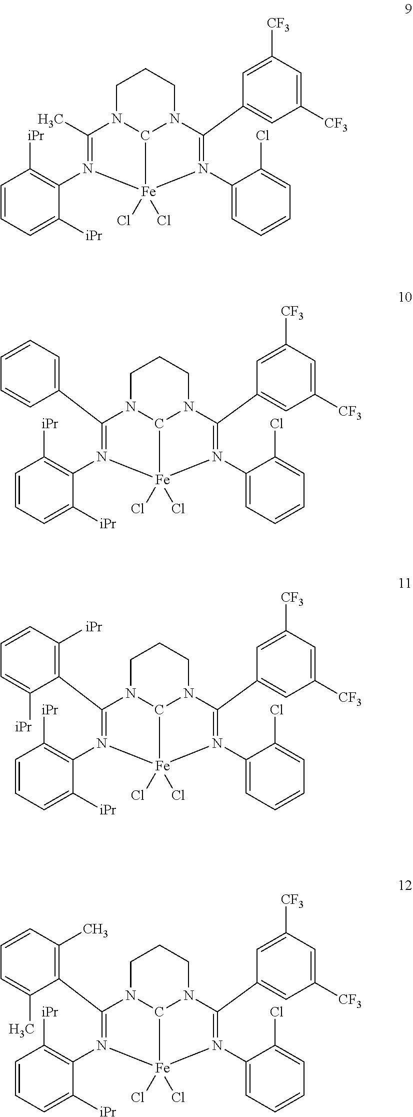

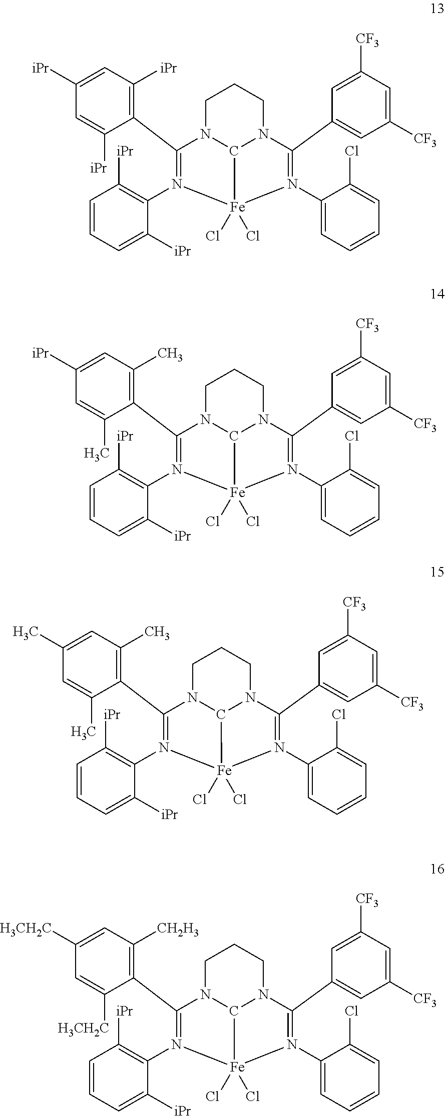

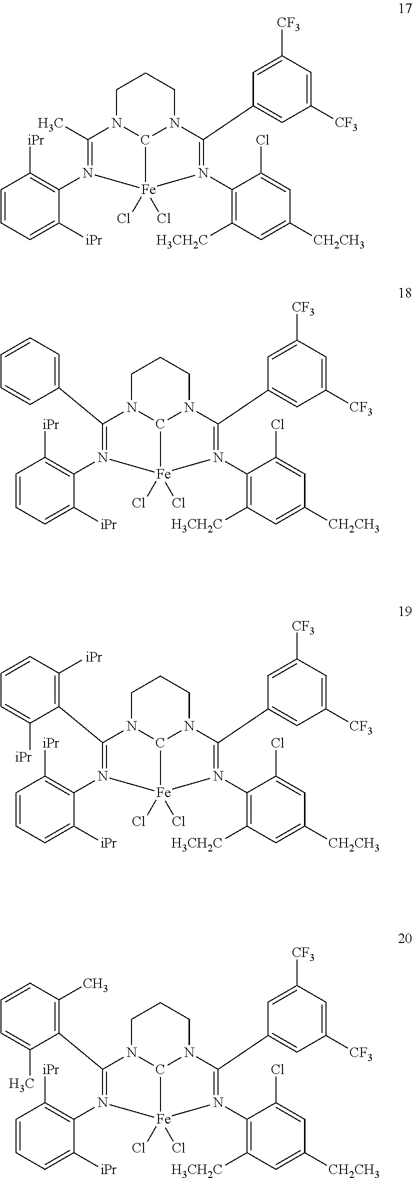

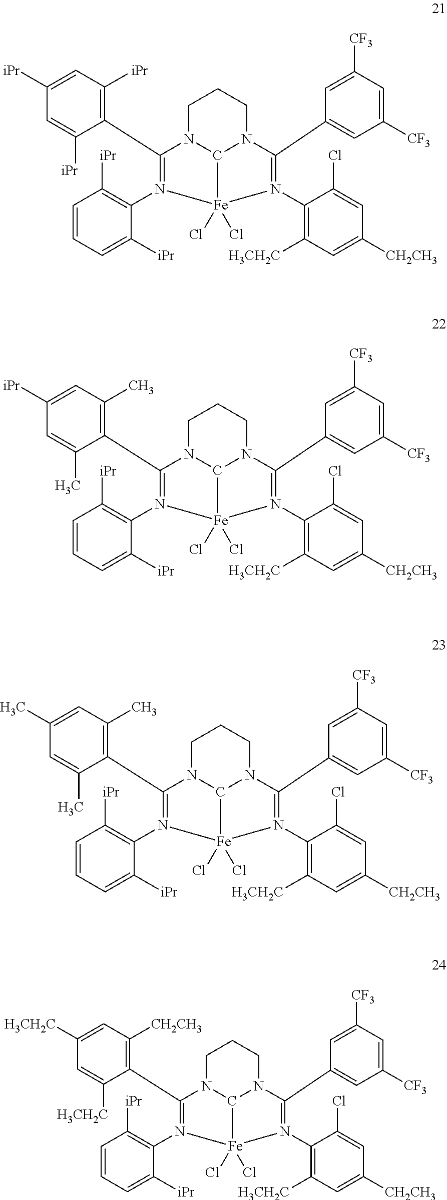

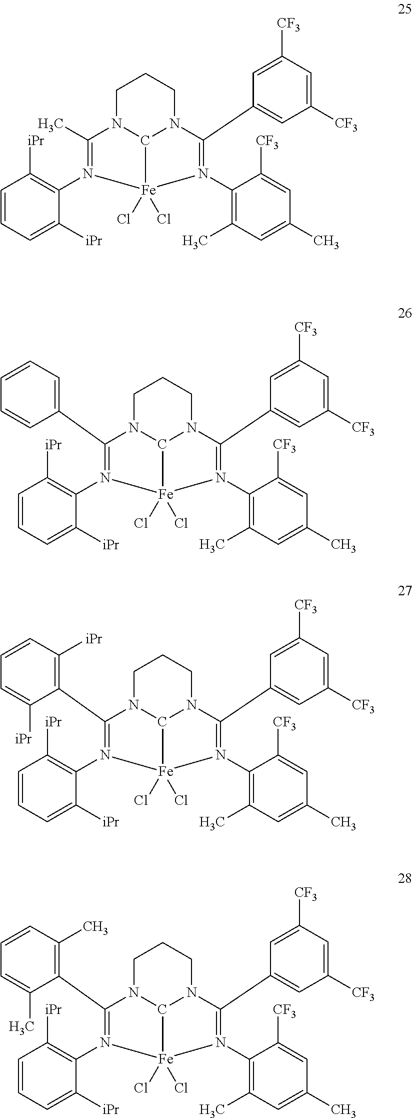

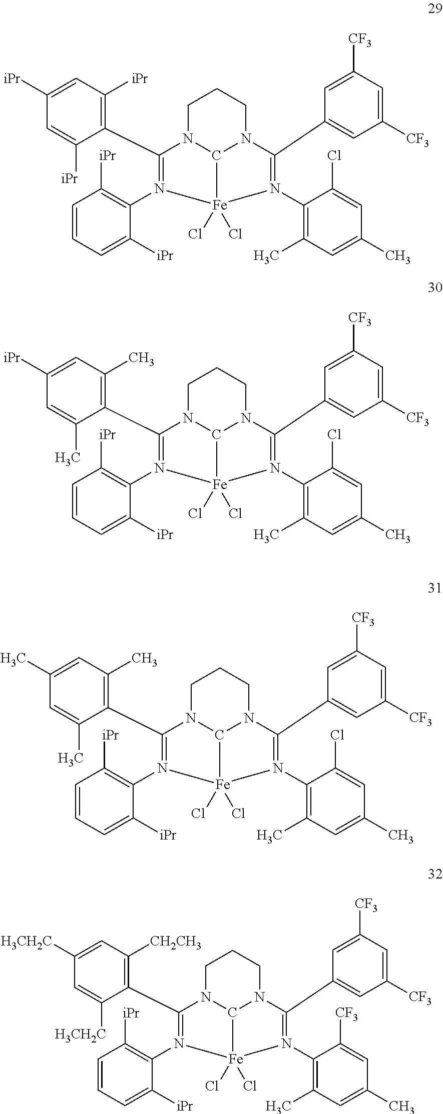

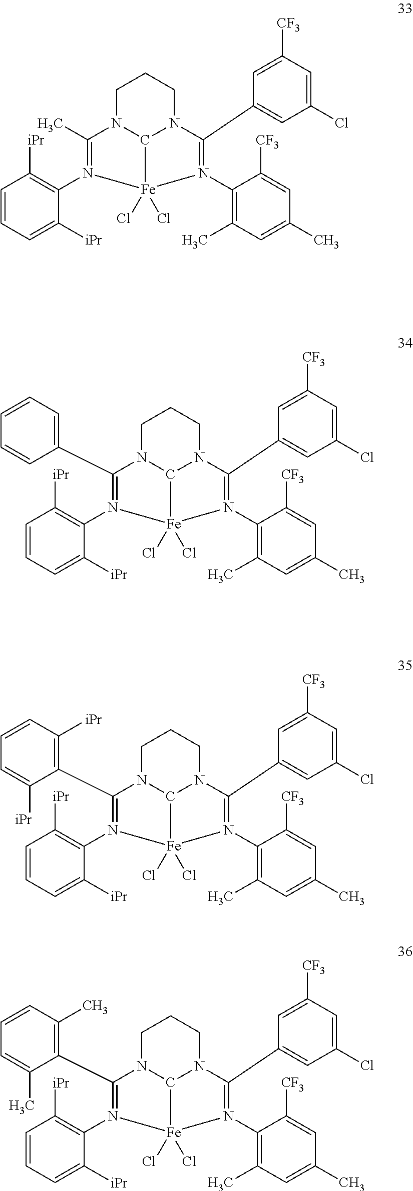

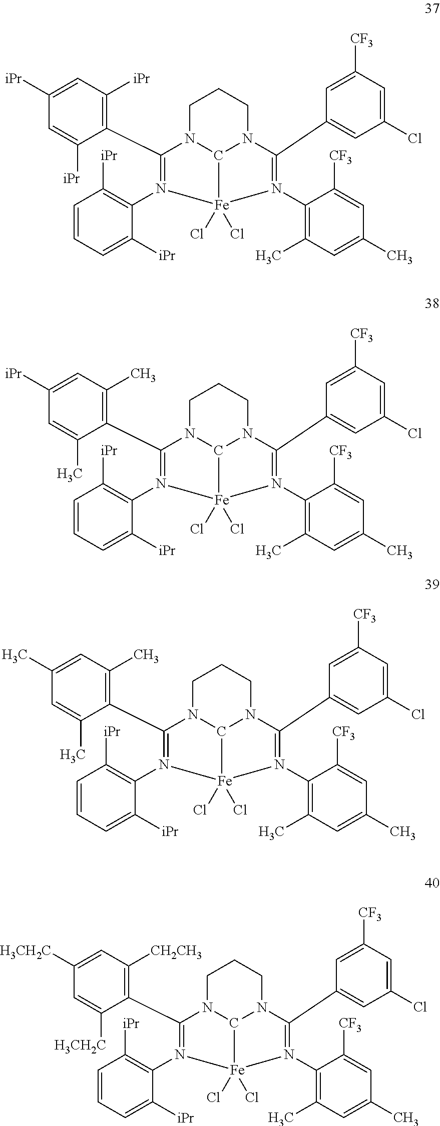

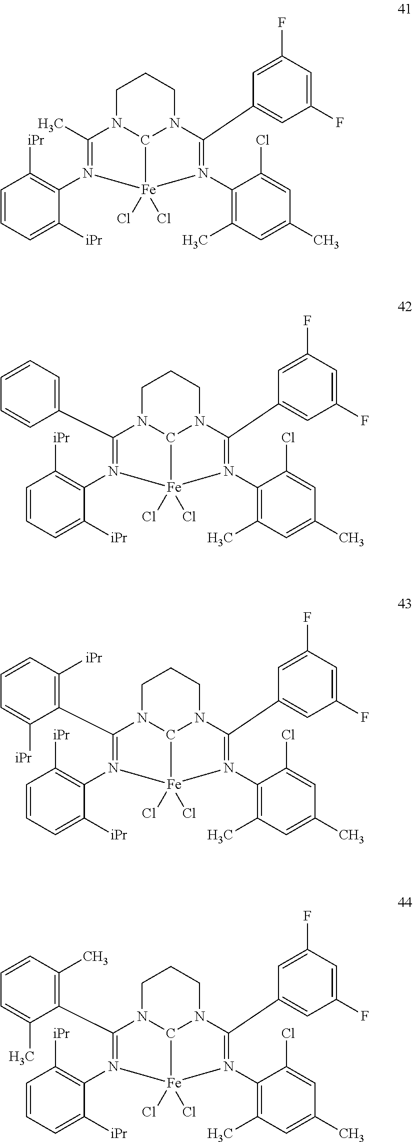

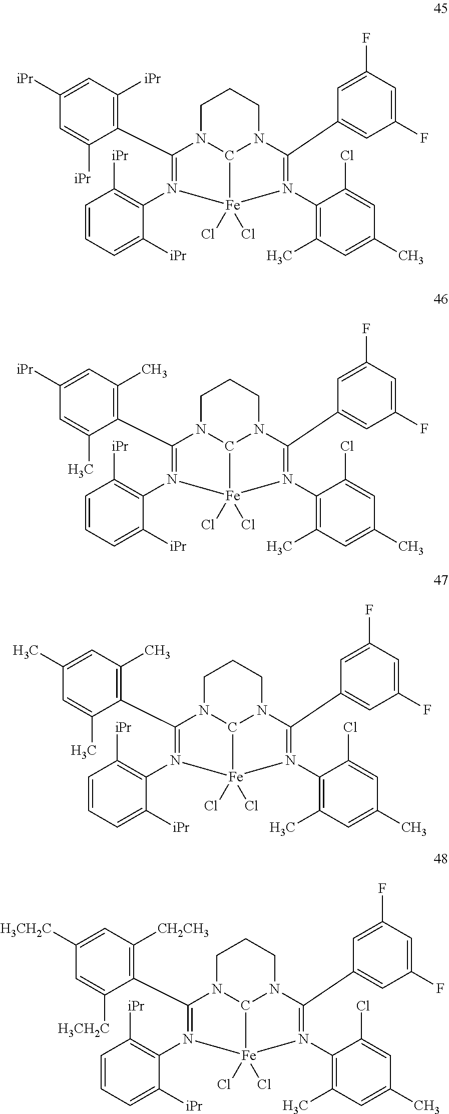

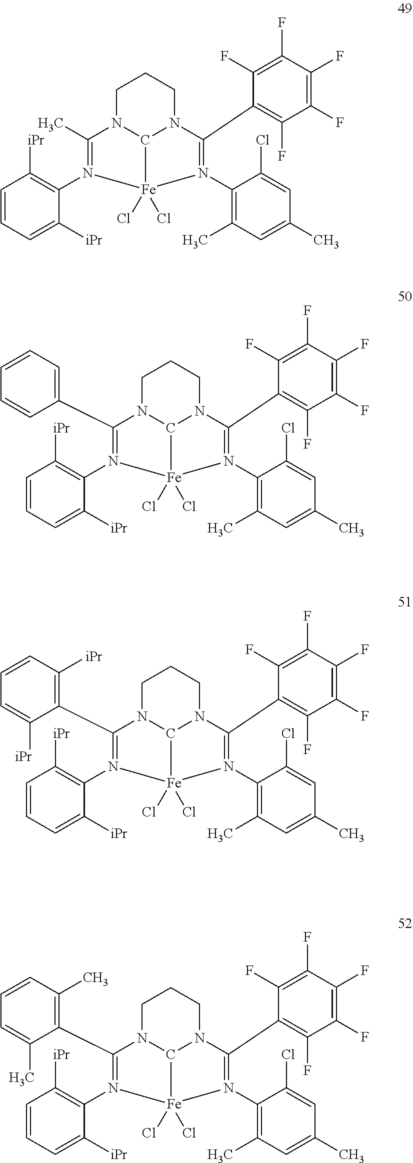

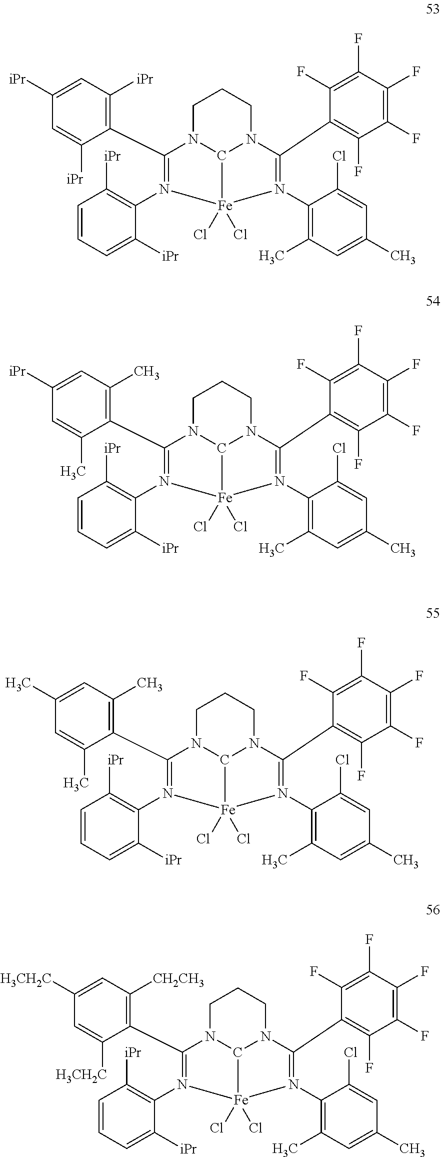

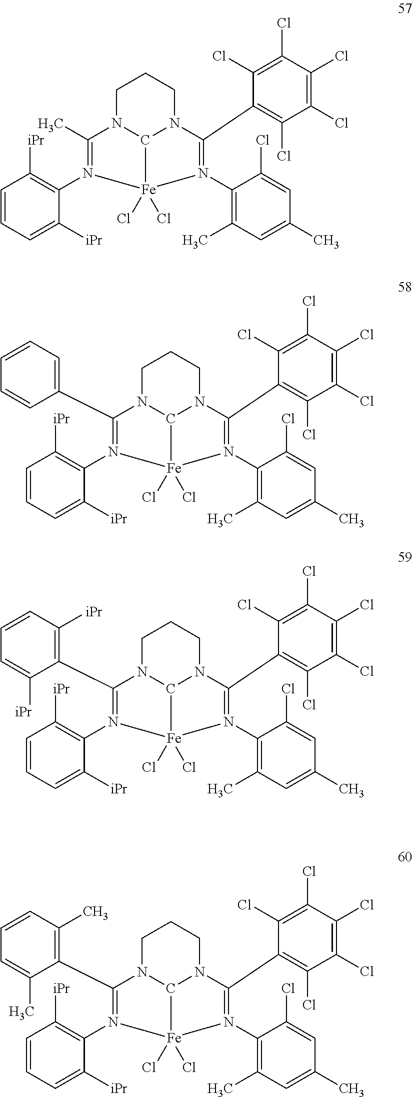

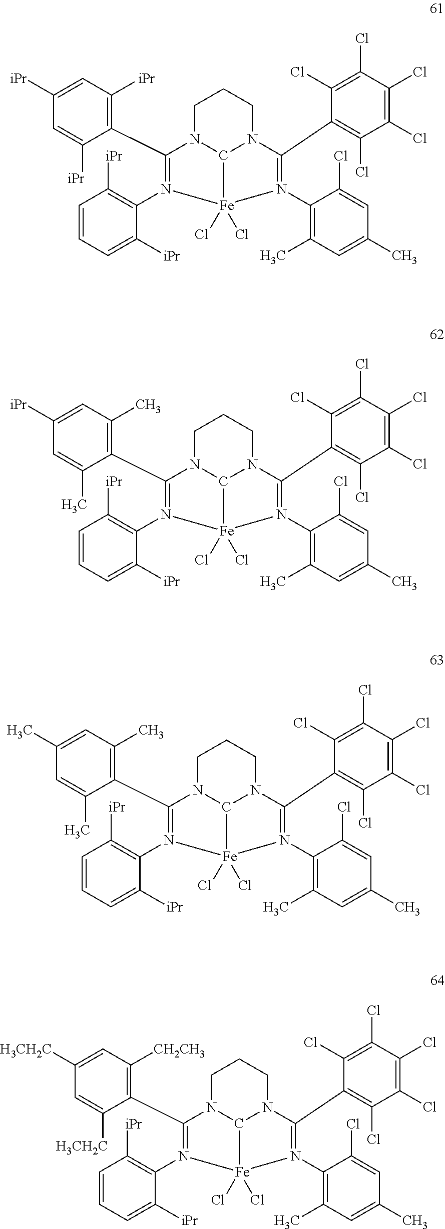

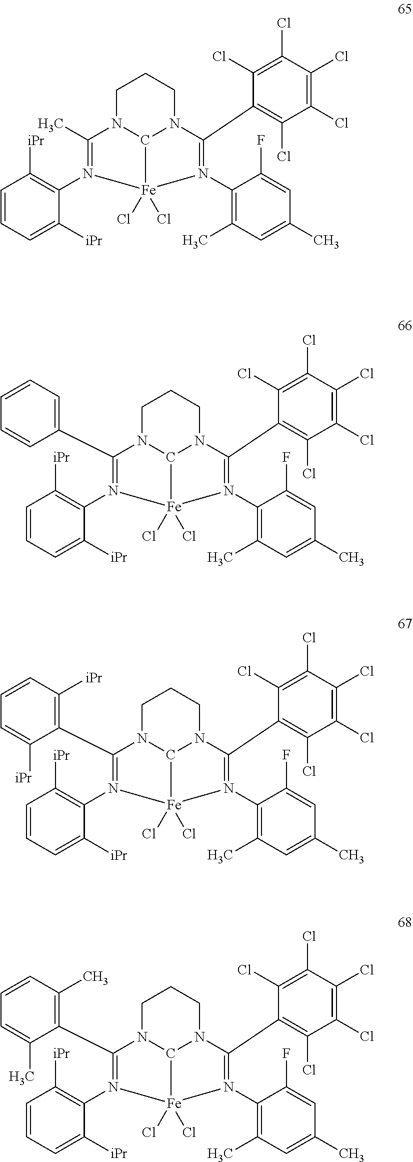

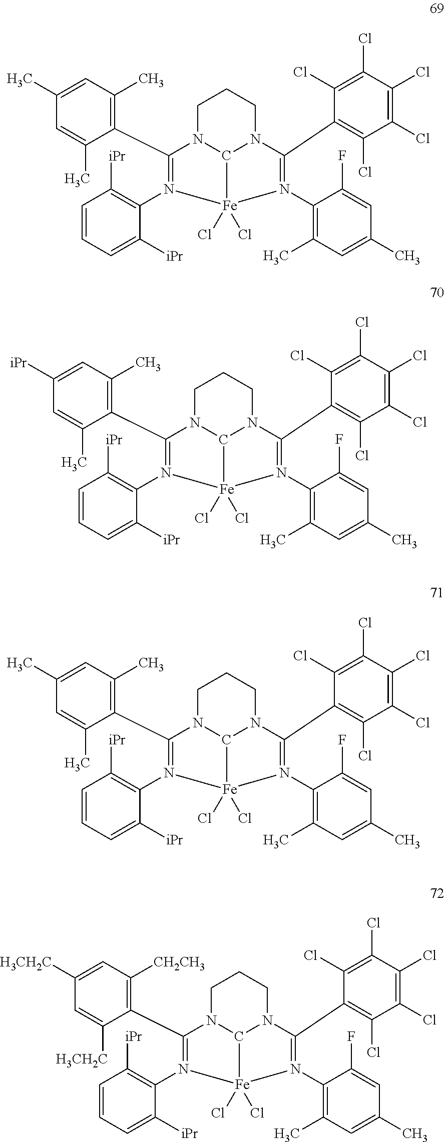

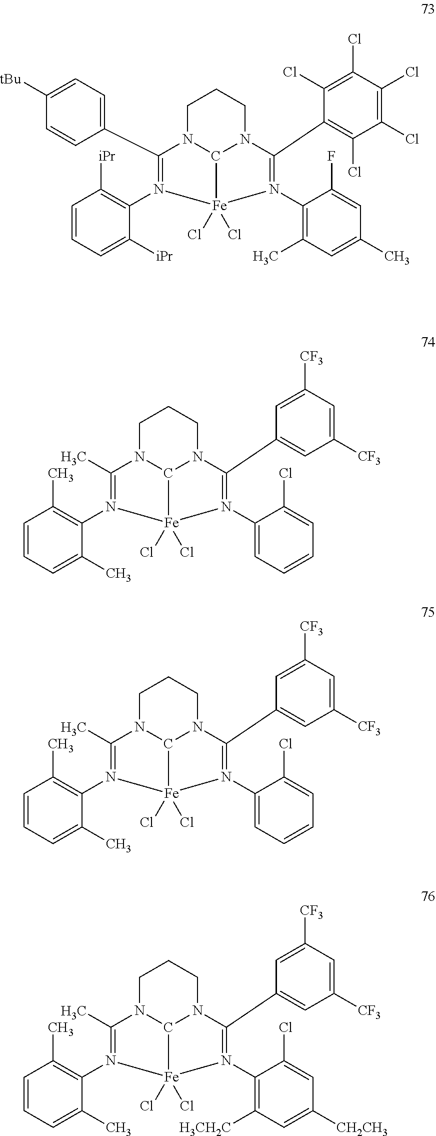

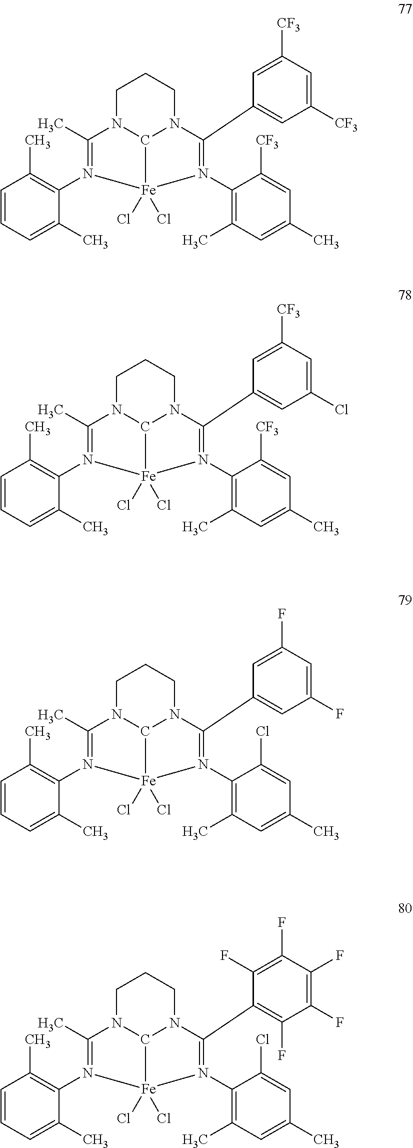

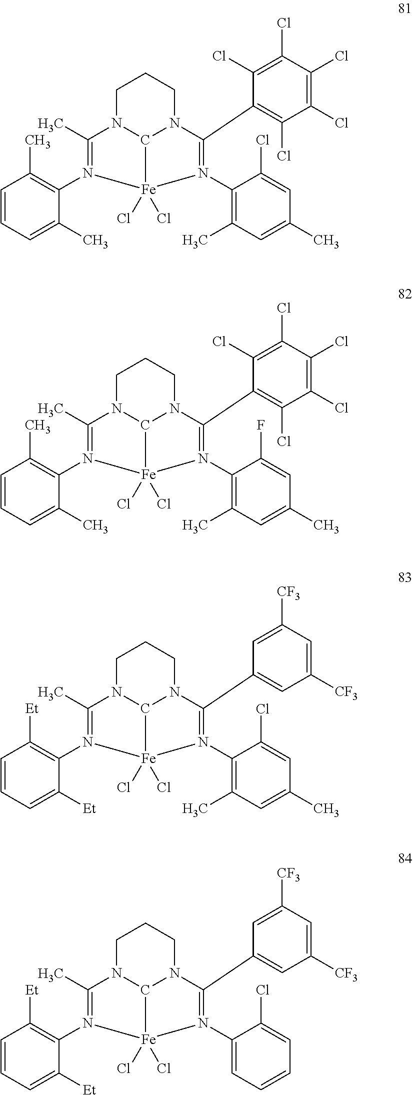

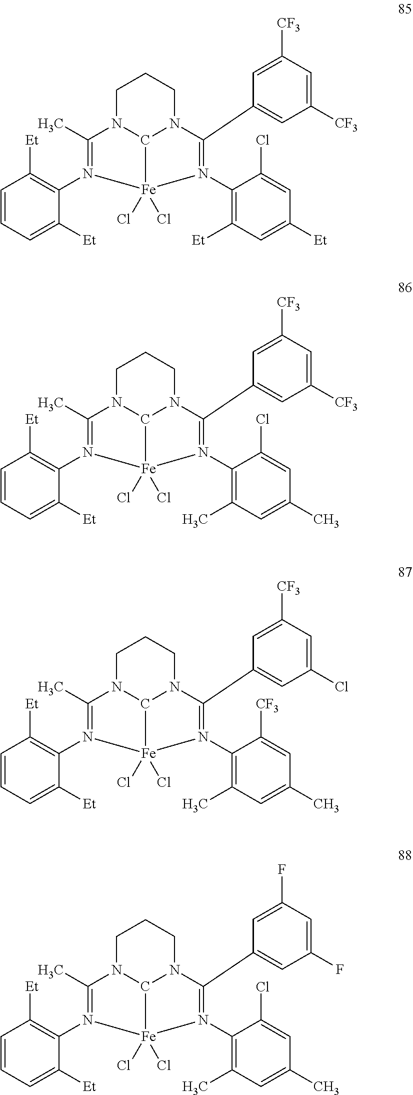

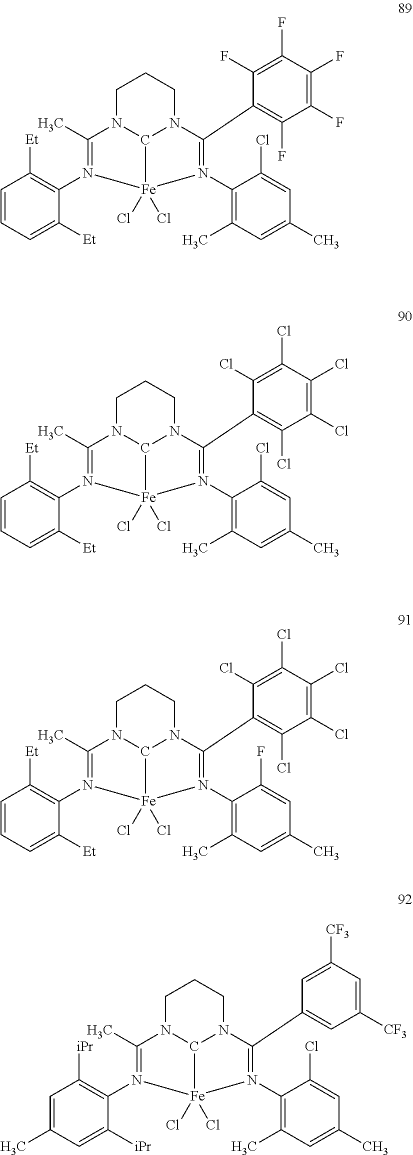

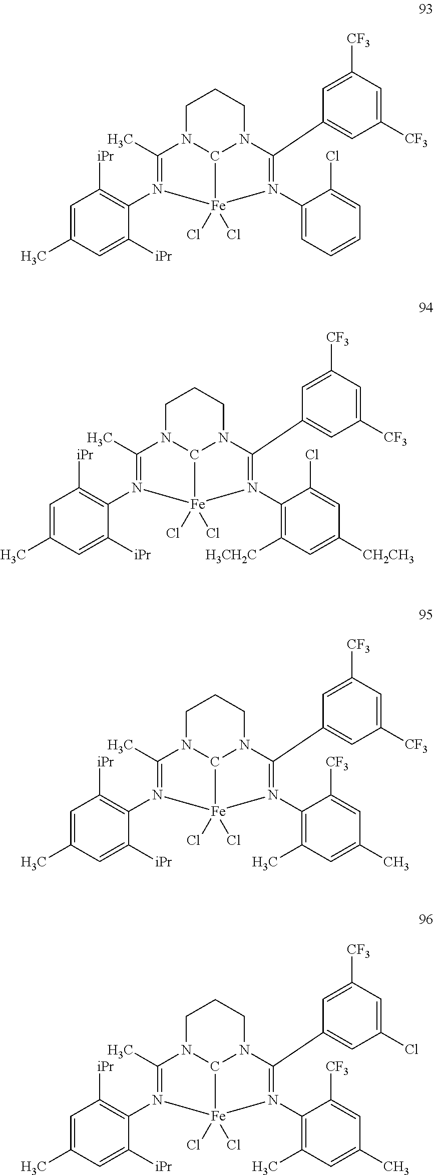

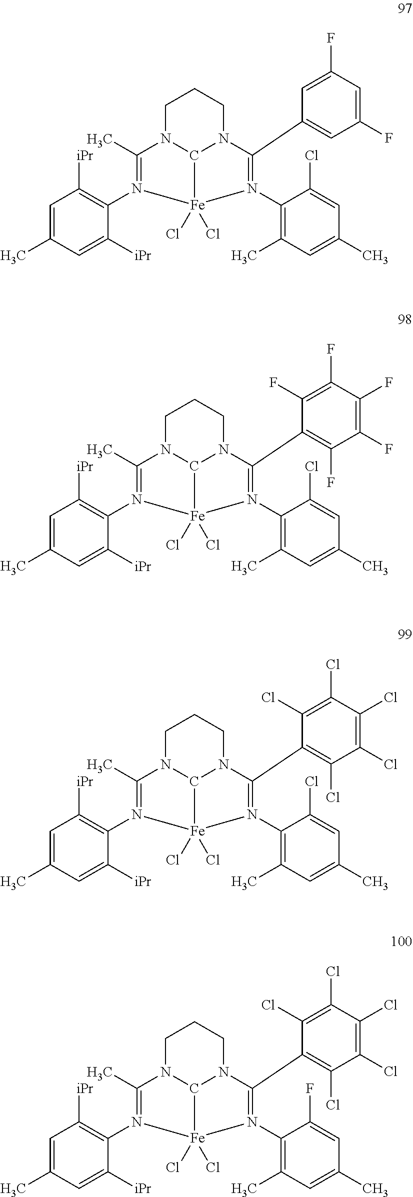

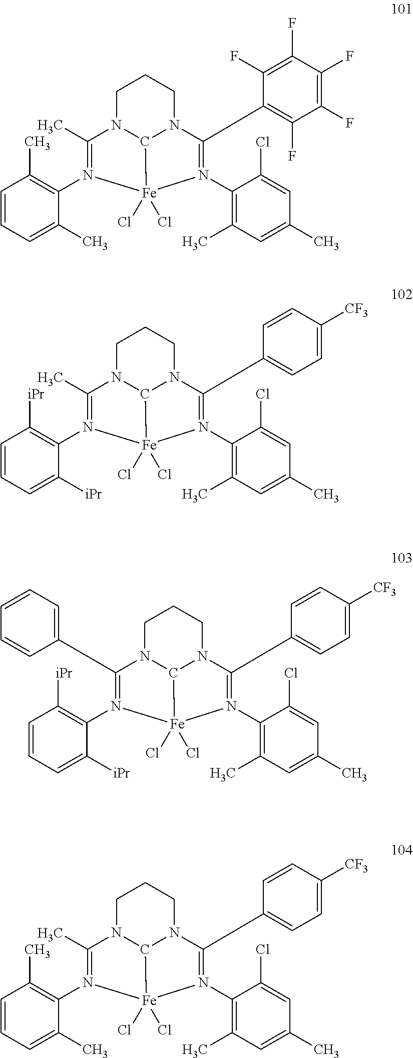

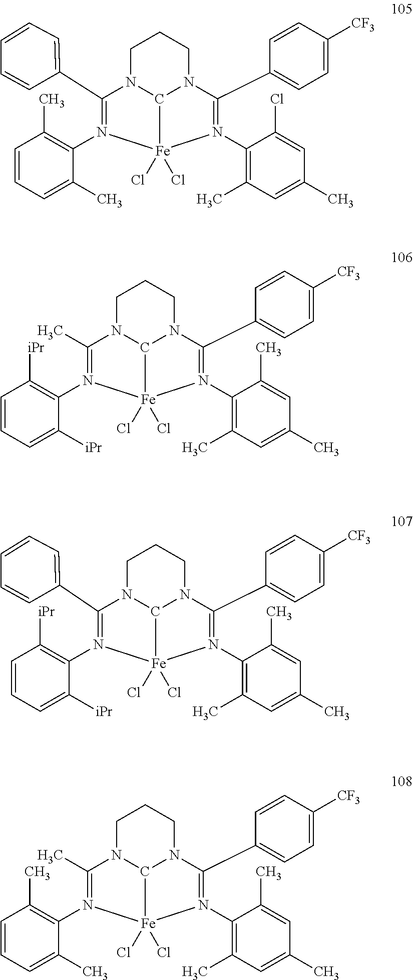

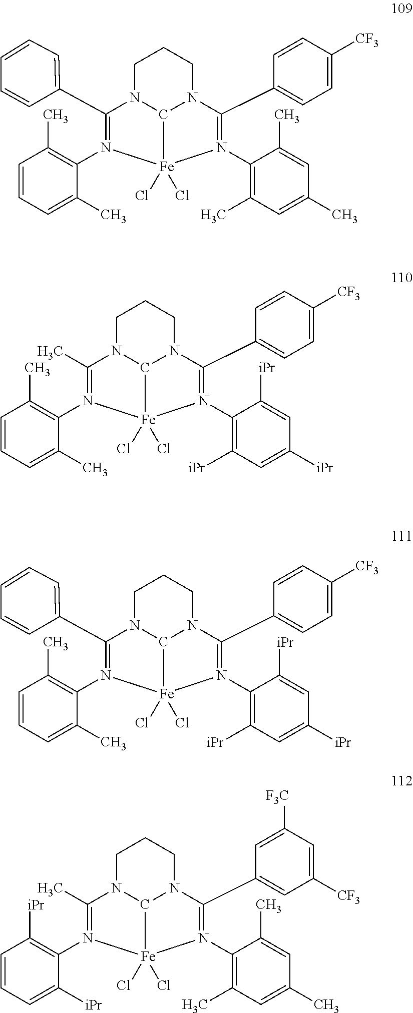

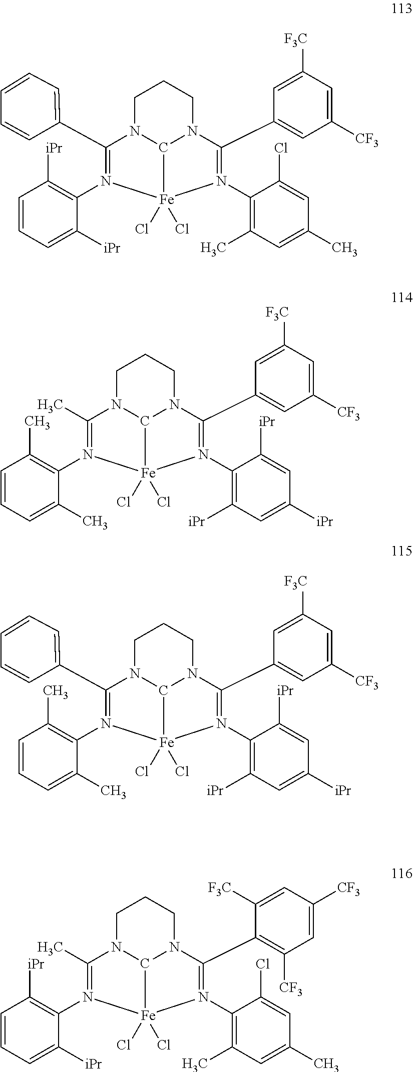

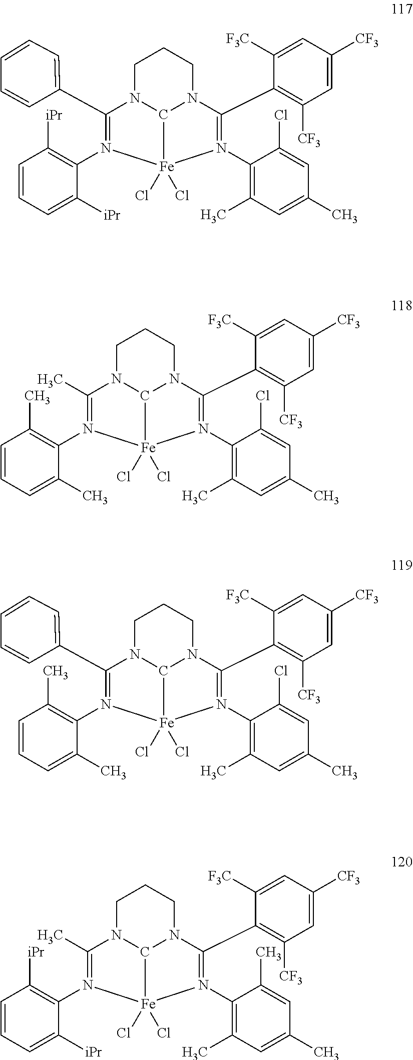

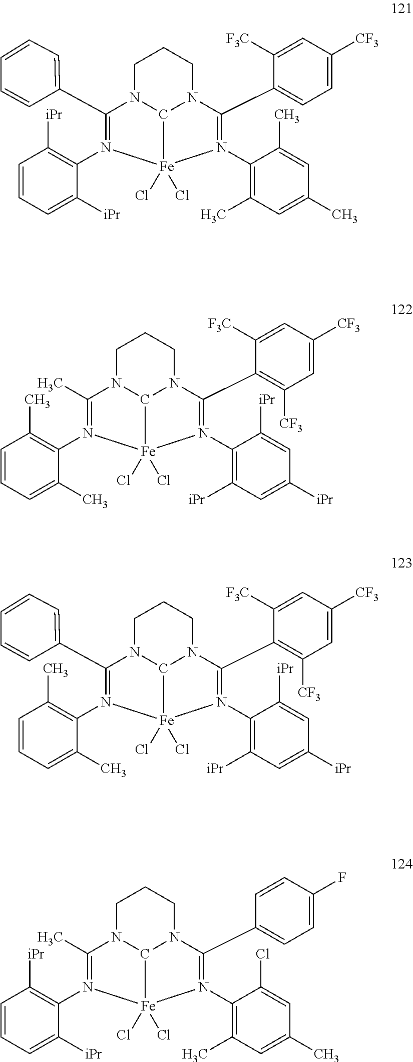

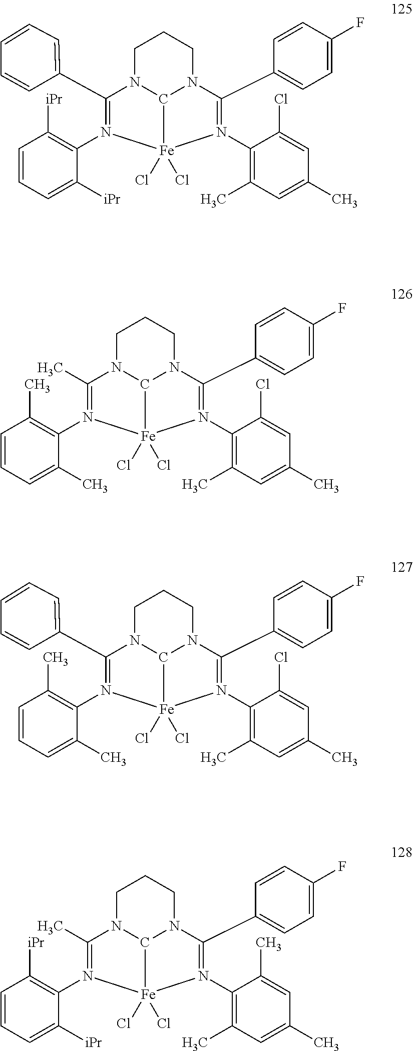

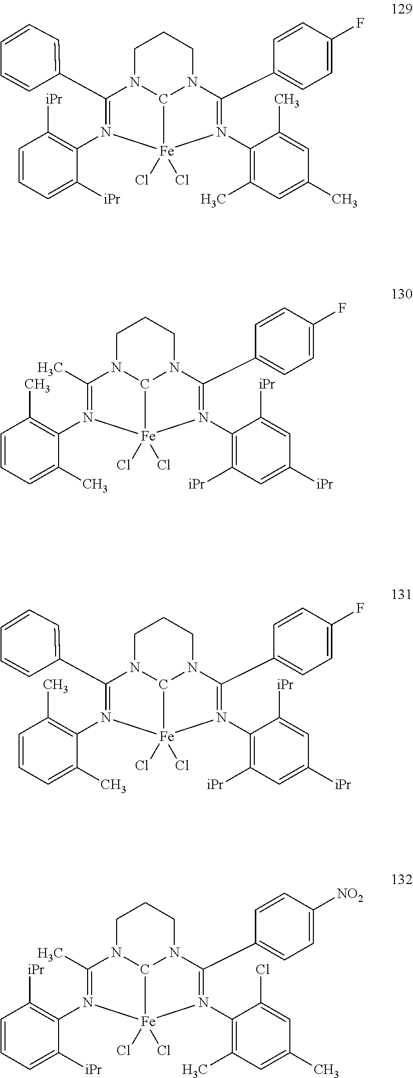

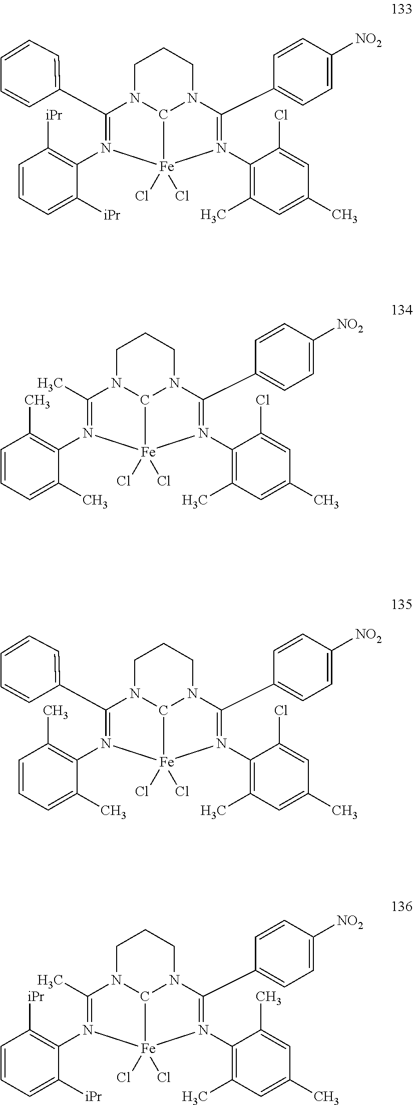

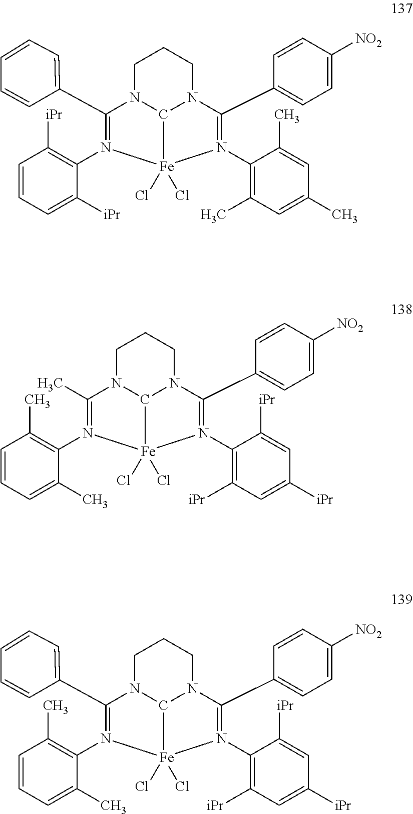

In some preferred embodiments, the first catalyst compound represented by formula (I), formula (II), or formula (III) can be one or more of the following.

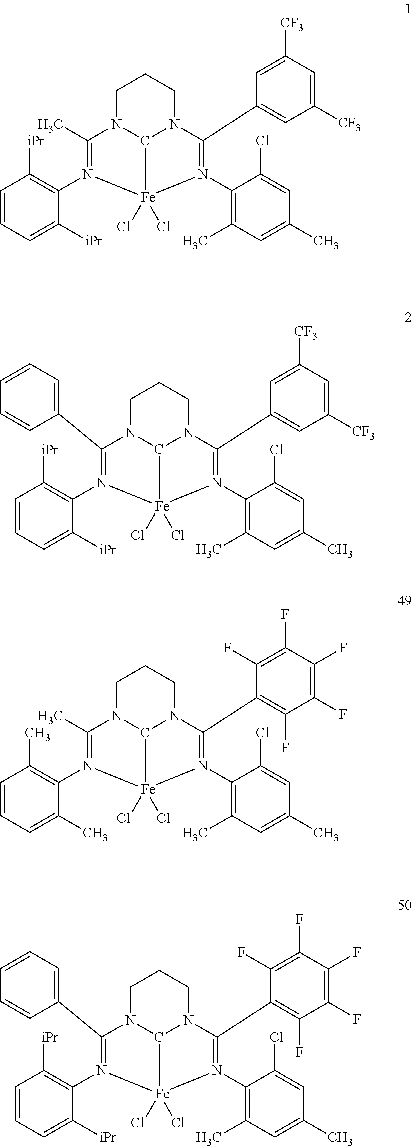

In at least one embodiment, the first catalyst compound represented by formula (I), formula (II), or formula (III) can be an alkyl migration product formed in situ during formation of a catalyst system upon contact with an alkyl alumoxane, such as methylalumoxane. For example, a compound represented by formula (I) can form an alkyl migration product (e.g., a compound represented by formula (Ia)). Without being bound by theory, it is thought that alkyl migration from an alkyl alumoxane can occur upon contact of a compound represented by formula (I), formula (II), or formula (III) and an alkyl alumoxane. For simplicity, a plausible mechanism of alkyl migration from an alkyl alumoxane to a compound represented by formula (I), formula (II), or formula (III) is shown in Scheme 1. Alkyl migration can occur on a minor fraction, a major fraction, or the entirety of the total amount of a compound represented by formula (I), formula (II), or formula (III) that contacts an alkyl alumoxane during formation of a catalyst system of the present disclosure. Alternatively, alkyl migration does not occur on any fraction of the total amount of a compound represented by formula (I), formula (II), and or formula (III) that contacts an alkyl alumoxane during formation of a catalyst system of the present disclosure.

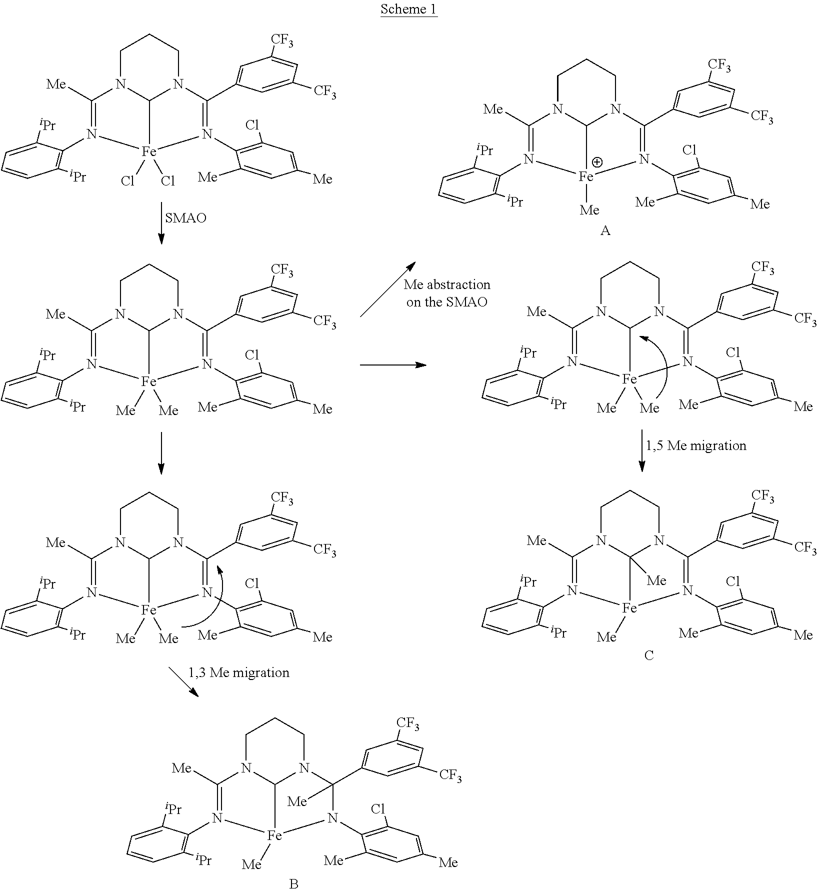

In some preferred embodiments where alkyl migration products are formed, the alkyl migration product or neutral radical anion of formula (I) (or compound represented by formula (Ia)) can be one or more of the following.

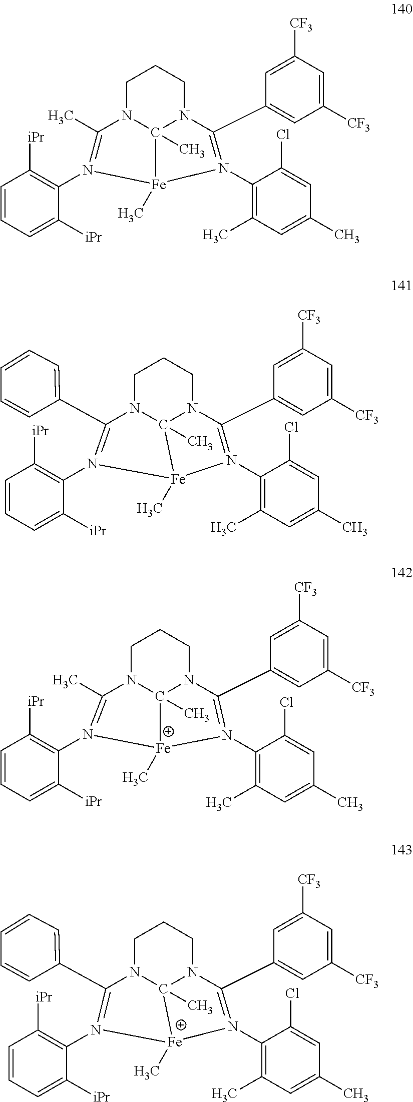

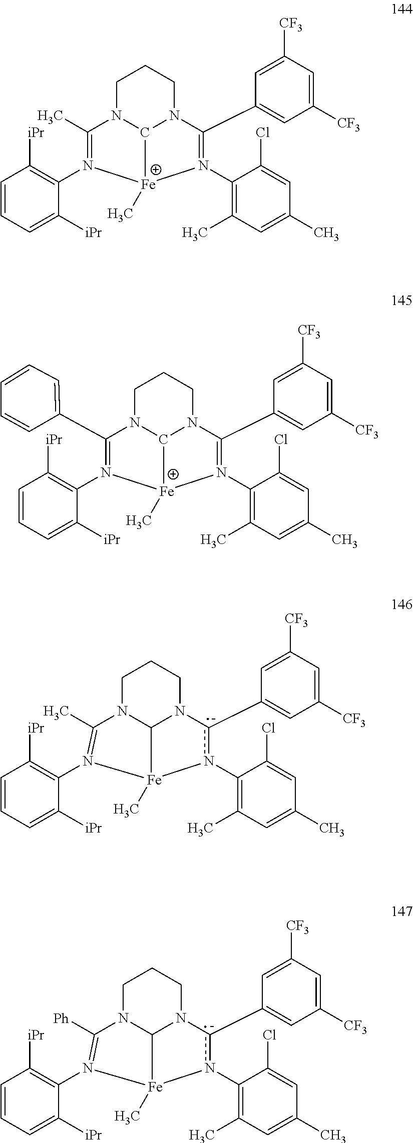

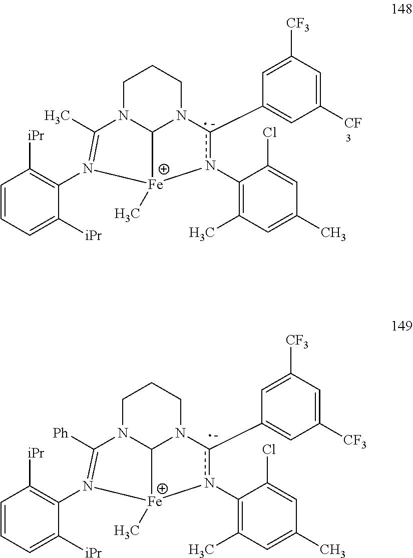

In at least one embodiment, one catalyst compound is used, e.g., the catalyst compounds are not different. For purposes of the present disclosure one catalyst compound is considered different from another if they differ by at least one atom. For example “bisindenyl ZrCl₂” is different from “(indenyl)(2-methylindenyl) ZrCl₂” which is different from “(indenyl)(2-methylindenyl) HfCl₂.” Catalyst compounds that differ only by isomer are considered the same for purposes of the present disclosure, e.g., rac-dimethylsilylbis(2-methyl 4-phenyl)Hf(Me)₂ is considered to be the same as meso-dimethylsilylbis(2-methyl 4-phenyl)Hf(Me)₂.

### Second Catalyst Compound(s) (B)

In embodiments where the mixed catalyst systems (and processes for making oligomeric or polymeric product using such mixed catalyst systems) according to the present disclosure comprise a second catalyst compound, different from the first catalyst compound represented by formula (I), formula (Ia), formula (II), or formula (III) herein, the second catalyst compound having a structure represented by formula (IV) below:

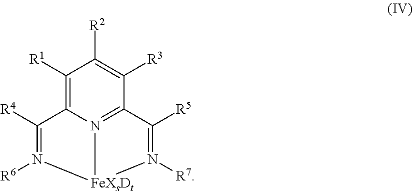

In formula (IV), each of R¹, R², and R³ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O and S; in some embodiments, any one or more of R¹, R², and R³ can optionally be substituted by halogen, —CF₃, —CF₂CF₃, —CH₂CF₃, —NO₂, —NR′₂, —OR′, or —SiR″₃.

If any R′ moieties are present in formula (IV), each R′ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR″₃; in some embodiments any one or more R′ radicals can be optionally substituted by halogen, or two R′ radicals can optionally bond to form a (five- or six-membered) ring. If any R″ moieties are present in formula (IV), each R″ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms; in some embodiments, two R″ radicals can optionally bond to form a (five- or six-membered) ring.

In formula (IV), R⁴ and R⁵ represent moieties (or ligands) bonded to the imine carbons; in some embodiments, they are symmetric in composition (i.e., the same). Each of R⁴ and R⁵ can independently be C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or five-, six-, or seven-membered heterocyclyl comprising at least one atom selected from N, P, O, and S; in some embodiments, each of R⁴ and R⁵ may optionally be individually substituted by halogen, —NR′₂, —OR′, or —SiR″₃. In some embodiments, R⁴ may optionally bond with R¹, and/or R⁵ may optionally bond with R³, in each case to independently form a (five-, six- or seven-membered) ring.

In formula (IV), each of R⁶ and R⁷ can independently be C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O and S; in some embodiments, each of R⁴ and R⁵ may optionally be individually substituted by halogen, —CF₃, —CF₂CF₃, —CH₂CF₃, —NO₂, —NR′₂, —OR′, or —SiR″₃.

In formula (IV), each X can independently be a halogen (e.g., fluorine, chlorine, bromine, or iodine), hydrogen, C₁-C₂₀-alkyl, C₂-C₁₀-alkenyl, C₆-C₂₀-aryl, arylalkyl where alkyl has from 1 to 10 carbon atoms and aryl has from 6 to 20 carbon atoms, —NR′″₂, —OR′″, —SR′″, —SO₃R′″, —OC(O)R′″, —CN, —SCN, β-diketonate, —CO, —BF₄, —PF₆, or bulky non-coordinating anions, and the X radicals can optionally be bonded with one another. In some embodiments, each X can independently be fluorine, chlorine, bromine, iodine, or C₁-C₂₀-alkyl (e.g., methyl, ethyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, or sec-decyl).

If any R′″moieties are present in formula (IV), each R′″can independently be hydrogen, C₁-C₂₀-alkyl, C₂-C₂₀-alkenyl, C₆-C₂₀-aryl, arylalkyl where alkyl has from 1 to 10 carbon atoms and aryl has from 6 to 20 carbon atoms, or —SiR″″₃; in some embodiments, one or more R′″can be substituted by halogen or nitrogen- or oxygen-containing groups, or two R′″radicals can optionally bond to form a (five- or six-membered) ring. If any R″″ moieties are present in formula (IV), each R″″ can independently be hydrogen, C₁-C₂₀-alkyl, C₂-C₂₀-alkenyl, C₆-C₂₀-aryl or arylalkyl where alkyl has from 1 to 10 carbon atoms and aryl has from 6 to 20 carbon atoms; in some embodiments, one or more R″″ can be substituted by halogen or nitrogen- or oxygen-containing groups, or two R″″ radicals can optionally bond to form a (five- or six-membered) ring.

In formula (IV), s is 1, 2, or 3, D is a neutral donor, and t is 0, 1 or 2. Preferably, t is 0, in which case D is absent. In at least one embodiment, D is a neutral donor such as a neutral Lewis base or Lewis acid, for example, amines, alcohols, ethers, ketones, aldehydes, esters, sulfides or phosphines, which can be bonded with the iron center or can still be contained in the complex as residual solvent from the preparation of the iron complexes.

In some embodiments, the second catalyst compound represented by formula (IV) can be symmetric, such that at least R⁴ and R⁵ radicals are identical and R⁶ and R⁷ radicals are identical (and optionally that all four of R⁴, R⁵, R⁶, and R⁷ are identical).

In some embodiments, the first catalyst compound used in the process of the present disclosure for making oligomeric or polymeric products can be an iron-containing catalyst alternatively represented by formula (V) below:

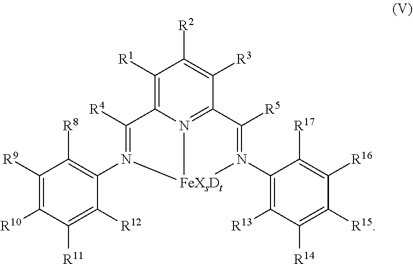

In formula (V), each of the moieties can be as in formula (IV), except that moieties R⁶ is replaced with a phenyl radical having pendant moieties R⁸, R⁹, R¹⁰, R¹¹, and R¹², and R⁷ is replaced with a phenyl radical having pendant moieties R¹³, R¹⁴, R¹⁵, R¹⁶, and R¹⁷.

In formula (V), each of R⁸, R⁹, R¹⁰, R¹¹, R¹², R¹³, R¹⁴, R¹⁵, R¹⁶, and R¹⁷ can independently be hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O and S; in some embodiments, any one or more of R⁸, R⁹, R¹⁰, R¹¹, R¹², R¹³, R¹⁴, R¹⁵, R¹⁶, and R¹⁷ can optionally be substituted by halogen, —CF₃, —CF₂CF₃, —CH₂CF₃, —NO₂, —NR′₂, —OR′, or —SiR″₃.

In some alternative embodiments, the second catalyst compound can be a non-iron transition metal metallocene catalyst compound. In such alternative embodiments, the second catalyst compound can advantageously (a) be compatible with the first catalyst compound and/or (b) be capable of being activated with an activator identical to an activator used to activate the first catalyst compound. Together with the first catalyst compound in an appropriately activated mixed catalyst system, the second catalyst compound (regardless of chemistry) can preferably be capable of producing homopolymers of ethylene or propylene, copolymers of ethylene such as having from 0 to 25 mol % of one or more C₃ to C₂₀ olefin comonomers, or copolymers of propylene such as having from 0 to 25 mol % of one or more of C₂ and C₄ to C₂₀ olefin comonomers, the polymeric products advantageously possessing an Mw (g/mol) from 40,000 to 1,500,000 and an Mn (g/mol) from 8,000 to 1,000,000.

### Methods to Prepare the Catalyst Compounds

All air sensitive syntheses can be carried out in nitrogen purged dry boxes. All solvents are available from commercial sources. Substituted anilines; acyl chlorides; phosphorous pentachloride; nBuLi; 1,4,5,6-Tetrahydropyrimidine; iron (II) chloride; and potassium hexamethyl disilane are available from commercial sources.

Generally, first catalyst compounds of formula (I), formula (Ia), formula (II), or formula (III) can be synthesized according to the schematic reaction procedure described in Scheme 2 below. As shown in Scheme 2: (i) an aniline compound can be treated with an acyl chloride under basic conditions to form an aryl amide; (ii) the aryl amide can be treated with phosphorous pentachloride to form an imidoyl chloride; (iii) the 1,4,5,6-tetrahydropyrimidine can be treated with n-butyl lithium to form a lithium salt that can then be contacted with the imidoyl chloride to form a dihydropyrimidinyl methanimine; (iv) the methanimine can then be treated with an imidoyl chloride to provide an imino tetrahydropyridinium compound; and (v) the imino tetrahydropyridinium compound can then be treated with iron (II) chloride in the presence of potassium hexamethyldisilane to form a compound represented by formula (I), formula (II), or formula (III). Compounds represented by formula (Ia) can then be formed by further reaction of the carbene carbon of the final compound from Scheme 2 with another moiety.

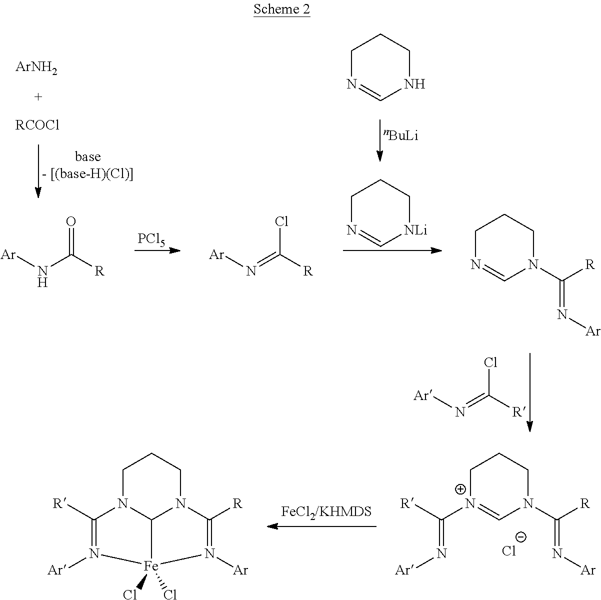

The first catalyst compounds represented by formula (I), formula (II), or formula (III) can be obtained by extraction of crude materials in dichloromethane.

In some symmetric embodiments, R and R′ can be methyl and Ar and Ar′ can be 2,6-(iPr)Ph. In some asymmetric embodiments, R can be methyl, R′ can be 3,5-(CF₃)Ph, Ar can be 2,6-(iPr)Ph, and Ar′ can be 2-C₁-4,6-(CH₃)Ph. In some asymmetric embodiments, R can be phenyl, R′ can be perfluorophenyl, Ar can be 2,6-(iPr)Ph, and Ar′ can be 2-Cl-4,6-(CH₃)Ph.

The second catalyst compounds represented by formula (IV) or formula (V) can be obtained through known synthesis methods, e.g., as disclosed in U.S. Pat. No. 8,759,460 or in J. Y. Liu et al., “Electron Effect of p-Substituent on Iron (II) and Cobalt (II) Pyridinebisimine Catalyst for Ethylene Polymerization,” Chinese Journal of Chemistry, 2006 Oct. 1, 24(10), pp. 1447-51, B. A. Schaefer, G. W. Margulieux, P. J. Chrik, Bull. Jpn. Soc. Coord. Chem., 2016, 67, 19-29; B. A. Schaefer, G. W. Margulieux, M. A. Tiedemann, B. L. Small, P. J. Chrik, Organometallics, 2015, 34, 5615-5623 the entire contents of each of which are incorporated herein by reference.

### Activators

The terms “cocatalyst” and “activator” are used herein interchangeably and are defined to be any compound which can activate any one of the catalyst compounds described above by converting the neutral catalyst compound to a catalytically active catalyst compound.

After the catalysts have been synthesized, catalyst systems may be formed by combining the catalysts with activators in any suitable manner, including by supporting them for use in slurry or gas phase polymerization. The catalyst systems may also be added to or generated in solution polymerization or bulk polymerization (in the monomer, i.e., no solvent).

Non-limiting activators, for example, include alumoxanes, aluminum alkyls, ionizing activators, which may be neutral or ionic, and conventional-type cocatalysts. Preferred activators typically include alumoxane compounds, modified alumoxane compounds, and ionizing anion precursor compounds that abstract a reactive, σ-bound, metal ligand making the metal complex cationic and providing a charge-balancing noncoordinating or weakly coordinating anion.

### Alumoxane Activators

In some embodiments, alumoxane activators are utilized as an activator in the mixed catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under U.S. Pat. No. 5,041,584). Aluminum alkyls are available as hydrocarbon solutions from commercial sources. For example, methylalumoxane (“MAO”) is available from Albemarle Corporation, Baton Rouge, La., as a 10-30 wt % solution in toluene.

The mixed catalyst system typically comprises first and second catalyst compounds described above and an activator such as alumoxane or a non-coordinating anion activator. Activation may be performed using alumoxane solution including an alkylalumoxane such as methyl alumoxane, referred to as MAO, as well as modified MAO, referred to herein as MMAO, which contains some higher alkyl groups to improve the solubility. The mixed catalyst system employed in the present disclosure can use an activator selected from alumoxanes, such as methyl alumoxane, modified methyl alumoxane, ethyl alumoxane, iso-butyl alumoxane, TEAL (triethyl aluminum) and the like.

When an alumoxane or modified alumoxane is used, the total catalyst (A+B)-to-activator molar ratio is from 1:3000 to 10:1; such as 1:2000 to 10:1; such as 1:1000 to 10:1; such as 1:500 to 1:1; such as 1:300 to 1:1; such as 1:200 to 1:1; such as 1:100 to 1:1; such as 1:50 to 1:1; such as 1:10 to 1:1. When the activator is an alumoxane (modified or unmodified), some embodiments select the maximum amount of activator at a 5,000-fold molar excess over the catalyst (per metal catalytic site). The minimum activator-to-catalyst ratio can be ˜1:1 molar ratio.

### Non-Coordinating Anion Activators

A non-coordinating anion (NCA) is an anion either that does not coordinate to the catalyst metal cation(s) or that does coordinate to the metal cation(s), but only weakly. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. An NCA coordinates weakly enough that a neutral Lewis base, such as an olefinically or acetylenically unsaturated monomer can displace it from each catalyst center. Any metal or metalloid that can form a compatible, weakly coordinating complex may be used or contained in the noncoordinating anion. Suitable metals can include aluminum, gold, and platinum. Suitable metalloids can include boron, aluminum, phosphorus, and silicon. A stoichiometric activator can be either neutral or ionic. The terms ionic activator, and stoichiometric ionic activator can be used interchangeably. Likewise, the terms neutral stoichiometric activator, and Lewis acid activator can be used interchangeably. The term non-coordinating anion includes neutral stoichiometric activators, ionic stoichiometric activators, ionic activators, and Lewis acid activators.

“Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization.

Activation may be performed using non-coordinating anions (NCAs) of the type, for example, described in EP 277 003 A1 and EP 277 004 A1. NCA may be added in the form of an ion pair using, for example, [DMAH]+[NCA]− in which the N,N-dimethylanilinium (“DMAH”) cation reacts with a basic leaving group on the transition metal complex to form a transition metal complex cation and [NCA]−. The cation in the precursor may, alternatively, be trityl. Alternatively, the transition metal complex may be reacted with a neutral NCA precursor, such as B(C₆F₅)₃, which abstracts an anionic group from the complex to form an activated species. Useful activators include N,N-dimethylanilinium tetrakis (pentafluorophenyl)borate (i.e., [PhNMe₂H]B(C₆F₅)₄) and N,N-dimethylanilinium tetrakis (heptafluoronaphthyl)borate, where Ph is phenyl, and Me is methyl.

Additionally activators useful herein include those described in U.S. Pat. No. 7,247,687 at column 169, line 50 to column 174, line 43, particularly column 172, line 24 to column 173, line 53.

In some embodiments of the present disclosure, a non-coordinating anion activator can be represented by the following formula (1):

(Z)^{d+}(A^{d-}) (1)

wherein Z is (L-H) or a reducible Lewis acid, L is a neutral Lewis base, H is hydrogen and (L-H)⁺ is a Bronsted acid; A^{d-} is a non-coordinating anion having the charge d−; and d is an integer from 1 to 3.

When Z is (L-H) such that the cation component is (L-H)^{d+}, the cation component may include Bronsted acids such as protonated Lewis bases capable of protonating a moiety, such as an alkyl or aryl, from the catalyst precursor(s), resulting in a cationic transition metal species, or the activating cation (L-H)^{d+} is a Bronsted acid, capable of donating a proton to the catalyst precursor(s) resulting in a transition metal cation, including ammoniums, oxoniums, phosphoniums, silyliums, and mixtures thereof, or ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, phosphoniums from triethylphosphine, triphenylphosphine, and diphenylphosphine, oxoniums from ethers, such as dimethyl ether diethyl ether, tetrahydrofuran, and dioxane, sulfoniums from thioethers, such as diethyl thioethers and tetrahydrothiophene, and mixtures thereof.

When Z is a reducible Lewis acid, it may be represented by the formula: (Ar₃C+), where Ar is aryl or aryl substituted with a heteroatom, or a C₁ to C₄₀ hydrocarbyl, the reducible Lewis acid may be represented by the formula: (Ph₃C+), where Ph is phenyl or phenyl substituted with a heteroatom, and/or a C₁ to C₄₀ hydrocarbyl. In an embodiment, the reducible Lewis acid is triphenyl carbenium.

Embodiments of the anion component A^{d-} include those having the formula [M^{k}+Qⁿ]^{d-} wherein k is 1, 2, or 3; n is 1, 2, 3, 4, 5 or 6, or 3, 4, 5 or 6; n−k=d; M is an element selected from Group 13 of the Periodic Table of the Elements, or boron or aluminum, and Q is independently a hydride, bridged or unbridged dialkylamido, halide, alkoxide, aryloxide, hydrocarbyl radicals, the Q having up to 20 carbon atoms with the proviso that in not more than one occurrence is Q a halide, and two Q groups may form a ring structure. Each Q may be a fluorinated hydrocarbyl radical having 1 to 20 carbon atoms, or each Q is a fluorinated aryl radical, or each Q is a pentafluoryl aryl radical. Examples of suitable A^{d-} components also include diboron compounds as disclosed in U.S. Pat. No. 5,447,895, which is fully incorporated herein by reference.

Illustrative examples of boron compounds which may be used as an activating cocatalyst are the compounds described as (and particularly those specifically listed as) activators in U.S. Pat. No. 8,658,556, which is incorporated by reference herein.

In an embodiment in any of the NCA's represented by Formula 1 described above, the anion component A^{d-} is represented by the formula [M*k*+Q*n*]d*- wherein k* is 1, 2, or 3; n* is 1, 2, 3, 4, 5, or 6 (or 1, 2, 3, or 4); n*−k*=d*; M* is boron; and Q* is independently selected from hydride, bridged or unbridged dialkylamido, halogen, alkoxide, aryloxide, hydrocarbyl radicals, the Q* having up to 20 carbon atoms with the proviso that in not more than 1 occurrence is Q* a halogen.

The present disclosure also provides a method to polymerize olefins comprising contacting olefins (such as ethylene or propylene) with a catalyst complex as described above and an NCA activator represented by the Formula (2):

RₙM**(ArNHal)⁴⁻ⁿ (2)

where R is a monoanionic ligand; M** is a Group 13 metal or metalloid; ArNHal is a halogenated, nitrogen-containing aromatic ring, polycyclic aromatic ring, or aromatic ring assembly in which two or more rings (or fused ring systems) are joined directly to one another or together; and n is 0, 1, 2, or 3. Typically the NCA comprising an anion of Formula 2 also comprises a suitable cation that is essentially non-interfering with the ionic catalyst complexes formed with the transition metal compounds, or the cation is Z_{d+} as described above.

In an embodiment in any of the NCA's comprising an anion represented by Formula 2 described above, R is selected from the group consisting of C₁ to C₃₀ hydrocarbyl radicals. In an embodiment, C₁ to C₃₀ hydrocarbyl radicals may be substituted with one or more C₁ to C₂₀ hydrocarbyl radicals, halide, hydrocarbyl substituted organometalloid, dialkylamido, alkoxy, aryloxy, alkysulfido, arylsulfido, alkylphosphido, arylphosphide, or other anionic substituent; fluoride; bulky alkoxides, where bulky means C₄ to C₂₀ hydrocarbyl radicals; —SRa, —NRa₂, and —PRa₂, where each Ra is independently a monovalent C₄ to C₂₀ hydrocarbyl radical comprising a molecular volume greater than or equal to the molecular volume of an isopropyl substitution or a C₄ to C₂₀ hydrocarbyl substituted organometalloid having a molecular volume greater than or equal to the molecular volume of an isopropyl substitution.

In an embodiment in any of the NCA's comprising an anion represented by Formula 2 described above, the NCA also comprises cation comprising a reducible Lewis acid represented by the formula: (Ar₃C+), where Ar is aryl or aryl substituted with a heteroatom, and/or a C₁ to C₄₀ hydrocarbyl, or the reducible Lewis acid represented by the formula: (Ph₃C+), where Ph is phenyl or phenyl substituted with one or more heteroatoms, and/or C₁ to C₄₀ hydrocarbyls.

In an embodiment in any of the NCA's comprising an anion represented by Formula 2 described above, the NCA may also comprise a cation represented by the formula, (L-H)^{d+}, wherein L is an neutral Lewis base; H is hydrogen; (L-H) is a Bronsted acid; and d is 1, 2, or 3, or (L-H)^{d+} is a Bronsted acid selected from ammoniums, oxoniums, phosphoniums, silyliums, and mixtures thereof.

Further examples of useful activators include those disclosed in U.S. Pat. Nos. 7,297,653 and 7,799,879, which are fully incorporated by reference herein.

In an embodiment, an activator useful herein comprises a salt of a cationic oxidizing agent and a noncoordinating, compatible anion represented by the Formula (3):

(OX^{e+})_{d}(A^{d-})ₑ (3)

wherein OX^{e+} is a cationic oxidizing agent having a charge of e+; e is 1, 2, or 3; d is 1, 2, or 3; and A^{d-} is a non-coordinating anion having the charge of d− (as further described above). Examples of cationic oxidizing agents include: ferrocenium, hydrocarbyl-substituted ferrocenium, Ag⁺, or Pb⁺². Suitable embodiments of A^{d-} include tetrakis(pentafluorophenyl) borate.

Activators useful in catalyst systems herein include: trimethylammonium tetrakis(perfluoronaphthyl)borate, N,N-dimethylanilinium tetrakis(perfluoronaphthyl)borate, N,N-diethylanilinium tetrakis(perfluoronaphthyl)borate, triphenylcarbenium tetrakis(perfluoronaphthyl)borate, trimethylammonium tetrakis(perfluorobiphenyl)borate, N,N-dimethylanilinium tetrakis(perfluorobiphenyl)borate, triphenylcarbenium tetrakis(perfluorobiphenyl)borate, and the types disclosed in U.S. Pat. No. 7,297,653, which is fully incorporated by reference herein.

Particularly suitable activators include: N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Ph₃C⁺][B(C₆F₅)₄⁻], [Me₃NH⁺][B(C₆F₅)₄⁻]; 1-(4-(tris(pentafluorophenyl)borate)-2,3,5,6-tetrafluorophenyl)pyrrolidinium; and 4-(tris(pentafluorophenyl)borate)-2,3,5,6-tetrafluoropyridine.

In at least one embodiment, the activator comprises a triaryl carbonium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthyl)borate, N,N-dialkylanilinium tetrakis(perfluoronaphthyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

In at least one embodiment, an activator is one or more of: N,N-dimethylanilinium tetrakis(perfluorophenyl)borate; N,N-dimethylanilinium tetrakis(perfluoronaphthyl)borate; N,N-dimethylanilinium tetrakis(perfluorobiphenyl)borate; N,N-dimethylanilinium tetrakis(3,5-bis(trifluoromethyl)phenyl)borate; triphenylcarbenium tetrakis(perfluoronaphthyl)borate; triphenylcarbenium tetrakis(perfluorobiphenyl)borate; triphenylcarbenium tetrakis(3,5-bis(trifluoromethyl)phenyl)borate; triphenylcarbenium tetra(perfluorophenyl)borate; trimethylammonium tetrakis(perfluoronaphthyl)borate; triethylammonium tetrakis(perfluoronaphthyl)borate; tripropylammonium tetrakis(perfluoronaphthyl)borate; tri(n-butyl)ammonium tetrakis(perfluoronaphthyl)borate; tri(t-butyl)ammonium tetrakis(perfluoronaphthyl)borate; N,N-diethylanilinium tetrakis(perfluoronaphthyl)borate; N,N-dimethyl-(2,4,6-trimethylanilinium) tetrakis(perfluoronaphthyl)borate; and tropillium tetrakis(perfluoronaphthyl)borate.

Bulky activators are also useful herein as NCAs. “Bulky activator” as used herein refers to anionic activators represented by the formula:

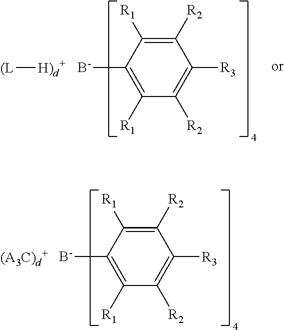

in which: each R₁ is, independently, a halide, preferably a fluoride; Ar is substituted or unsubstituted aryl group (preferably a substituted or unsubstituted phenyl), preferably substituted with C₁ to C₄₀ hydrocarbyls, preferably C₁ to C₂₀ alkyls or aromatics; each R₂ is, independently, a halide, a C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (preferably R₂ is a fluoride or a perfluorinated phenyl group); each R₃ is a halide, C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (preferably R₃ is a fluoride or a C₆ perfluorinated aromatic hydrocarbyl group); L is an neutral Lewis base; (L-H)⁺ is a Bronsted acid; and d is 1, 2, or 3. In these formulas, R₂ and R₃ can form one or more saturated or unsaturated, substituted or unsubstituted rings (preferably R₂ and R₃ can form a perfluorinated phenyl ring). In these formulas, the anion can have a molecular weight of greater than 1020 g/mol, and at least three of the substituents on the B atom can each have a molecular volume of greater than 250 Å³, greater than 300 Å³, or greater than 500 Å³.

Preferably (Ar₃C)_{d}⁺ is (Ph₃C)_{d}⁺, in which Ph is a substituted or unsubstituted phenyl, preferably substituted with C₁ to C₄₀ hydrocarbyls or substituted C₁ to C₄₀ hydrocarbyls, more preferably C₁ to C₂₀ alkyls or aromatics or substituted C₁ to C₂₀ alkyls or aromatics.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in Girolami, Gregory S. “A Simple ‘Back of the Envelope’ Method for Estimating the Densities and Molecular Volumes of Liquids and Solids,” Journal of Chemical Education, Vol. 71, No. 11, November 1994, pp. 962-964. Molecular volume (MV), in units of cubic A, is calculated using the formula: MV=8.3Vₛ, where Vₛ is the scaled volume. Vₛ is the sum of the relative volumes of the constituent atoms, and is calculated from the molecular formula of the substituent using the following table of relative volumes. For fused rings, the Vₛ is decreased by ˜7.5% per fused ring.

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

For a list of particularly useful bulky activators, please see U.S. Pat. No. 8,658,556, which is incorporated by reference herein.

In at least one embodiment, two NCA activators may be used in the polymerization and the molar ratio of the first NCA activator to the second NCA activator can be any ratio. In at least one embodiment, the molar ratio of the first NCA activator to the second NCA activator is 0.01:1 to 10,000:1, or 0.1:1 to 1000:1, or 1:1 to 100:1.

In at least one embodiment, the NCA activator-to-total catalyst (A+B) ratio is a 1:1 molar ratio, or 0.1:1 to 100:1, or 0.5:1 to 200:1, or 1:1 to 500:1 or 1:1 to 1000:1. In at least one embodiment, the NCA activator-to-catalyst ratio is 0.5:1 to 10:1, or 1:1 to 5:1.

In at least one embodiment, the catalyst compounds can be combined with combinations of alumoxanes and NCA's (see for example, U.S. Pat. Nos. 5,153,157 and 5,453,410, European Patent No. EP 0 573 120 B1, and PCT Publication Nos. WO 94/07928 and WO 95/14044, which discuss the use of an alumoxane in combination with an ionizing activator, all of which are incorporated by reference herein).

In at least one embodiment, when an NCA (such as an ionic or neutral stoichiometric activator) is used, the total catalyst(A+B)-to-activator molar ratio is typically from 1:10 to 1:1; 1:10 to 10:1; 1:10 to 2:1; 1:10 to 3:1; 1:10 to 5:1; 1:2 to 1.2:1; 1:2 to 10:1; 1:2 to 2:1; 1:2 to 3:1; 1:2 to 5:1; 1:3 to 1.2:1; 1:3 to 10:1; 1:3 to 2:1; 1:3 to 3:1; 1:3 to 5:1; 1:5 to 1:1; 1:5 to 10:1; 1:5 to 2:1; 1:5 to 3:1; 1:5 to 5:1; 1:1 to 1:1.2.

Likewise, a co-activator, such as a group 1, 2, or 13 organometallic species (e.g., an alkyl aluminum compound such as tri-n-octyl aluminum), may be used in the catalyst system herein. The catalyst-to-co-activator molar ratio is from 1:100 to 100:1; 1:75 to 75:1; 1:50 to 50:1; 1:25 to 25:1; 1:15 to 15:1; 1:10 to 10:1; 1:5 to 5:1; 1:2 to 2:1; 1:100 to 1:1; 1:75 to 1:1; 1:50 to 1:1; 1:25 to 1:1; 1:15 to 1:1; 1:10 to 1:1; 1:5 to 1:1; 1:2 to 1:1; 1:10 to 2:1.

### Support Materials

In embodiments herein, the mixed catalyst system may comprise an inert support material. In at least one embodiment, the support material is a porous support material, for example, talc, or inorganic oxides. Other support materials include zeolites, clays, organoclays, or any other suitable organic or inorganic support material and the like, or mixtures thereof.

In at least one embodiment, the support material is an inorganic oxide. Suitable inorganic oxide materials for use in catalyst systems herein include Groups 2, 4, 13, and 14 metal oxides, such as silica, alumina, and mixtures thereof. Other inorganic oxides that may be employed either alone or in combination with the silica, or alumina are magnesia, titania, zirconia, and the like. Other suitable support materials, however, can be employed, for example, functionalized polyolefins, such as polyethylene. Supports include magnesia, titania, zirconia, montmorillonite, phyllosilicate, zeolites, talc, clays, and the like. Also, combinations of these support materials may be used, for example, silica-chromium, silica-alumina, silica-titania, and the like. Support materials include Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area in the range of from 10 to 700 m²/g, pore volume in the range of from 0.1 to 4.0 cc/g and average particle size in the range of from 5 to 500 m. In at least one embodiment, the surface area of the support material is in the range of from 50 to 500 m²/g, pore volume of from 0.5 to 3.5 cc/g and average particle size of from 10 to 200 m. In at least one embodiment, the surface area of the support material is in the range is from 100 to 400 m²/g, pore volume from 0.8 to 3.0 cc/g and average particle size is from 5 to 100 m. The average pore size of the support material useful in the present disclosure is in the range of from 10 to 1000 Å, such as 50 to 500 Å, such as 75 to 350 Å. In some embodiments, the support material is a high surface area, amorphous silica (surface area=300 m²/gm; pore volume of 1.65 cm³/gm). Silicas are marketed under the tradenames of Davison 952 or Davison 955 by the Davison Chemical Division of W.R. Grace and Company. In other embodiments DAVISON 948 is used.

The support material can preferably be dry, that is, substantially free of absorbed water. Drying of the support material can be effected by heating or calcining at 100° C. to 1000° C., such as at least about 600° C. When the support material is silica, it is heated to at least 200° C., such as 200° C. to 850° C., such as at about 600° C.; and for a time of 1 minute to about 100 hours, from 12 hours to 72 hours, or from 24 hours to 60 hours. The calcined support material should have at least some reactive hydroxyl (OH) groups to produce supported catalyst systems of the present disclosure. The calcined support material can then contacted with a mixed polymerization catalyst comprising a first catalyst compound and its activator and a second catalyst compound and its activator, whether individually (in parallel or series, thereafter being mixed together) or in combination (mixed together before contacting with the calcined support material).

The support material, having reactive surface groups, typically hydroxyl groups, is slurried in a non-polar solvent and the resulting slurry is contacted with a solution of each/both catalyst compound(s) plus its(their) activator(s). In some embodiments, the slurry of the support material can be first contacted with the activator(s) for a period of time in the range of from 0.5 hours to 24 hours, from 2 hours to 16 hours, or from 4 hours to 8 hours. The solution of the respective catalyst compound(s) can then be contacted with the isolated support/activator(s). In some embodiments, the supported catalyst system can be generated in situ. In at least one embodiment, the slurry of the support material is first contacted with the catalyst compound(s) for a period of time in the range of from 0.5 hours to 24 hours, from 2 hours to 16 hours, or from 4 hours to 8 hours. The slurry of the supported catalyst compound(s) can then be contacted with the activator solution. In mixed catalyst systems, the contacting may occur in similar ways for the first catalyst compound/activator and second catalyst compound/activator, or in different ways.

The mixture of the catalyst, activator and support can be heated to 0° C. to 70° C., such as to 23° C. to 60° C., such as at room temperature. Contact times typically range from 0.5 hours to 24 hours, from 2 hours to 16 hours, or from 4 hours to 8 hours.

Suitable non-polar solvents are materials in which all of the reactants used herein, e.g., the activator(s), and the catalyst compound(s), are at least partially soluble and which are liquid at room temperature. Non-limiting example non-polar solvents are alkanes, such as isopentane, hexane, n-heptane, octane, nonane, and decane, cycloalkanes, such as cyclohexane, aromatics, such as benzene, toluene, and ethylbenzene.

In at least one embodiment, the support material comprises a support material treated with an electron-withdrawing anion. The support material can be silica, alumina, silica-alumina, silica-zirconia, alumina-zirconia, aluminum phosphate, heteropolytungstates, titania, magnesia, boria, zinc oxide, mixed oxides thereof, or mixtures thereof; and the electron-withdrawing anion is selected from fluoride, chloride, bromide, phosphate, triflate, bisulfate, sulfate, or any combination thereof.

The electron-withdrawing component used to treat the support material can be any component that increases the Lewis or Bronsted acidity of the support material upon treatment (as compared to the support material that is not treated with at least one electron-withdrawing anion). In at least one embodiment, the electron-withdrawing component is an electron-withdrawing anion derived from a salt, an acid, or other compound, such as a volatile organic compound, that serves as a source or precursor for that anion. Electron-withdrawing anions can be sulfate, bisulfate, fluoride, chloride, bromide, iodide, fluorosulfate, fluoroborate, phosphate, fluorophosphate, trifluoroacetate, triflate, fluorozirconate, fluorotitanate, phospho-tungstate, or mixtures thereof, or combinations thereof. An electron-withdrawing anion can be fluoride, chloride, bromide, phosphate, triflate, bisulfate, or sulfate, or any combination thereof, at least one embodiment of this disclosure. In at least one embodiment, the electron-withdrawing anion is sulfate, bisulfate, fluoride, chloride, bromide, iodide, fluorosulfate, fluoroborate, phosphate, fluorophosphate, trifluoroacetate, triflate, fluorozirconate, fluorotitanate, or combinations thereof.

Thus, for example, the support material suitable for use in the mixed catalyst systems of the present disclosure can be one or more of fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, sulfated silica-coated alumina, phosphated silica-coated alumina, or combinations thereof. In at least one embodiment, the activator-support can be, or can comprise, fluorided alumina, sulfated alumina, fluorided silica-alumina, sulfated silica-alumina, fluorided silica-coated alumina, sulfated silica-coated alumina, phosphated silica-coated alumina, or combinations thereof. In another embodiment, the support material includes alumina treated with hexafluorotitanic acid, silica-coated alumina treated with hexafluorotitanic acid, silica-alumina treated with hexafluorozirconic acid, silica-alumina treated with trifluoroacetic acid, fluorided boria-alumina, silica treated with tetrafluoroboric acid, alumina treated with tetrafluoroboric acid, alumina treated with hexafluorophosphoric acid, or combinations thereof. Further, any of these activator-supports optionally can be treated with a metal ion.

Nonlimiting examples of cations suitable for use in the present disclosure in the salt of the electron-withdrawing anion include ammonium, trialkyl ammonium, tetraalkyl ammonium, tetraalkyl phosphonium, H+, [H(OEt₂)₂]+, or combinations thereof.

Further, combinations of one or more different electron-withdrawing anions, in varying proportions, can be used to tailor the specific acidity of the support material to a desired level. Combinations of electron-withdrawing components can be contacted with the support material simultaneously or individually, and in any order that provides a desired chemically-treated support material acidity. For example, in at least one embodiment, two or more electron-withdrawing anion source compounds in two or more separate contacting steps.

In one embodiment of the present disclosure, one example of a process by which a chemically-treated support material is prepared is as follows: a selected support material, or combination of support materials, can be contacted with a first electron-withdrawing anion source compound to form a first mixture; such first mixture can be calcined and then contacted with a second electron-withdrawing anion source compound to form a second mixture; the second mixture can then be calcined to form a treated support material. In such a process, the first and second electron-withdrawing anion source compounds can be either the same or different compounds.

The method by which the oxide is contacted with the electron-withdrawing component, typically a salt or an acid of an electron-withdrawing anion, can include gelling, co-gelling, impregnation of one compound onto another, or combinations thereof. Following a contacting method, the contacted mixture of the support material, electron-withdrawing anion, and optional metal ion, can be calcined.

According to another embodiment of the present disclosure, the support material can be treated by a process comprising: (i) contacting a support material with a first electron-withdrawing anion source compound to form a first mixture; (ii) calcining the first mixture to produce a calcined first mixture; (iii) contacting the calcined first mixture with a second electron-withdrawing anion source compound to form a second mixture; and (iv) calcining the second mixture to form the treated support material.

### Polymerization Processes

In embodiments herein, the present disclosure provides polymerization processes where monomer (such as propylene or ethylene), and optionally comonomer, are contacted with a mixed catalyst system comprising a first catalyst compound, a second catalyst compound, and at least one activator, as described above. The catalyst compound(s) and activator(s) may be combined in any order, and are combined typically prior to contacting with the monomer.

In at least one embodiment, a polymerization process includes a) contacting one or more olefin monomers with a mixed catalyst system comprising: i) at least one activator; ii) a first catalyst compound of the present disclosure; and iii) a second catalyst compound of the present disclosure. The activator(s) may be an alumoxane or a non-coordination anion activator. In some embodiments, the first and second catalyst compounds have identical activators; in some embodiments, the first catalyst compound is paired with a first activator, and the second catalyst compound is paired with a second activator different from the first activator. The one or more olefin monomers may be propylene and/or ethylene and the polymerization process further comprises heating the one or more olefin monomers and the mixed catalyst system to 70° C. or more to form propylene polymers or ethylene polymers, preferably ethylene polymers.

Monomers useful herein include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer comprises ethylene and an optional comonomers comprising one or more ethylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups. In at least one embodiment, the monomer comprises ethylene and an optional comonomers comprising one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups.

Exemplary C₂ to C₄₀ olefin monomers and optional comonomers include ethylene, propylene, butene, pentene, hexene, heptene, octene, nonene, decene, undecene, dodecene, norbomene, norbomadiene, dicyclopentadiene, cyclopentene, cycloheptene, cyclooctene, cyclooctadiene, cyclododecene, 7-oxanorbomene, 7-oxanorbomadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbomene, norbomadiene, and their respective homologs and derivatives, such as norbomene, norbomadiene, and dicyclopentadiene.

In at least one embodiment, one or more dienes are present in the polymer produced herein at up to 10 wt %, such as at from 0.00001 to 1.0 wt %, from 0.002 to 0.5 wt %, or from 0.003 to 0.2 wt %, based upon the total weight of the composition. In some embodiments 500 ppm or less of diene is added to the polymerization, such as 400 ppm or less or 300 ppm or less. In other embodiments at least 50 ppm of dienes are added to the polymerization, such as 100 ppm or more or 150 ppm or more.

Diene monomers include any hydrocarbon structure, such as C₄ to C₃₀, having at least two unsaturated bonds, wherein at least two of the unsaturated bonds are readily incorporated into a polymer by either a stereospecific or a non-stereospecific catalyst(s). The diene monomers can be selected from alpha, omega-diene monomers (i. e. di-vinyl monomers). The diolefin monomers are linear di-vinyl monomers, such as those containing from 4 to 30 carbon atoms. Examples of dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Cyclic dienes include cyclopentadiene, vinylnorbomene, norbornadiene, ethylidene norbornene, divinylbenzene, dicyclopentadiene or higher ring containing diolefins with or without substituents at various ring positions.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be performed. (A useful homogeneous polymerization process is one where at least 90 wt % of the product is soluble in the reaction media.) A bulk homogeneous process can be used. (A preferred bulk process is one where monomer concentration in all feeds to the reactor is 70 volume % or more.) Alternately, no solvent or diluent is present or added in the reaction medium, (except for the small amounts used as the carrier for the catalyst system or other additives, or amounts typically found with the monomer; e.g., propane in propylene). In at least one embodiment, the process is a slurry polymerization process. As used herein the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (e.g., Isopar™); perhalogenated hydrocarbons, such as perfluorinated C₄-C₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof. In at least one embodiment, the solvent is not aromatic, such that aromatics are present in the solvent at less than 1 wt %, such as less than 0.5 wt % or less than 0.1 wt %, based upon the weight of the solvents.

In at least one embodiment, the feed concentration of the monomers and comonomers for the polymerization is 60 vol % solvent or less, such as 40 vol % or less or 20 vol % or less, based on the total volume of the feedstream. The polymerization can be performed in a bulk process.

Polymerizations can be performed at any temperature and/or pressure suitable to obtain the desired polymers, such as ethylene and or propylene polymers. Typical temperatures and/or pressures include a temperature in a range from 0° C. to 300° C., such as from 20° C. to 200° C., from 35° C. to 150° C., from 40° C. to 120° C., from 45° C. to 80° C., or at about 74° C., and at a pressure in a range from 0.35 MPa to 10 MPa, such as 0.45 MPa to 6 MPa or 0.5 MPa to 4 MPa.

In a typical polymerization, the run time of the reaction can be up to 300 minutes, such as in a range from 5 to 250 minutes or from 10 to 120 minutes.

In at least one embodiment, hydrogen is present in the polymerization reactor at a partial pressure from 0.001 to 50 psig (from 0.007 to 345 kPa), such as from 0.01 to 25 psig (from 0.07 to 172 kPa) or 0.1 to 10 psig (from 0.7 to 70 kPa).

In at least one embodiment, the productivity of a catalyst of the present disclosure is from 400 gPgcat⁻¹ hr⁻¹ to 20,000 gPgcat⁻¹ hr⁻¹, such as from 500 gPgcat⁻¹ hr⁻¹ to 15,000 gPgcat⁻¹ hr⁻¹, from 1,000 gPgcat⁻¹ hr⁻¹ to 14,000 gPgcat⁻¹ hr⁻¹, from 2,000 gPgcat⁻¹ hr⁻¹ to 13,000 gPgcat⁻¹ hr⁻¹, or from 3,000 gPgcat⁻¹ hr⁻¹ to 12,000 gPgcat⁻¹ hr⁻¹. In at least one embodiment, the conversion of olefin monomer is at least 10%, based upon polymer yield and the weight of the monomer entering the reaction zone, such as 20% or more, 30% or more, 50% or more, or 80% or more.

In at least one embodiment, for mixed catalyst systems of the present disclosure comprising a first catalyst compound of formula (I), formula (II), or formula (III) and one or more second catalysts (such as a compound of formula (IV) or formula (V) or alternatively a transition metal-containing metallocene catalyst compound), as described above, a polyethylene formed by the catalyst system can have an Mw/Mn value from greater than 1 to 30, such as from 3 to 25, from 5 to 20, from 7 to 18, or from 9 to 16.

In at least one embodiment, little or no alumoxane is used in the process to produce the polymers. Alumoxane can be present at zero mol %, alternatively the alumoxane is present at a molar ratio of aluminum to transition metal less than 500:1, such as less than 300:1, less than 100:1, or less than 1:1.

In at least one embodiment, little or no scavenger is used in the process to produce the ethylene polymer. Scavenger (such as trialkyl aluminum) can be present at zero mol %, alternately the scavenger is present at a molar ratio of scavenger metal to transition metal of less than 100:1, such as less than 50:1, such as less than 15:1, such as less than 10:1.

In at least one embodiment, the polymerization: 1) is conducted at temperatures of 0 to 300° C. (such as 25 to 150° C., 40 to 120° C., or 70 to 110° C.); 2) is conducted at a pressure of atmospheric pressure to 10 MPa (such as 0.35 to 10 MPa, from 0.45 to 6 MPa, or from 0.5 to 4 MPa); and 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, where aromatics are present in the solvent at less than 1 wt %, such as less than 0.5 wt %, such as at 0 wt % based upon the weight of the solvents). In at least one embodiment, the catalyst system used in the polymerization comprises no more than one catalyst compound. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In at least one embodiment, the polymerization occurs in one reaction zone.

Other additives may also be used in the polymerization, as desired, such as one or more scavengers, promoters, modifiers, chain transfer agents (such as diethyl zinc), reducing agents, oxidizing agents, hydrogen, aluminum alkyls, or silanes.

Useful chain transfer agents are typically alkylalumoxanes, a compound represented by the formula AlR₃, ZnR₂ (where each R is, independently, a C₁-C₈ aliphatic radical, such as methyl, ethyl, propyl, butyl, phenyl, hexyl octyl or an isomer thereof) or a combination thereof, such as diethyl zinc, methylalumoxane, trimethylaluminum, triisobutylaluminum, trioctylaluminum, or a combination thereof.

### Polyolefin Products

The present disclosure also provides compositions of matter which can be produced by the methods described herein.

In at least one embodiment, the process described herein produces ethylene homopolymers or ethylene copolymers, such as propylene-ethylene and/or ethylene-alphaolefin (such as C₄ to C₂₀) copolymers (such as ethylene-hexene copolymers or ethylene-octene copolymers) having an Mw/Mn from greater than 1 to 20 (such as from 2 to 17).

Likewise, the process of the present disclosure produces olefin polymers, such as polyethylene and polypropylene homopolymers and copolymers. In at least one embodiment, the polymers produced herein are homopolymers of ethylene or propylene, are copolymers of ethylene such as copolymer of ethylene having from 0 to 25 mol % (such as from 0.5 to 20 mol %, such as from 1 to 15 mol %, such as from 3 to 10 mol %) of one or more C₃ to C₂₀ olefin comonomer (such as C₃ to C₁₂ alpha-olefin, such as propylene, butene, hexene, octene, decene, dodecene, such as propylene, butene, hexene, octene), or are copolymers of propylene such as copolymers of propylene having from 0 to 25 mol % (such as from 0.5 to 20 mol %, such as from 1 to 15 mol %, such as from 3 to 10 mol %) of one or more of C₂ or C₄ to C₂₀ olefin comonomer (such as ethylene or C₄ to C₁₂ alpha-olefin, such as butene, hexene, octene, decene, dodecene, such as ethylene, butene, hexene, octene).

In at least one embodiment, the monomer is ethylene and the comonomer is hexene, at a comonomer content of from 1 wt % to 18 wt % hexene, such as from 5 wt % to 15 wt %, from 6 wt % to 12 wt %, from 6.5 wt % to 10 wt %, or from 7 wt % to 9 wt %.

In at least one embodiment, a polymer, such as polyethylene, has an Mw (g/mol) from 40,000 to 1,500,000, such as from 100,000 to 1,000,000, from 125,000 to 800,000, from 135,000 to 600,000, or from 150,000 to 300,000. In at least one embodiment, a polymer, such as polyethylene, has an Mn (g/mol) from 8,000 to 1,000,000, such as from 9,000 to 300,000, such as from 10,000 to 150,000, such as from 10,000 to 75,000. In at least one embodiment, a polymer, such as polyethylene, has an Mw/Mn value from greater than 1 to 30, such as from 3 to 25, from 5 to 20, from 7 to 18, or from 9 to 16.

Polymers produced herein typically have an Mz/Mw from greater than 1 to 25, such as from 2 to 20, from 3 to 15, from 4 to 14, or from 5 to 13. Polymers produced herein typically have an Mz/Mn from 1.5 to 500, such as from 2.5 to 300, from 3 to 250, from 4 to 200, or from 100 to 200. Mz/Mn is an indicator of the viscosity of a polymer. For example, a high Mz/Mn value tends to indicate a low viscosity whereas a low Mz/Mn value tends to indicate a high viscosity. Accordingly, a polymer with a larger Mz/Mn ratio would be expected to have a lower viscosity at high shear rates than a polymer with a similar weight average molecular weight but a smaller Mz/Mn ratio.

In at least one embodiment, a polymer of the present disclosure has a high degree of internal unsaturation. In at least one embodiment, a polymer has an internal unsaturation of less than 50% of the total unsaturations, such as less than 40%, preferably less than 30%. Polymers having a high degree of internal unsaturation can provide a low content of long chain branching, such as g′ᵥᵢₛ of 0.95 or more. Internal unsaturation can disrupt the crystallization of ethylene chains and contribute to the amorphous phase of the PE resin which may contribute to stronger mechanical properties in the film.

Polymers of the present disclosure can have a high degree of terminal unsaturation, e.g. vinylogous end groups. In at least one embodiment, a polymer has a terminal unsaturation of 0.1% to 20% or more of the total unsaturations, such as from 1% to 15% or from 3% to 8%. Terminal unsaturation can provide reactive end groups of polymers for functionalization.

In at least one embodiment, a polymer of the present disclosure has a combination of internal and terminal unsaturation of greater than 0.2 unsaturations per 1,000 carbon atoms, such as greater than 0.3 or greater than 0.35.

In at least one embodiment, a polymer of the present disclosure has a ratio of internal unsaturation to terminal unsaturation from 1 to 4, such as from 1 to 3 or from 1 to 2.

Unsaturation (internal and terminal) in a polymer can be determined by ¹H NMR with reference to He, Yiyong et al. (2014) “Terminal and Internal Unsaturations in Poly(ethylene-co-1-octene),” Macromolecules, v. 47, pp. 3782-3790 and Busico, Vincenzo et al. (2005) “H NMR Analysis of Chain Unsaturations in Ehtene/1-Octene Copolymers Prepared with Metallocene Catalysts at High Temperature,” Macromolecules, v. 38, pp. 6988-6996, but in event of conflict Macromolecules, 2014, 47, 3782 shall control. Peak assignments are determined referencing the solvent of tetrachloroethane-1,2 d₂ at ˜5.98 ppm. Specifically, percent internal unsaturation is determined by adding Vy1+Vy2+trisubstituted olefins then dividing by total unsaturation.

In at least one embodiment, a polymer of the present disclosure has a g′ᵥᵢₛ of greater than 0.92, such as greater than 0.94 or greater than 0.95.

In at least one embodiment, the polymer produced herein has a unimodal or multimodal molecular weight distribution as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versus).

In at least one embodiment, a bimodal polymer, such as a bimodal polyethylene (e.g., formed by a catalyst system having a catalyst represented by formula (I), (II), or (III) and a second catalyst) has an Mw/Mn value from greater than 1 to 30, such as from 3 to 25, from 5 to 20, from 7 to 18, or from 9 to 16, an Mz/Mw value from greater than 1 to 25, such as from 2 to 20, from 3 to 15, from 4 to 14, or from 5 to 13, and/or an Mz/Mn from 1.5 to 500, such as from 2.5 to 300, from 3 to 250, from 4 to 200, or from 100 to 200.

In at least one embodiment, the polymer produced herein has a composition distribution breadth index (CDBI) of 50% or more, such as 60% or more or 70% or more. CDBI is a measure of the composition distribution of monomer within the polymer chains and is measured by the procedure described in PCT publication WO 93/03093, published Feb. 18, 1993, specifically columns 7 and 8 as well as in Wild, L. et al (1982) “Determination of Branching Distributions in Polyethylene and Ethylene Copolymers,” J. Poly. Sci., Poly. Phys. Ed., Vol. 20, p. 441-455 and U.S. Pat. No. 5,008,204, including that fractions having a weight average molecular weight (Mw) below 15,000 are ignored when determining CDBI.

In at least one embodiment, a polymer of the present disclosure has an iron content of from about 0.001 parts per million by weight (ppm) to about 10 ppm, such as from about 0.005 ppm to about 9 ppm, such as from about 0.01 ppm to about 8 ppm.

Preferably the copolymer of the present disclosure has a reversed comonomer index. The reversed-co-monomer index (RCI,m) is computed from x2; (mol % co-monomer C₃, C₄, C₆, C₈, etc.), as a function of molecular weight, where x2 is obtained from the following expression in which n is the number of carbon atoms in the comonomer (3 for C₃, 4 for C₄, 6 for C₆, etc.):

$$x 2 = - \frac{200 w 2}{- 100 n - 2 w 2 + n w 2} .$$

Then the molecular-weight distribution, W(z) where z=log₁₀M, is modified to W′(z) by setting to 0 the points in W that are less than 5% of the maximum of W; this is to effectively remove points for which the S/N in the composition signal is low. Also, points of W′ for molecular weights below 2000 gm/mole are set to 0. Then W′ is renormalized so that

1=∫_{-∞}^{∞}W′dz

and a modified weight-average molecular weight (M_{W}′) is calculated over the effectively reduced range of molecular weights as follows:

M_{W}′=∫_{-∞}^{∞}10^{z}*W′dz

The RCI,m is then computed as:

RCI,m=∫_{-∞}^{∞}x2(10^{z}−M_{W}′)*W′dz

A reversed-co-monomer index (RCI,w) is also defined on the basis of the weight fraction co-monomer signal (w2/100) and is computed as follows:

$$R C I , w = {\int }_{- ∞}^{∞} \frac{w 2}{100} ( {10}^{z} - {M}_{W}^{′} ) {W}^{′} dz .$$

Note that in the above definite integrals the limits of integration are the widest possible for the sake of generality; however, in reality the function is only integrated over a finite range for which data is acquired, considering the function in the rest of the non-acquired range to be 0. Also, by the manner in which W′ is obtained, it is possible that W is a discontinuous function, and the above integrations need to be done piecewise.

Three co-monomer distribution ratios are also defined on the basis of the % weight (w2) comonomer signal, denoted as CDR-1,w, CDR-2,w, and CDR-3,w, as follows:

$$C D R \text{-} 1 , w = \frac{w 2 ( Mz )}{w 2 ( Mw )}$$

$$C D R \text{-} 2 , w = \frac{w 2 ( Mz )}{w 2 ( \frac{Mw + Mn}{2} )}$$

$$C D R \text{-} 3 , w = \frac{w 2 ( \frac{Mz + Mw}{2} )}{w 2 ( \frac{Mw + Mn}{2} )}$$

where w2(Mw) is the % weight co-monomer signal corresponding to a molecular weight of Mw, w2(Mz) is the % weight co-monomer signal corresponding to a molecular weight of Mz, w2[(Mw+Mn)/2)] is the % weight co-monomer signal corresponding to a molecular weight of (Mw+Mn)/2, and w2[(Mz+Mw)/2] is the % weight co-monomer signal corresponding to a molecular weight of Mz+Mw/2, where Mw is the weight-average molecular weight, Mn is the number-average molecular weight, and Mz is the z-average molecular weight.

Accordingly, the co-monomer distribution ratios can be also defined utilizing the % mole co-monomer signal, CDR-1,m, CDR-2,m, CDR-3,m, as:

$$C D R \text{-} 1 , m = \frac{x 2 ( Mz )}{x 2 ( Mw )}$$

$$C D R \text{-} 2 , m = \frac{x 2 ( Mz )}{x 2 ( \frac{Mw + Mn}{2} )}$$

$$C D R \text{-} 3 , m = \frac{x 2 ( \frac{Mz + Mw}{2} )}{x 2 ( \frac{Mw + Mn )}{2} )}$$

where x2(Mw) is the % mole co-monomer signal corresponding to a molecular weight of Mw, x2(Mz) is the % mole co-monomer signal corresponding to a molecular weight of Mz, x2[(Mw+Mn)/2)] is the % mole co-monomer signal corresponding to a molecular weight of (Mw+Mn)/2, and x2[(Mz+Mw)/2] is the % mole co-monomer signal corresponding to a molecular weight of Mz+Mw/2, where Mw is the weight-average molecular weight, Mn is the number-average molecular weight, and Mz is the z-average molecular weight.

In at least one embodiment of the present disclosure, the polymer produced by the processes described herein includes ethylene and one or more comonomers and the polymer has an RCI,m of 25 or more, such as from 30 to 250.

### Blends

In another embodiment, the polymer (preferably the polyethylene or polypropylene) produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1-esters, polyacetal, polyvinylidine fluoride, polyethylene glycols, and/or polyisobutylene.

In at least one embodiment, the polymer (such as polyethylene or polypropylene) is present in the above blends, at from 10 to 99 wt %, based upon the weight of the polymers in the blend, such as 20 to 95 wt %, such as at least 30 to 90 wt %, such as at least 40 to 90 wt %, such as at least 50 to 90 wt %, such as at least 60 to 90 wt %, such as at least 70 to 90 wt %.

The blends described above may be produced by mixing the polymers of the present disclosure with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; and talc.

### Films

One or more of the foregoing polymers, such as the foregoing polyethylenes or blends thereof, may be used in a variety of end-use applications. Such applications include, for example, mono- or multi-layer blown, extruded, and/or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, such as between 5 and 7, and in the Transverse Direction (TD) at a ratio of up to 15, such as 7 to 9. However, in at least one embodiment the film is oriented to the same extent in both the MD and TD directions.

The films may vary in thickness depending on the intended application; however, films of a thickness from 1 to 50 μm are usually suitable. Films intended for packaging are usually from 10 to 50 μm thick. The thickness of the sealing layer is typically 0.2 to 50 μm. There may be a sealing layer on both the inner and outer surfaces of the film or the sealing layer may be present on only the inner or the outer surface.

In at least one embodiment, one or more layers may be modified by corona treatment, electron beam irradiation, gamma irradiation, flame treatment, or microwave. In at least one embodiment, one or both of the surface layers is modified by corona treatment.

### Experimental

¹H NMR for Compound Characterization:

Chemical structures are determined by ¹H NMR. ¹H NMR data are collected at room temperature (e.g., ˜23° C.) in a ˜5 mm probe using either a ˜400 or ˜500 MHz Bruker spectrometer with deuterated solvent, such as deuterated methylene chloride or deuterated benzene.

All anhydrous solvents were purchased from Fisher Chemical and were degassed and dried over molecular sieves prior to use. Deuterated solvents were purchased from Cambridge Isotope Laboratories and dried over molecular sieves prior to use. Acetyl chloride, 3,5-bis(trifluoromethyl)benzoyl chloride, n-butyllithium, 2-chloro-4,6-dimethylaniline, 2,6-diisopropylaniline, pyridine, phosphorus pentachloride (PCI₅), potassium bis(trimethylsilyl)amide (KHMDS), 1,4,5,6-tetrahydropyrimidine and triethylamine (Et₃N) were purchased from Sigma-Aldrich and used as received. Iron(II) chloride was procured from Strem Chemicals and dried under vacuum prior to use. [N,N-1,3-Bis[1-(2,6-diisopropylphenylimino)-ethyl]-4,5,6-trihydropyrimid-2-ylidine] iron dichloride was synthesized according to literature (H. Z. Kaplan, B. Li, J. A. Byers, Organometallics, 2012, 31, 7343-7350; J. Al Thagfi, G. C. Lavoie, Organometallics, 2012, 31, 7351-7358). The ¹H NMR measurements were recorded on a 400 MHz Bruker spectrometer.

### Examples

| Catalyst | Structure | Name |
|---|---|---|
| 1 | 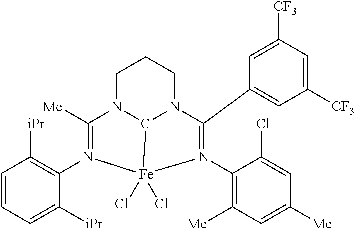 | {N,N-1-[(3,5- bis(trifluoromethyl)phenyl)- N-(2-chloro-4,6- dimethylphenyl)]-3-[1-(2,6- diisopropylphenylimino)- ethyl]-4,5,6-trihydropyrimid- 2-ylidine}iron dichloride |
| 2 | 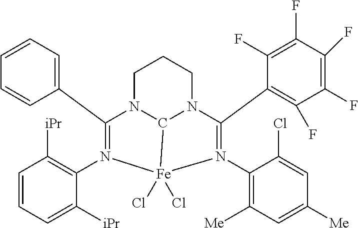 | {N,N-1-(perfluorophenyl-N- (2-chloro-4,6- dimethylphenyl)]-3-[(2,6- diisopropylphenylimino)- (phenyl)methyl)]-4,5,6- trihydropyrimid-2- ylidine}iron dichloride |
| 3 | 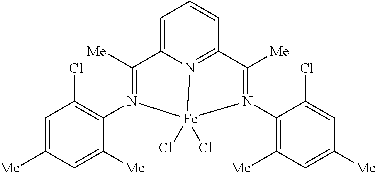 | [N,N-1,3-Bis[1-(2,6- diisopropylphenylimino)- ethyl]-4,5,6-trihydropyrimid- 2-ylidine] iron dichloride |

### Synthesis of Catalysts (and Catalyst Precursor Compounds)

### Synthesis of N-(2,6-diisopropylphenyl)acetamide

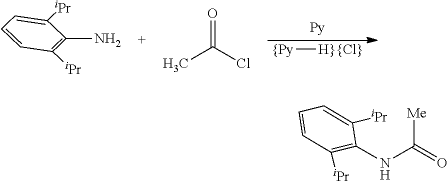

Neat acetyl chloride (˜8.855 g, ˜113 mmol) was added drop-wise to a pyridine (˜150 mL) solution of 2,6-diisopropyl aniline (˜20.0 g, ˜113 mmol) at about −25° C. The resulting mixture was first gradually brought to room temperature and then refluxed for ˜3 hours. The reaction mixture was dried in vacuo to remove pyridine solvent. The crude materials were slurried in dichloromethane and washed with deionized water to remove pyridine hydrochloride salt. The dichloromethane layer was decanted and dried over magnesium sulphate, which was then filtered to remove the magnesium sulphate. Volatiles were removed in vacuo and the crude materials were re-dissolved in toluene and stored overnight (˜8-16 hours) at about −25° C. to obtain highly crystalline colorless solid of N-(2,6-diisopropylphenyl)acetamide in ˜15.10 g (˜61.0%) yield. The ¹H NMR spectrum further suggests that this compound has two structural isomers in a 2:1 ratio (see proton integral values). ¹H NMR (˜400 MHz, C₆D₆): δ ˜1.14 ppm (2H, doublet (“d”), iPr-CH₃), ˜1.18 ppm (8H, d, ⁱPr—CH₃), ˜1.22 ppm (2H, d, ⁱPr—CH₃), ˜1.73 ppm (1H, singlet (“s”), CH₃), ˜2.20 ppm (2H, s, CH₃), ˜3.06 ppm (1.3H, septet (“sept”), ⁱPr—CH), ˜3.18 ppm (0.7H, sept, iPr-CH), ˜6.82 ppm (0.6H, broad singlet (“bs”), NH), ˜6.98 ppm (0.4H, broad singlet, NH), ˜7.17-7.20 ppm (1H, multiplet (“m”), Ar—CH), ˜7.25-7.34 ppm (2H, m, Ar—CH).

### Synthesis of N-(2,6-diisopropylphenyl)acetimidoyl chloride

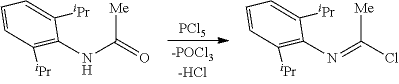

Neat N-(2,6-diisopropylphenyl)acetamide (˜14.89 g, ˜66 mmol) was dissolved in dry benzene and cooled to about −25° C.; to this, solid PC15 (˜14.02 g, ˜67 mmol, ˜1.02 equ) was added slowly. The reaction mixture was gradually brought to room temperature and then heated at ˜60° C. for about an hour. The reaction mixture solvents were removed in vacuo and the crude materials were vacuum distilled to obtain a colorless liquid of N-(2,6-diisopropylphenyl)acetimidoyl chloride in ˜14.10 g (˜89.8%) yield. Oil bath temperature was maintained at ˜110° C., and the product was distilled at ˜85° C. with ˜0.3-0.4 mbar vacuum. ¹H NMR (400 MHz, C₆D₆): δ ˜1.24 ppm (12H, d, iPr-CH₃), ˜2.23 ppm (3H, s, CH₃), ˜3.00 ppm (2H, sept, iPr-CH), ˜7.17-7.24 ppm (3H, m, Ar—CH).

### Synthesis of 1-[1-(2,6-diisopropylphenylimino)ethyl]-4,5,6-trihydropyrimidine

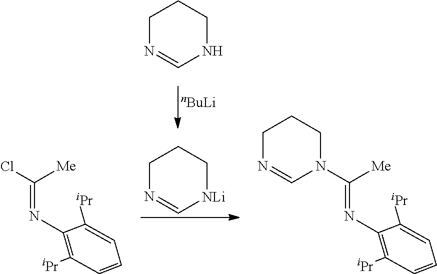

A solution of 1,4,5,6-tetrahydropyrimidine (˜0.71 g, ˜8.4 mmol) in THF was cooled to about −25° C., and, to this, n-butyllithium (˜3.36 mL, ˜8.4 mmol, ˜2.5 M solution in hexane) was added drop-wise over a period of ˜5-10 minutes. As n-butyllithium addition progressed, a thick white precipitate was formed at first, and this mixture was stirred an additional ˜2 hours at room temperature to ensure completion of the deprotonation reaction. The mixture was again cooled to about −25° C., and, to this, (E)-N-(2,6-diisopropylphenyl) acetimidoyl chloride in THF was added dropwise. The resulting mixture was stirred ˜2 hours at room temperature, and solvents/volatiles were removed in vacuo. The crude materials were extracted into dichloromethane to remove byproduct LiCl and other insoluble materials. Solvent removal under reduced pressure resulted a colorless crystalline solid of 1-[1-(2,6-diisopropylphenylimino)ethyl]-4,5,6-trihydropyrimidine in ˜2.7 g yield (˜112.5%, probably due to some remaining solvent). ¹H NMR (˜400 MHz, C₆D₆): δ ˜1.12 ppm (6H, d, iPr-CH₃), ˜1.17 ppm (6H, d, iPr-CH₃), ˜1.41 ppm (5H, bs, CH₃ and —CH₂), ˜2.81 ppm (2H, sept, iPr-CH), ˜3.32 ppm (2H, bs, —CH₂), ˜3.66 ppm (2H, bs, —CH₂), ˜7.07-7.17 ppm (3H, m, Ar—CH), ˜7.81 ppm (1H, bs, —CH).

### Synthesis of N,N-1,3-Bis[1-(2,6-diisopropylphenylimino)-ethyl]-4,5,6-trihydropyrimidinium chloride

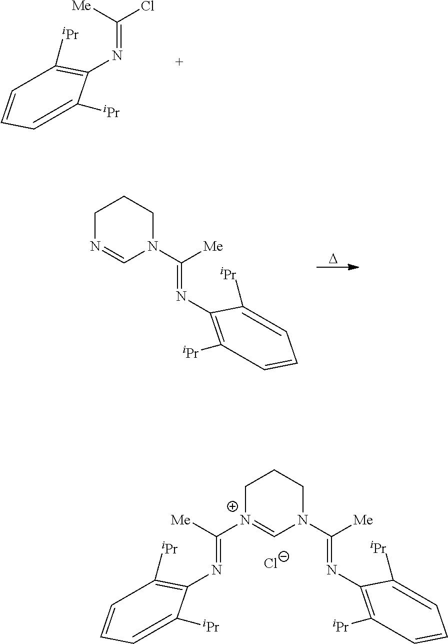

Solid 1-[1-(2,6-diisopropylphenylimino)ethyl]-4,5,6-trihydropyrimidine (˜2.76 g, ˜10.0 mmol) was dissolved in toluene and cooled to about −25° C. To this solution, N-(2,6-diisopropylphenyl)acetimidoyl chloride (˜2.30 g, ˜10.0 mmol) in toluene was added. The reaction mixture was stirred at room temperature for about an hour, and, during this time, a colorless crystalline solid of N,N-1,3-Bis[1-(2,6-diisopropylphenylimino)-ethyl]-4,5,6-trihydropyrimidinium chloride precipitated from solution. The product was filtered and washed with hexane to remove organic soluble impurities and unreacted starting materials, thereby obtaining spectroscopically pure N,N-1,3-Bis[1-(2,6-diisopropylphenylimino)-ethyl]-4,5,6-trihydropyrimidinium chloride as a colorless crystalline solid in ˜3.4 g (˜67.2%) yield. ¹H NMR (˜400 MHz, CD₂Cl₂): δ ˜1.12 ppm (6H, d, iPr-CH₃), ˜1.19 ppm (6H, d, iPr-CH₃), ˜2.45 ppm (1H, m, —CH₂), ˜2.58 ppm (3H, s, CH₃), ˜2.77 ppm (2H, sept, iPr-CH), ˜4.30 ppm (2H, t, —CH₂), ˜7.10-7.18 ppm (3H, m, Ar—CH), ˜9.82 ppm (1H, s, —CH).

### Synthesis of [N,N-1,3-Bis[1-(2,6-diisopropylphenylimino)-ethyl]-4,5,6-trihydropyrimid-2-ylidine] iron dichloride

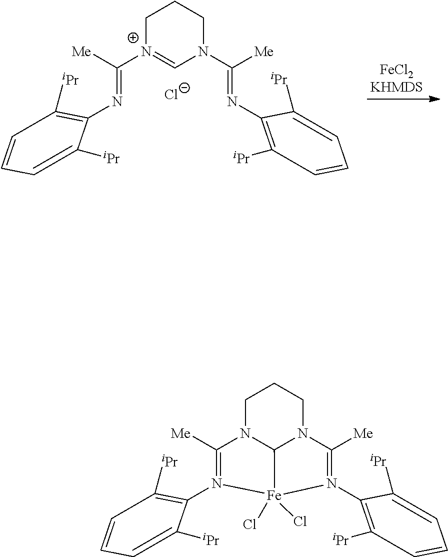

Solid FeCl₂ (˜0.24 g, ˜2.0 mmol) was slurried in THF and cooled to about −25° C., followed by dropwise addition of a pre-cooled solution of KHMDS (˜0.38 g, ˜2.0 mmol) in THF. The resulting mixture was occasionally agitated over a time period of ˜3 hours. The mixture was then added to a pre-cooled THF solution of N,N-1,3-Bis[1-(2,6-diisopropylphenylimino)-ethyl]-4,5,6-trihydropyrimidinium chloride (˜1.0 g, ˜2.0 mmol) and stirred overnight at room temperature, turning the reaction mixture to a wine red color. The reaction mixture solvents were removed in vacuo, and the reaction mixture was extracted into dichloromethane. The crude materials were finally washed with hexane to afford a burgundy red solid of [N,N-1,3-Bis[1-(2,6-diisopropylphenylimino)-ethyl]-4,5,6-trihydropyrimid-2-ylidine] iron dichloride in ˜0.7 g (˜59.6%) yield. The dichloromethane dissolved the desired neutral Fe complexes, while the remaining materials (including by-products) were insoluble. The iron carbene compound was insoluble in hexane and thus precipitated from the dichloromethane solution with hexane addition. ¹H NMR spectrum of this compound displayed 8 broad resonances, suggested to be C₂ symmetric, paramagnetic Fe(II) complexes in solution. ¹H NMR (˜400 MHz, CD₂Cl₂): δ ˜−21.42 ppm, ˜−10.8 ppm, ˜−6.8 ppm, ˜1.2 ppm, ˜7.1 ppm, ˜11.0 ppm, ˜16.1 ppm (bs).

### Synthesis of N-(2-chloro-4,6-dimethylphenyl)-3,5-bis(trifluoromethyl)benzamide

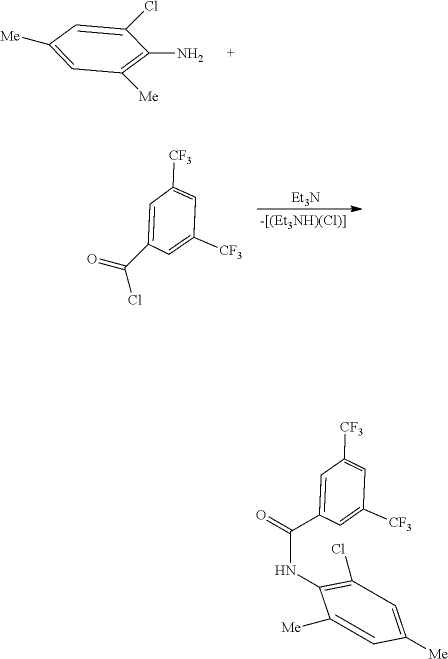 [SMILES: "Et3N" ; Cc1cc(C)c(N)c(Cl)c1 ; O=C(Cl)c1cc(C(F)(F)F)cc(C(F)(F)F)c1 ; Cc1cc(C)c(NC(=O)c2cc(C(F)(F)F)cc(C(F)(F)F)c2)c(Cl)c1]

Neat 3,5-bis(trifluoromethyl)benzoyl chloride (˜2.516 g, ˜9.1 mmol) was added dropwise to a mixture of triethylamine (˜0.92 g, ˜9.1 mmol) and 2-chloro-4,6-dimethylaniline (˜1.416 g, ˜9.1 mmol) in dichloromethane at about −25° C. The resulting mixture was first warmed to room temperature and then refluxed overnight. The reaction mixture solvents were removed in vacuo and dissolved in dichloromethane, and this mixture was then washed with deionized water. The organic layer (dichloromethane) was dried over magnesium sulphate, and the magnesium sulfate was then filtered, after which the dichloromethane was removed in vacuo. The crude materials were again dissolved in toluene and stored at about −25° C. Spectroscopically pure colorless crystalline materials of N-(2-chloro-4,6-dimethylphenyl)-3,5-bis(trifluoromethyl)benzamide were isolated in ˜3.6 g (˜54.7%) yield. ¹H NMR (˜400 MHz, CDCl₃): δ ˜2.29 ppm (3H, s, CH₃), ˜2.34 ppm (3H, s, CH₃), ˜7.03 ppm (1H, s, Ar—CH), ˜7.15 ppm (1H, s, Ar—CH), ˜7.66 ppm (1H, s, —NH), ˜8.08 ppm (1H, s, Ar—CH), ˜8.38 ppm (2H, s, Ar—CH) ppm. ¹⁹F NMR (˜400 MHz, CDCl₃): δ ˜−62.9 ppm (s).

### Synthesis of N-(2-chloro-4,6-dimethylphenyl)-3,5-bis(trifluoromethyl)benzimidoyl chloride

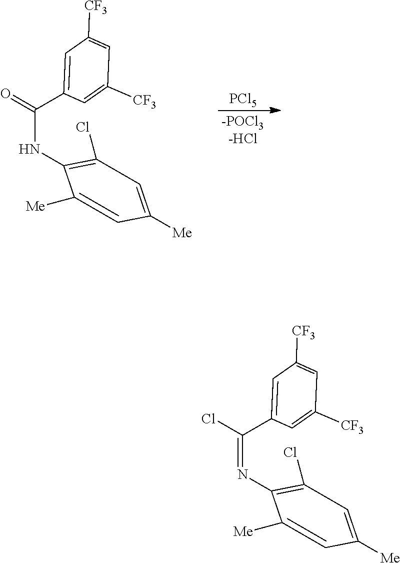 [SMILES: Cc1cc(C)c(NC(=O)c2cc(C(F)(F)F)cc(C(F)(F)F)c2)c(Cl)c1 ; "PCl5" ; Cc1cc(C)c(/N=C(/Cl)c2cc(C(F)(F)F)cc(C(F)(F)F)c2)c(Cl)c1]

Neat N-(2-chloro-4,6-dimethylphenyl)-3,5-bis(trifluoromethyl)benzamide (˜1.97 g, ˜5.0 mmol) was slurried in dry toluene and cooled to about −25° C., followed by addition of solid PC15 (˜1.037 g, ˜5.0 mmol) over a period of ˜5-10 minutes. Over the course of the PC15 addition, HCl gas was evolved and the slurry gradually dissolved to become a clear yellow solution. The resulting mixture was stirred overnight at room temperature, after which solvents/volatiles were removed in vacuo. The crude materials were washed with cold pentane to remove organic soluble impurities, affording colorless crystalline materials of N-(2-chloro-4,6-dimethylphenyl)-3,5-bis(trifluoromethyl)benzimidoyl chloride in ˜1.6 g (˜77.6%) yield. There were no phosphorus impurities observed in the final materials, which was confirmed by the absence of a phosphorus signal in the ³¹P NMR spectrum. ¹H NMR (˜400 MHz, C₆D₆): δ ˜1.87 ppm (3H, s, CH₃), ˜1.94 ppm (3H, s, CH₃), ˜6.64 ppm (1H, s, Ar—CH), ˜7.00 ppm (1H, s, Ar—CH), ˜7.70 ppm (1H, s, Ar—CH), ˜8.51 ppm (2H, s, Ar—CH). ¹⁹F NMR (˜400 MHz, C₆D₆): δ ˜−62.7 ppm (s).

### Synthesis of 1-(3,5-bis(trifluoromethyl)phenyl)-N-(2-chloro-4,6-dimethylphenyl)-1-(5,6-dihydropyrimidin-1(4H)-yl)methanimine

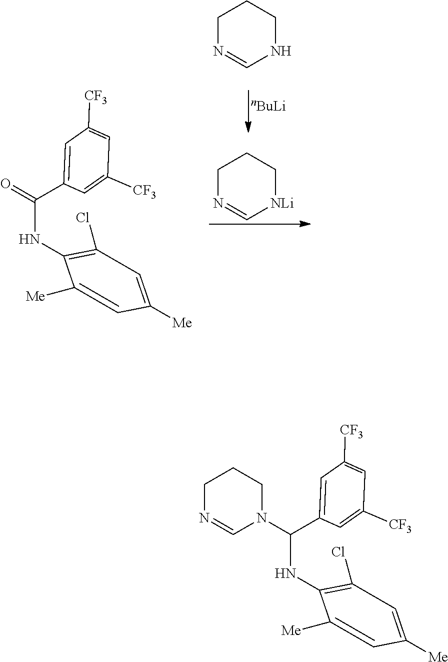

A solution of 1,4,5,6-tetrahydropyrimidine (˜0.156 g, ˜1.86 mmol) in THF was cooled to about −25° C., followed by dropwise addition of a solution of n-butyllithium (˜0.74 mL, ˜1.86 mmol) over a period of ˜2-3 minutes. During this time, a thick white precipitate was formed. This mixture was stirred ˜2 hours at room temperature to ensure completion of ligand deprotonation reaction. The mixture was again cooled to about −25° C., followed by dropwise addition of N-(2,6-diisopropylphenyl)acetimidoyl chloride (˜0.7 g, ˜1.69 mmol) in THF. The resulting mixture was stirred overnight at room temperature. Solvents were then removed in vacuo, and the dried material was extracted into dichloromethane. Solvent removal afforded the colorless crystalline solid of 1-(3,5-bis(trifluoromethyl)phenyl)-N-(2-chloro-4,6-dimethylphenyl)-1-(5,6-dihydropyrimidin-1 (4H)-yl)methanimine in ˜0.85 g (˜52%) yield. ¹H NMR (˜400 MHz, CD₂Cl₂): δ ˜1.81 ppm (2H, bs, —CH₂), ˜2.06 (3H, bs, CH₃), ˜2.11 ppm (3H, bs, CH₃), ˜3.47 ppm (2H, bs, —CH₂), ˜3.95 ppm (2H, bs, —CH₂), ˜6.75 ppm (1H, s, Ar—CH), ˜6.83 ppm (1H, s, Ar—CH), ˜7.29 ppm (1H, bs, —CH), ˜7.72 ppm (2H, bs, Ar—CH), ˜7.82 ppm (1H, bs, Ar—CH). ¹⁹F NMR (˜400 MHz, CD₂Cl₂): δ ˜−63.6 (s) ppm.

### Synthesis of N,N-1-[(3,5-bis(trifluoromethyl)phenyl)-N-(2-chloro-4,6-dimethylphenyl)]-3-[1-(2,6-diisopropylphenylimino)-ethyl]-4,5,6-trihydropyrimidinium chloride

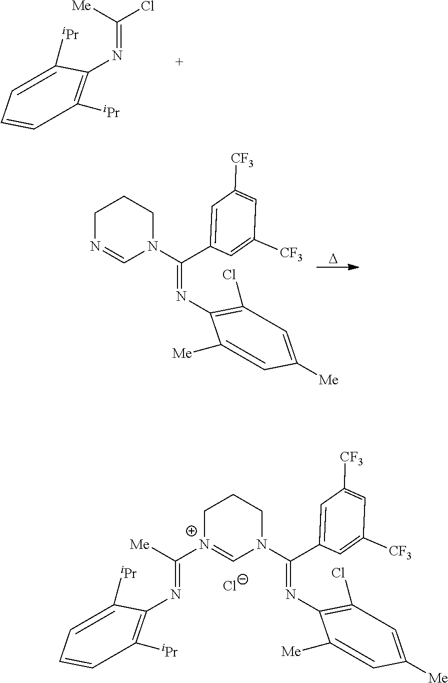

Solid 1-(3,5-bis(trifluoromethyl)phenyl)-N-(2-chloro-4,6-dimethylphenyl)-1-(5,6-dihydropyrimidin-1(4H)-yl)methanimine (˜0.38 g, ˜0.82 mmol) was dissolved in toluene and cooled to about −25° C., followed by addition of N-(2,6-diisopropylphenyl)acetimidoyl chloride (˜0.196 g, ˜0.82 mmol) in toluene. The reaction mixture was gradually warmed to room temperature and then refluxed for ˜48 hours. Progress of the reaction was monitored by NMR spectroscopy (¹⁹F and ¹H). Volatiles/solvent from the reaction mixture were removed under vacuum and triturated with pentane. The product was then washed with cold pentane to remove organic-soluble impurities, filtered, and dried under vacuum to obtain the colorless crystalline solid of N,N-1-[(3,5-bis(trifluoromethyl)phenyl)-N-(2-chloro-4,6-dimethylphenyl)]-3-[1-(2,6-diisopropylphenylimino)-ethyl]-4,5,6-trihydropyrimidinium chloride) in ˜0.35 g (˜61.1%) yield.

### Synthesis of {N,N-1-[(3,5-bis(trifluoromethyl)phenyl)-N-(2-chloro-4,6-dimethylphenyl)]-3-[1-(2,6-diisopropylphenylimino)-ethyl]-4,5,6-trihydropyrimid-2-ylidine}iron dichloride

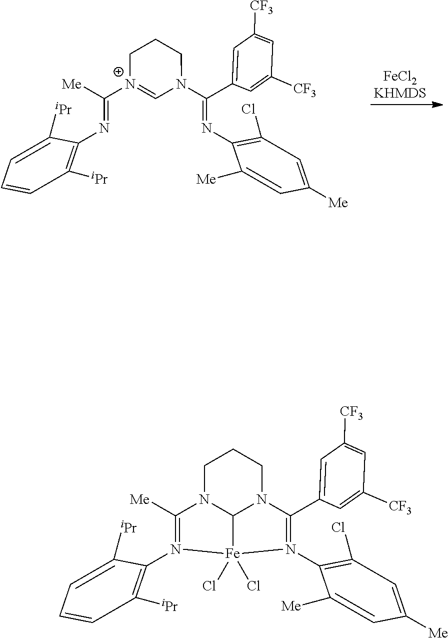

Solid FeCl₂ (˜0.07 g, ˜0.52 mmol) was slurried in THF and cooled to about −25° C., followed by dropwise addition of KHMDS (˜0.11 g, ˜0.52 mmol) in THF. The resulting mixture was occasionally agitated for ˜3 hours. This mixture was added to a pre-cooled THF solution of a N,N-1-[(3,5-bis(trifluoromethyl)phenyl)-N-(2-chloro-4,6-dimethylphenyl)]-3-[1-(2,6-diisopropylphenylimino)-ethyl]-4,5,6-trihydropyrimidinium chloride (˜0.35 g, ˜0.52 mmol) and stirred overnight at room temperature, during which the reaction mixture turned a dark brown color. The reaction mixture solvents were removed in vacuo and extracted into dichloromethane. The crude materials were washed with hexane to afford a brown solid of {N,N-1-[(3,5-bis(trifluoromethyl)phenyl)-N-(2-chloro-4,6-dimethylphenyl)]-3-[1-(2,6-diisopropylphenylimino)-ethyl]-4,5,6-trihydropyrimid-2-ylidine} iron dichloride in ˜0.25 g (˜60.8%) yield. ¹H NMR spectrum of {N,N-1-[(3,5-bis(trifluoromethyl)phenyl)-N-(2-chloro-4,6-dimethylphenyl)]-3-[1-(2,6-diisopropylphenyl-imino)-ethyl]-4,5,6-trihydropyrimid-2-ylidine} iron dichloride displayed very broad multiple resonances indicative of asymmetric, paramagnetic Fe(II) complexes in solution.

### Synthesis of N-(2,6-diisopropylphenyl)benzamide

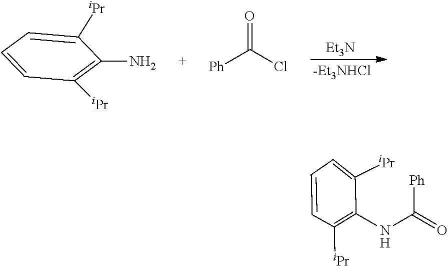

Neat benzoyl chloride (˜8.04 g, ˜57.2 mmol) was added drop-wise to a mixture of trimethylamine (˜5.79 g, ˜57.2 mmol) and 2,6-diisopropylaniline (˜10.14 g, ˜57.2 mmol) in dichloromethane at about −25° C. The resulting mixture was first gradually brought to room temperature and then refluxed for ˜3 hours. The reaction mixture solvents were removed and re-dissolved in dichloromethane, and the crude materials were washed with deionized water. The dichloromethane fraction was dried under magnesium sulphate and decanted. All volatiles were removed in vacuo and re-dissolved in toluene. The concentrated toluene solution of materials were stored at about −25° C. overnight to obtain a colorless crystalline solid of N-(2,6-diisopropylphenyl)benzamide in ˜15.50 g (˜96.3%) yield. ¹H NMR (˜400 MHz, CD₂Cl₂): δ ˜1.19 ppm (12H, d, iPr-CH₃), ˜3.15 ppm (2H, sept, iPr-CH), ˜7.25 ppm (2H, m, Ar—CH), ˜7.38 ppm (1H, ddd, Ar—CH), ˜7.49 ppm (2H, m, Ar—CH), ˜7.60 ppm (1H, bs, N—H), ˜7.57 ppm (1H, m, Ar—CH), ˜7.90 ppm (2H, m, Ar—CH).

### Synthesis of N-(2,6-diisopropylphenyl)benzimidoyl chloride

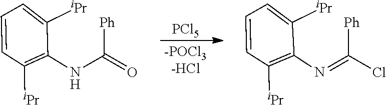 [SMILES: CC(C)c1cccc(C(C)C)c1NC(=O)c1ccccc1 ; "PCl5" ; CC(C)c1cccc(C(C)C)c1/N=C(/Cl)c1ccccc1]

Neat N-(2,6-diisopropylphenyl)benzamide (˜15.4 g, ˜54.8 mmol) was slurried in dry toluene and cooled to about −25° C.; to this, solid PCl₅(˜11.41 g, ˜54.8 mmol) was added slowly. The reaction mixture was gradually brought to room temperature and then heated at ˜60° C. for about an hour. The reaction mixture solvents were removed in vacuo and the crude materials extracted with hexane. Solvent removal resulted in a pale yellow crystalline solid of N-(2,6-diisopropylphenyl)benzimidoyl chloride in ˜14.8 g (˜90.2%) yield. ¹H NMR (˜400 MHz, CD₂Cl₂): δ ˜1.15 ppm (6H, d, iPr-CH₃), ˜1.22 ppm (6H, d, iPr-CH₃), ˜2.82 ppm (2H, sept, iPr-CH), ˜7.19 ppm (3H, m, Ar—CH), ˜7.53 ppm (2H, m, Ar—CH), ˜7.60 ppm (2H, m, Ar—CH), ˜8.21 ppm (2H, m, Ar—CH).

### Synthesis of Trifluoromethanesulfonic-N-(2,6-diisopropylphenyl)benzimidic anhydride

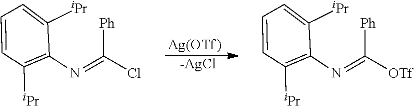

Neat N-(2,6-diisopropylphenyl)benzimidoyl chloride (˜1.67 g, ˜5.6 mmol) was dissolved in dry dichloromethane and cooled to about −25° C.; to this, solid Ag(OTf) (˜1.43 g, ˜5.6 mmol) was added slowly. The reaction mixture was gradually brought to room temperature and then continuously stirred at room temperature overnight. The reaction flask was covered with aluminum foil through-out the reaction progress. Insoluble AgCl byproduct was removed by filtration, and volatiles were removed in vacuo to obtain a colorless solid of trifluoromethanesulfonic-N-(2,6-diisopropylphenyl)benzimidic anhydride in ˜1.6 g (˜69.7%) yield. ¹⁹F NMR (˜400 MHz, CDCl₃): δ ˜−78.5 (s) ppm.

### Synthesis of N-(2-chloro-4,6-dimethylphenyl)-2,3,4,5,6-pentafluorobenzamide

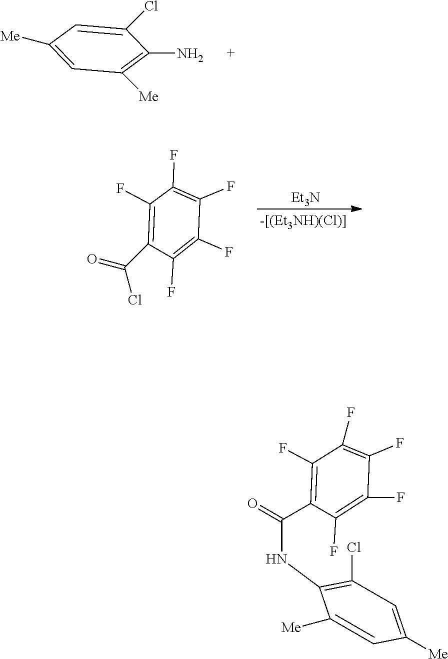 [SMILES: "Et3N" ; Cc1cc(C)c(N)c(Cl)c1 ; O=C(Cl)c1c(F)c(F)c(F)c(F)c1F ; Cc1cc(C)c(NC(=O)c2c(F)c(F)c(F)c(F)c2F)c(Cl)c1]

Neat 2,3,4,5,6-pentafluorobenzoyl chloride (˜10.0 g, ˜43.4 mmol) was added dropwise to the mixture of triethylamine (˜5.746 g, ˜56.4 mmol, ˜1.3 equ) and 2-chloro-4,6-dimethylaniline (˜6.80 g, ˜43.4 mmol) in dichloromethane at about −25° C. The resulting mixture was first warmed to room temperature and then refluxed overnight. The reaction mixture solvents were removed in vacuo and re-dissolved in dichloromethane, and this was washed with deionized water, saturated NH₄C₁/NaHCO₃, and brine solution. The organic fraction of the dichloromethane layer was dried over magnesium sulphate, and crude materials were re-dissolved in toluene and stored at about −25° C. Spectroscopically pure colorless crystalline materials of N-(2-chloro-4,6-dimethylphenyl)-2,3,4,5,6-pentafluorobenzamide were isolated in ˜6.26 g (˜41.0%) yield. ¹H NMR (˜400 MHz, CDCl₃): δ ˜2.3 ppm (6H, m, CH₃), ˜7.05 ppm (1H, m, Ar—CH), ˜7.17 ppm (1H, m, Ar—CH), ˜9.51 ppm (1H, s, NH). ¹⁹F NMR (˜400 MHz, CDCl₃): δ ˜−163.3 ppm, ˜−155.1 ppm, ˜−142.2 (m) ppm.

### Synthesis of N-(2-chloro-4,6-dimethylphenyl)-2,3,4,5,6-pentafluorobenzimidoyl chloride

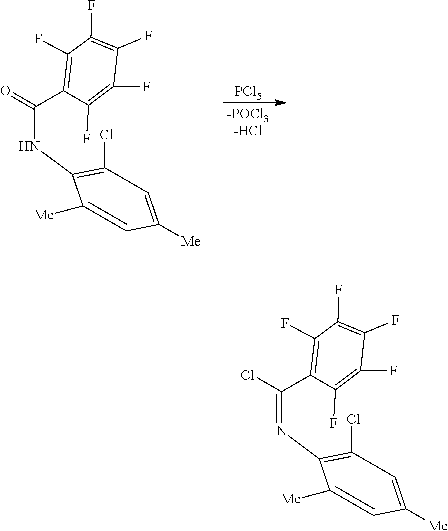 [SMILES: Cc1cc(C)c(NC(=O)c2c(F)c(F)c(F)c(F)c2F)c(Cl)c1 ; "PCl5" ; Cc1cc(C)c(/N=C(/Cl)c2c(F)c(F)c(F)c(F)c2F)c(Cl)c1]

Neat N-(2-chloro-4,6-dimethylphenyl)-2,3,4,5,6-pentafluorobenzamide (˜6.26 g, ˜17.9 mmol) was slurried in dry toluene and cooled to about −25° C.; to this, solid PC15 (˜3.73 g, ˜17.9 mmol) was added over a period of ˜5-10 minutes. Over the course of addition, HCl gas was evolved and the slurry gradually dissolved to become a clear yellow solution. The resulting mixture was stirred overnight at room temperature, and then solvents or volatiles were removed in vacuo. The crude materials were washed with cold pentane to get rid of organic-soluble impurities and extracted with diethyl ether (to remove insoluble materials), affording a colorless crystalline material of N-(2-chloro-4,6-dimethylphenyl)-2,3,4,5,6-pentafluorobenzimidoyl chloride in ˜5.8 g (˜88.0%) yield. No phosphorus impurities were observed in the final materials, which was confirmed by absence of phosphorus signal in the ³¹P NMR spectrum. ¹H NMR (˜400 MHz, CD₂Cl₂): δ ˜2.16 ppm and ˜2.33 ppm (6H, s, CH₃), ˜7.08 ppm (2H, m, Ar—CH). ¹⁹F NMR (˜400 MHz, C₆D₆): δ ˜−160.9 ppm, ˜−151.5 ppm, ˜−150.3 ppm, ˜−140.7 ppm, ˜−140.0 (m) ppm.

### Synthesis of N-(2-chloro-4,6-dimethylphenyl)-1-(5,6-dihydropyrimidin-1(4H)-yl)-1-(perfluorophenyl)methanimine

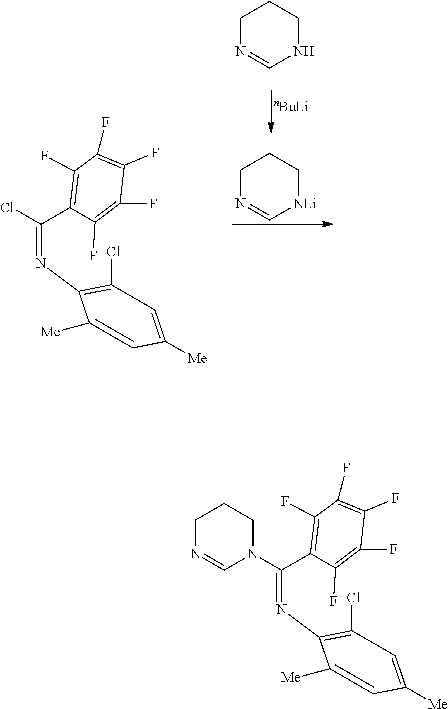

A solution of 1,4,5,6-tetrahydropyrimidine (˜0.343 g, ˜4.1 mmol) in THF was cooled to about −25° C., and, to this, a solution of n-butyllithium (˜1.7 mL, ˜4.2 mmol, ˜1.02 equ) was added drop-wise over a period of ˜2-3 minutes. During this time, a thick white precipitate was formed. This mixture was stirred ˜2 hours at room temperature to ensure completion of ligand deprotonation reaction. The mixture was again cooled to about −25° C., and N-(2-chloro-4,6-dimethylphenyl)-2,3,4,5,6-pentafluorobenzimidoyl chloride (˜1.5 g, ˜4.1 mmol) in THF was added drop-wise. The resulting mixture was stirred overnight at room temperature. Solvents were removed in vacuo and then extracted into dichloromethane. Solvent removal afforded the colorless crystalline solid of N-(2-chloro-4,6-dimethylphenyl)-1-(5,6-dihydropyrimidin-1(4H)-yl)-1-(perfluorophenyl)methanimine in ˜1.6 g (˜94.4%) yield. ¹H NMR (˜400 MHz, C₆D₆): δ ˜1.39 ppm (2H, s, —CH₂), ˜1.92 ppm (3H, bs, CH₃), ˜2.14 ppm (3H, bs, CH₃), ˜2.86 ppm (2H, bs, —CH₂), ˜3.28 ppm (2H, bs, —CH₂), ˜6.63 ppm (1H, s, —CH), ˜7.00 ppm (2H, s, Ar—CH). ¹⁹F NMR (˜400 MHz, C₆D₆): δ ˜−148.9 ppm, ˜140.7 (m) ppm.

### Synthesis of 3-(2-chloro-4,6-dimethylphenyl)imino)(perfluorophenyl)methyl)-1-(2,6-diisopropylphenyl)imino)(phenyl)methyl)-3,4,5,6-tetrahydropyrimidin-1-ium trifluoromethane sulfonate

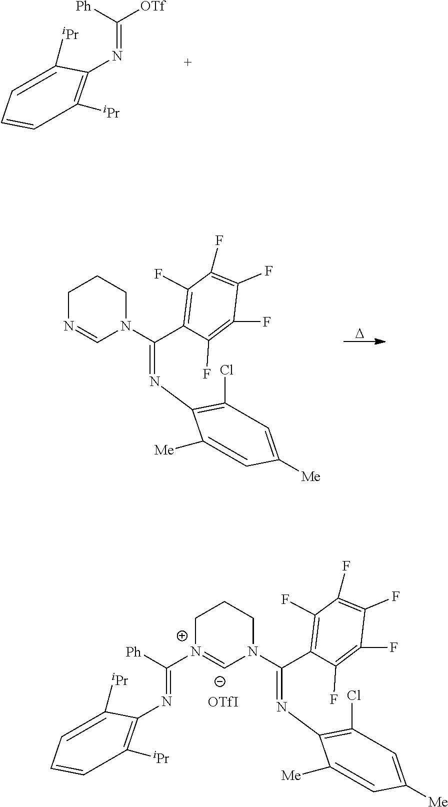

Solid N-(2-chloro-4,6-dimethylphenyl)-1-(5,6-dihydropyrimidin-1(4H)-yl)-1-(perfluorophenyl)methanimine (˜0.82 g, ˜2.0 mmol) was dissolved in toluene and cooled to about −25° C.; to this, solid trifluoromethanesulfonic-N-(2,6-diisopropylphenyl)benzimidic anhydride (˜0.82 g, ˜2.0 mmol) in toluene was added. The reaction mixture was gradually warmed to room temperature and then refluxed for ˜48 hours. Progress of the reaction was monitored by NMR spectroscopy methods (both ¹⁹F and ¹H). Volatiles from the reaction mixture were removed under vacuum and triturated with pentane. The product was then washed with cold pentane to get rid of organic-soluble impurities and dried under vacuum to obtain the colorless crystalline solid of 3-(2-chloro-4,6-dimethylphenyl)imino) (perfluorophenyl)methyl)-1-(2,6-diisopropylphenyl)imino)(phenyl)methyl)-3,4,5,6-tetrahydropyrimidin-1-ium trifluoromethane sulfonate in ˜1.3 g (˜78.4%) yield.

### Synthesis of 3-(2-chloro-4,6-dimethylphenyl)imino)(perfluorophenyl)methyl)-1-(2,6-diisopropylphenyl)imino)(phenyl)methyl)-3,4,5,6-tetrahydropyrimidin-1-iron dichloride

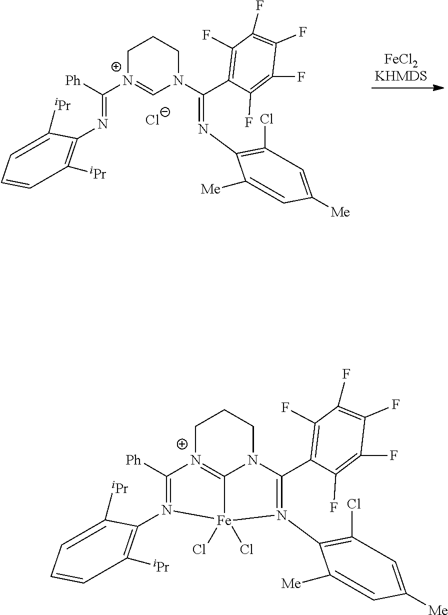

Solid FeCl₂ (˜0.19 g, ˜1.53 mmol) was slurried in THF and cooled to ˜−25° C.; to this, a pre-cooled solution of KHMDS (˜0.32 g, ˜1.61 mmol, ˜1.05 equ) in THF was added dropwise, and then the resulting mixture was occasionally agitated for ˜3 hours. This was added to a pre-cooled THF solution of a pro-ligand (˜1.27 g, ˜1.53 mmol) and stirred overnight at room temperature. The reaction mixture turned dark brown over a period of time, after which the reaction mixture solvents were removed in vacuo and extracted into dichloromethane. The crude materials were finally washed with hexane to afford a brown solid of 3-(2-chloro-4,6-dimethylphenyl)imino)(perfluorophenyl)methyl)-1-(2,6-diisopropylphenyl)imino)(phenyl)methyl)-3,4,5,6-tetrahydropyrimidin-1-iron dichloride in ˜0.87 g (˜70.5%) yield. ¹H NMR spectrum of this compound displayed very broad multiple resonances, suggested to be asymmetric, paramagnetic Fe(II) complexes in solution.

### Formation of Supported Catalysts

SMAO:

Methylalumoxane treated silica was prepared in a manner similar to the following: in a ˜4 L stirred vessel in a drybox, methylalumoxane (MAO, ˜30 wt % in toluene, ˜1 kg) was added, along with ˜2 kg of toluene. This solution was then stirred at ˜60 RPM for ˜5 minutes. Next, ˜800 grams of ES-70™ silica (PQ Corporation, Conshohocken, Pa.) that had been calcined at ˜875° C. (see below) was added to the vessel. This slurry was then heated at ˜100° C. and stirred at ˜120 RPM for ˜3 hours. The temperature was then reduced to ˜25° C. and cooled to temperature over ˜2 hours. Once cooled, the vessel was set to ˜8 RPM and placed under vacuum for ˜72 hours. After emptying the vessel and sieving the supported MAO, ˜1.1 kg of supported MAO was collected.

ES70™ silica that had been calcined at 875° C. is ES70™ silica calcined at ˜880° C. for ˜4 hours after being ramped to 880° C. according to the following ramp rates.

| ° C. | ° C./hr | ° C. |
|---|---|---|
| ambient | 100 | 200 |
| 200 | 50 | 300 |
| 300 | 133 | 400 |
| 400 | 200 | 800 |
| 800 | 50 | 880 |

### Supportation on SMAO

Supported Mixed Catalyst 1/3:

Catalyst 1 (˜0.028 g, ˜36.0 mmol) and Catalyst 3 (˜0.002 g ˜4.0 mmol) were added to a slurry of ˜1.0 g silica-supported methylalumoxane (SMAO) in ˜10 mL toluene in a Celestir™ vessel. This slurry/mixture was stirred for about 3 hours, filtered, and washed with toluene (1×10 mL) and then hexane (2×10 mL). The supported mixed catalyst was then dried under vacuum overnight (˜8-16 hours) to obtain ˜0.91 g beige colored supported silica.

Supported Mixed Catalyst 2/3:

Catalyst 2 (˜0.029 g, ˜36.0 mmol) and Catalyst 3 (˜0.002 g, ˜4.0 mmol) were added to a slurry of ˜1.0 g SMAO in ˜10 mL toluene in a Celestir™ vessel. This slurry/mixture was stirred for about 3 hours, filtered, and washed with toluene (1×10 mL) and then hexane (2×10 mL). The supported mixed catalyst was then dried under vacuum overnight to obtain ˜0.92 g beige colored supported silica.

### Polymerization

A ˜2 L autoclave was heated to ˜110° C. and purged with N₂ for at least 30 minutes. It was then charged with dry NaCl (˜350 g; Fisher, S271-10 dehydrated at ˜180° C., subjected to several pump/purge cycles, and finally passed through a ˜16 mesh screen prior to use) and SMAO (˜5 g) at ˜105° C. and stirred for ˜30 minutes. The temperature was then adjusted to ˜85° C. At a pressure of ˜2 psig N₂, dry, degassed 1-hexene was added to the reactor with a syringe, and the reactor was then charged with N₂ to a pressure of ˜20 psig. A mixture of H₂ and N₂ was flowed into reactor (˜10% H₂ in N₂) while stirring the bed. Precharges of H₂ and 1-hexene, as well as flow ratios of each to ethylene, were as follows: ˜120 (ml) hydrogen, 1-hexene ˜2.5 ml.

Thereafter, Supported Mixed Catalyst 1/3 or Supported Mixed Catalyst 2/3 was injected into the reactor with ethylene at a pressure of ˜220 psig; ethylene flow was allowed over the course of the run to maintain constant pressure in the reactor. 1-hexene was fed into the reactor as a ratio to ethylene flow (˜0.1 g/g). Hydrogen was fed to the reactor as a ratio to ethylene flow (˜0.5 mg/g). The hydrogen and ethylene ratios were measured by on-line GC analysis. Polymerizations were halted after ˜1 hour by venting the reactor, cooling to room temperature, then exposing to air. The salt was removed by washing with water two times; the polymer was isolated by filtration, briefly washed with acetone, and dried in air for at least two days.

### NMR Spectroscopy of Polymer Samples

¹H NMR data was collected at ˜393° K in a ˜10 mm probe using a Bruker spectrometer with a ¹H frequency of at least ˜400 MHz (available from Agilent Technologies, Santa Clara, Calif.). Data was recorded using a maximum pulse width of ˜45°, ˜5 seconds between pulses and signal averaging ˜512 transients. Spectral signals were integrated, and the number of unsaturation types per 1,000 carbons was calculatable by multiplying the different groups by 1,000 and dividing the result by the total number of carbons. The number average molecular weight (Mn) was calculated by dividing the total number of unsaturated species into 14,000 and is reported herein in units of g/mol.

GPC 4D Procedure: Molecular Weight, Comonomer Composition and Long Chain Branching Determination by GPC-IR Hyphenated with Multiple Detectors

Unless otherwise indicated, the distribution and the moments of molecular weight (Mw, Mn, Mw/Mn, etc.), the comonomer content (C₂, C₃, C₆, etc.) and the branching index (g′ᵥᵢₛ) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 ml/min and the nominal injection volume is 200 μL. The whole system including transfer lines, columns, and detectors are contained in an oven maintained at 145° C. The polymer sample is weighed and sealed in a standard vial with 80-L flow marker (Heptane) added to it. After loading the vial in the autosampler, polymer is automatically dissolved in the instrument with 8 ml added TCB solvent. The polymer is dissolved at 160° C. with continuous shaking for about 1 hour for most PE samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{PS} / K )}{a + 1} + \frac{{a}_{PS} + 1}{a + 1} log {M}_{PS}$$

where the variables with subscript “PS” stand for polystyrene while those without a subscript are for the test samples. In this method, α_{PS}=0.67 and K_{PS}=0.000175 while a and K are for other materials as calculated and published in literature (Sun, T. et al. (2001) “Effect of Short Chain Branching on the Coil Dimensions of Polyolefins in Dilute Solution,” Macromolecules, v. 34, pp. 6812-6820), except that for purposes of the present disclosure, α=0.695 and K=0.000579 for linear ethylene polymers, α=0.705 and K=0.0002288 for linear propylene polymers, α=0.695 and K=0.000181 for linear butene polymers, a is 0.695 and K is 0.000579*(1−0.0087*w2b+0.000018*(w2b)\hat{ }2) for ethylene-butene copolymer where w2b is a bulk weight percent of butene comonomer, a is 0.695 and K is 0.000579*(1-0.0075*w2b) for ethylene-hexene copolymer where w2b is a bulk weight percent of hexene comonomer, and a is 0.695 and K is 0.000579*(1−0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1,000 total carbons (CH₃/1,000 TC) as a function of molecular weight. The short-chain branch (SCB) content per 1000 TC (SCB/1,000 TC) is then computed as a function of molecular weight by applying a chain-end correction to the CH₃/1,000 TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

w2=f*SCB/1000 TC.

The bulk composition of the polymer from the GPC-IR and GPC-4D analyses is obtained by considering the entire signals of the CH₃ and CH₂ channels between the integration limits of the concentration chromatogram. First, the following ratio is obtained.

$$Bulk IR ratio = \frac{Area of {CH}_{3} signal within integration limits}{Area of {CH}_{2} signal within integration limits}$$

Then the same calibration of the CH₃ and CH₂ signal ratio, as mentioned previously in obtaining the CH₃/1,000 TC as a function of molecular weight, is applied to obtain the bulk CH₃/1,000 TC. A bulk methyl chain ends per 1,000 TC (bulk CH₃end/1,000 TC) is obtained by weight-averaging the chain-end correction over the molecular-weight range. Then

w2b=f*bulk CH₃/1000 TC

bulk SCB/1000 TC=bulk CH₃/1000 TC−bulk CH₃end/1000 TC

and bulk SCB/1000 TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system:

$${K}_{o} = \frac{4 {π}^{2} {{n}^{2} ( dn / d c )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K_{PS}M^{α}^{_{PS}}⁺¹/[r], where α_{PS} is 0.67 and K_{PS} is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits. The branching index g′ᵥᵢₛ is defined as

$${g}_{vis}^{′} = \frac{{[ η ]}_{avg}}{{KM}_{v}^{α}} ,$$

where M_{V} is the viscosity-average molecular weight based on molecular weights determined by LS analysis and the K and α are for the reference linear polymer, which are, for purposes of the present disclosure, α=0.695 and K=0.000579 for linear ethylene polymers, α=0.705 and K=0.0002288 for linear propylene polymers, α=0.695 and K=0.000181 for linear butene polymers, a is 0.695 and K is 0.000579*(1−0.0087*w2b+0.000018*(w2b)\hat{ }2) for ethylene-butene copolymer where w2b is a bulk weight percent of butene comonomer, α is 0.695 and K is 0.000579*(1−0.0075*w2b) for ethylene-hexene copolymer where w2b is a bulk weight percent of hexene comonomer, and a is 0.695 and K is 0.000579*(1−0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

Table 1 illustrates data of copolymerized ethylene-hexene formed by the mixed catalyst systems containing catalysts 1/3 (90:10) and 2/3 (90:10). As shown in Table 1, the ethylene-hexene copolymers formed by both mixed catalyst systems produce polymers with high comonomer content but also with a high molecular weight tail.

TABLE 1

| | | | | Prod. | | | | |
|---|---|---|---|---|---|---|---|---|
| Cat. | C₆ | Yield | Supported | (g Pol./g | Mn; Mw; | | | Fe |
| Syst. | (mL) | (g) | Cat. mgs | suppd. cat.) | Mz (g/mol) | g′ vis | C₆ wt % | (ppm) |
| 1/3 | 2.5 | 15.5 | 13.6 | 1140 | 12,640; | 0.96 | 8.69 | 3 |
| | | | | | 158,900; | | | |
| | | | | | 1,878,000 | | | |
| 2/3 | 2.5 | 6.3 | 13.5 | 467 | 10,600; | 0.99 | 7.06 | 7 |
| | | | | | 161,800; | | | |
| | | | | | 1,994,000 | | | |

It is noteworthy that these mixed catalyst systems seem to readily form ethylene-hexene copolymers (incorporate hexene comonomers in ethylene polymerizations), even though catalyst compound 3 (the bisiminopyridyl iron compound), as the second catalyst compound in the mixed catalyst system, typically does not yield ethylene-hexene copolymers when it is the sole catalyst compound in a catalyst system.

The FIG. is a 4D-GPC spectrum of the ethylene-hexene copolymer formed by the mixed catalyst system containing catalysts 1/3 (90/10). As shown in the FIG., comonomer content ranges from about 2 wt % to about 14 wt %, with an average of ˜9 wt %. At least between log M values of ˜3.7 and ˜5.5, the comonomer content line has a positive slope, indicative of broad orthogonal composition distribution (BOCD), in which the comonomer is incorporated predominantly in the high molecular weight chains which can provide improved physical properties, for example toughness properties and environmental stress crack resistance (ESCR).

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

What is claimed is:

1. A process for the production of an ethylene alpha-olefin copolymer comprising:
polymerizing ethylene and at least one C₃-C₂₀ alpha-olefin by contacting the ethylene and the at least one C₃-C₂₀ alpha-olefin with a mixed catalyst system comprising at least one activator, a first catalyst compound, and a second catalyst compound different from the first catalyst compound, the polymerizing occurring in at least one gas phase reactor or at least one slurry phase at a reactor pressure of from 0.7 to 70 bar and a reactor temperature from 20° C. to 150° C. to form an ethylene alpha-olefin copolymer,
the first catalyst compound represented by Formula (I): 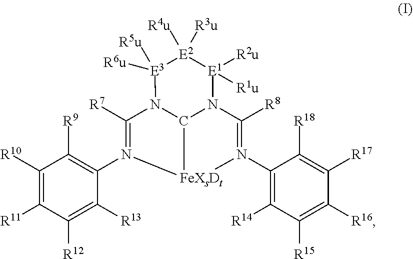
wherein:
each of R¹, R², R³, R⁴, R⁵, R⁶, R⁹, R¹⁰, R¹¹, R¹², R¹³, R¹⁴, R¹⁵, R¹⁶, R¹⁷, and R¹⁸ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, alkylaryl wherein alkyl has from 1 to 10 carbon atoms and aryl has from 6 to 20 carbon atoms, —NR′₂, —OR′, halogen, —NO₂, —SiR′₃, or five-, six-, or seven-membered heterocyclyl comprising at least one atom selected from N, P, O, and S, wherein R¹, R², R³, R⁴, R⁵, R⁶, R⁹, R¹⁰, R¹¹, R¹², R¹³, R¹⁴, R¹⁵, R¹⁶, R¹⁷, and R¹⁸ are optionally substituted by halogen, —NO₂, —CF₃, —CF₂CF₃, —CH₂CF₃, —NR′₂, —OR′, or —SiR″₃, wherein each R′ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR″₃, wherein R′ is optionally substituted by halogen, or two R′ radicals optionally bond to form a five- or six-membered ring, wherein each R″ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or two R″ radicals optionally bond to form a five- or six-membered ring;
each of R¹ and R⁸ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or five-, six-, or seven-membered heterocyclyl comprising at least one atom selected from N, P, O, and S, wherein each of R⁷ and R⁸ is optionally substituted by halogen, —NR′₂, —OR′, or —SiR″₃, wherein R⁷ optionally bonds with R⁵ or R⁶, and R⁸ optionally bonds with R¹ or R², in each case to independently form a five-, six- or seven-membered ring;
each of E¹, E², and E³ is independently carbon, nitrogen, or phosphorus;
u is 1 for R¹u and R²u if E¹ is carbon, u is 1 for R³u and R⁴u if E² is carbon, and u is 1 for R⁵u and R⁶u if E³ is carbon;
u is 0 for R²u and 1 for R¹u if E¹ is nitrogen or phosphorus, u is 0 for R⁴u and 1 for R³u if E² is nitrogen or phosphorus, and u is 0 for R⁶u and 1 for R⁵u if E³ is nitrogen or phosphorus;
each X is independently fluorine, chlorine, bromine, iodine, hydrogen, C₁-C₂₀-alkyl, C₂-C₁₀-alkenyl, C₆-C₂₀-aryl, arylalkyl wherein alkyl has from 1 to 10 carbon atoms and aryl has from 6 to 20 carbon atoms, —NR′″₂, —OR′″, —SR′″, —SO₃R′″, —OC(O)R′″, —CN, —SCN, 0-diketonate, —CO, —BF₄, —PF₆ or bulky non-coordinating anions, or the radicals X are bonded with one another, wherein each R′″ is independently hydrogen, C₁-C₂₀-alkyl, C₂-C₂₀-alkenyl, C₆-C₂₀-aryl, arylalkyl where alkyl has from 1 to 10 carbon atoms and aryl has from 6 to 20 carbon atoms, or —SiR″″₃, wherein R′″can be substituted by halogen or nitrogen- or oxygen-containing groups or two R′″radicals optionally bond to form a five- or six-membered ring, wherein each R″″ is independently hydrogen, C₁-C₂₀-alkyl, C₂-C₂₀-alkenyl, C₆-C₂₀-aryl or arylalkyl where alkyl has from 1 to 10 carbon atoms and aryl has from 6 to 20 carbon atoms, wherein R″″ can be substituted by halogen or nitrogen- or oxygen-containing groups or two R″″ radicals optionally bond to form a five- or six-membered ring;
s is 1, 2, or 3;
D is a neutral donor; and
t is 0, 1, or 2;
the second catalyst compound represented by formula (IV): 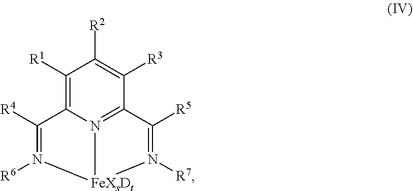
wherein:
each of R¹, R², and R³ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O and S; wherein any one or more of R¹, R², and R³ are optionally substituted by halogen, —CF₃, —CF₂CF₃, —CH₂CF₃, —NO₂, —NR′₂, —OR′, or —SiR″₃; wherein each R′ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR″₃; wherein any one or more R′ radicals is optionally substituted by halogen, or two R′ radicals optionally bond to form a five- or six-membered ring; wherein each R″ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms; wherein two R″ radicals optionally bond to form a five- or six-membered ring;
each of R⁴ and R⁵ is independently C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or five-, six-, or seven-membered heterocyclyl comprising at least one atom selected from N, P, O, and S; wherein each of R⁴ and R⁵ is optionally individually substituted by halogen, —NR′₂, —OR′, or —SiR″₃; wherein R⁴ optionally bonds with R¹, and/or wherein R⁵ optionally bonds with R³, in each case to independently form a five-, six- or seven-membered ring;
each of R⁶ and R⁷ is independently C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O and S; wherein each of R⁴ and R⁵ is optionally individually substituted by halogen, —CF₃, —CF₂CF₃, —CH₂CF₃, —NO₂, —NR′₂, —OR′, or —SiR″₃;
each X is independently fluorine, chlorine, bromine, iodine, hydrogen, C₁-C₂₀-alkyl, C₂-C₁₀-alkenyl, C₆-C₂₀-aryl, arylalkyl where alkyl has from 1 to 10 carbon atoms and aryl has from 6 to 20 carbon atoms, —NR′″₂, —OR′″, —SR′″, —SO₃R′″, —OC(O)R′″, —CN, —SCN, β-diketonate, —CO, —BF₄, —PF₆—, or bulky non-coordinating anions, wherein X radicals are optionally bonded with one another; wherein each R′″ is independently hydrogen, C₁-C₂₀-alkyl, C₂-C₂₀-alkenyl, C₆-C₂₀-aryl, arylalkyl where alkyl has from 1 to 10 carbon atoms and aryl has from 6 to 20 carbon atoms, or —SiR″″₃; wherein one or more R′″ is optionally substituted by halogen or nitrogen- or oxygen-containing groups, or two R′″radicals optionally bond to form a five- or six-membered ring; wherein each R″″ is independently hydrogen, C₁-C₂₀-alkyl, C₂-C₂₀-alkenyl, C₆-C₂₀-aryl or arylalkyl where alkyl has from 1 to 10 carbon atoms and aryl has from 6 to 20 carbon atoms; wherein one or more R″″ is optionally substituted by halogen or nitrogen- or oxygen-containing groups, or two R″″ radicals optionally bond to form a five- or six-membered ring;
s is 1, 2, or 3;
D is a neutral donor; and
t is 0, 1 or 2.

2. The process of claim 1, wherein, in the first catalyst compound of formula (I), each of E¹, E², and E³ is carbon, u is 1 for R¹u, R²u, R³u, R⁴u, R⁵u, and R⁶u; and each of R¹, R², R³, R⁴, R⁵, and R⁶ is hydrogen.

3. The process of claim 1, wherein, in the first catalyst compound of formula (I), each X is independently fluorine, chlorine, bromine, iodine, or C₁-C₂₀-alkyl.

4. The process of claim 1, wherein, in the first catalyst compound of formula (I), t is 0.

5. The process of claim 1, wherein the first catalyst compound is represented by formula (II): 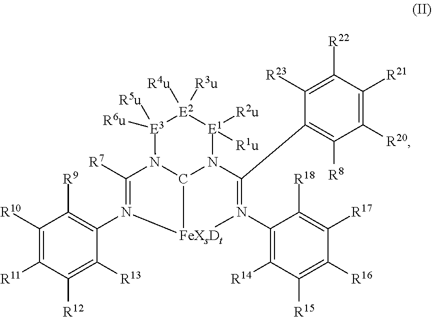
wherein:
each of R¹, R², R³, R⁴, R⁵, R⁶, R⁸, R⁹, R¹⁰, R¹¹, R¹², R¹³, R¹⁴, R¹⁵, R¹⁶, R¹⁷, R¹⁸, R²⁰, R²¹, R²², and R²³ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, alkylaryl wherein alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O, and S; wherein R¹, R², R³, R⁴, R⁵, R⁶, R⁸, R⁹, R¹⁰, R¹¹, R¹², R¹³, R¹⁴, R¹⁵, R¹⁶, R¹⁷, R¹⁸, R²⁰, R²¹, R²², and R²³ are optionally substituted by halogen, —NO₂, —CF₃, —CF₂CF₃, —CH₂CF₃, —NR′₂, —OR′, or —SiR″₃, wherein each R′ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR″₃, wherein R′ is optionally substituted by halogen, or two R′ radicals optionally bond to form a five- or six-membered ring, wherein each R″ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or two R″ radicals optionally bond to form a five- or six-membered ring;
R⁷ is hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or five-, six- or seven-membered heterocyclyl comprising at least one atom selected from N, P, O, and S; wherein R⁷ is optionally substituted by halogen, —NR′₂, —OR′, or —SiR″₃, or R⁷ optionally bonds with R⁵ or R⁶ to independently form a five-, six-, or seven-membered ring;
each of E¹, E², and E³ is independently carbon, nitrogen or phosphorus;
u is 1 for R¹u and R²u if E¹ is carbon, u is 1 for R³u and R⁴u if E² is carbon, and u is 1 for R⁵u and R⁶u if E³ is carbon;
u is 0 for R²u and 1 for R¹u if E¹ is nitrogen or phosphorus, u is 0 for R⁴u and 1 for R³u if E² is nitrogen or phosphorus, and u is 0 for R⁶u and 1 for R⁵u if E³ is nitrogen or phosphorus;
each X is independently fluorine, chlorine, bromine, iodine, hydrogen, C₁-C₂₀-alkyl, C₂-C₁₀-alkenyl, C₆-C₂₀-aryl, arylalkyl where alkyl has from 1 to 10 carbon atoms and aryl has from 6 to 20 carbon atoms, —NR′″₂, —OR′″, —SR′″, —SO₃R′″, —OC(O)R′″, —CN, —SCN, β-diketonate, —CO, —BF₄⁻, —PF₆⁻ or bulky non-coordinating anions, or the radicals X are bonded with one another, wherein each R′″ is independently hydrogen, C₁-C₂₀-alkyl, C₂-C₂₀-alkenyl, C₆-C₂₀-aryl, arylalkyl where alkyl has from 1 to 10 carbon atoms and aryl has from 6 to 20 carbon atoms, or —SiR″″₃, wherein R′″can be substituted by halogen or nitrogen- or oxygen-containing groups or two R′″radicals optionally bond to form a five- or six-membered ring. Each R″″ is independently hydrogen, C₁-C₂₀-alkyl, C₂-C₂₀-alkenyl, C₆-C₂₀-aryl or arylalkyl where alkyl has from 1 to 10 carbon atoms and aryl has from 6 to 20 carbon atoms, wherein R″″ can be substituted by halogen or nitrogen- or oxygen-containing groups or two R″″ radicals optionally bond to form a five- or six-membered ring.
s is 1, 2, or 3;
D is a neutral donor; and
t is 0, 1, or 2.

6. The process of claim 5, wherein, in the first catalyst compound of formula (II), t is 0.

7. The process of claim 5, wherein, in the first catalyst compound of formula (II), each of R⁹, R¹⁰, R¹¹, R¹², and R¹³ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or alkylaryl wherein alkyl has from 1 to 10 carbon atoms and aryl has from 6 to 20 carbon atoms, and R⁹, R¹⁰, R¹¹, R¹², and R¹³ are optionally substituted by —NR′₂, —OR′, or —SiR″₃, wherein each R′ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or —SiR″₃, wherein R′ is optionally substituted by halogen, or two R′ radicals optionally bond to form a five- or six-membered ring, wherein each R″ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or two R″ radicals optionally bond to form a five- or six-membered ring.

8. The process of claim 5, wherein, in the first catalyst compound of formula (II), R⁷ is substituted phenyl, unsubstituted phenyl, or C₁-C₁₀-alkyl.

9. The process of claim 8, wherein, in the first catalyst compound of formula (II), R⁷ is methyl.

10. The process of claim 5, wherein, in the first catalyst compound of formula (II), R⁷ is substituted phenyl represented by the structure: 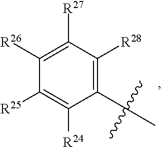
wherein each of R²⁴, R²⁵, R²⁶, R²⁷, and R²⁸ is independently hydrogen, C₁-C₁₀-alkyl, —OR′, wherein R′ is hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or —SiR″₃, wherein R′ is optionally substituted by halogen, or two R′ radicals optionally bond to form a five- or six-membered ring, wherein each R″ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or two R″ radicals optionally bond to form a five- or six-membered ring.

11. The process of claim 10, wherein each of R²⁴, R²⁵, R²⁶, R²⁷, and R²⁸ is independently hydrogen or C₁-C₁₀-alkyl.

12. The process of claim 5, wherein, in the first catalyst compound of formula (II), each of R⁸, R¹⁴, R¹⁵, R¹⁶, R¹⁷, R¹⁸, R²⁰, R²¹, R²², and R²³ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, alkylaryl wherein alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O, and S.

13. The process of claim 12, wherein, in the first catalyst compound of formula (II), each of R⁸, R¹⁴, R¹⁵, R¹⁶, R¹⁷, R¹⁸, R²⁰, R²¹, R²², and R²³ is independently hydrogen, C₁-C₂₂-alkyl, C₂-C₂₂-alkenyl, C₆-C₂₂-aryl, arylalkyl wherein alkyl has from 1 to 10 carbon atoms and aryl has from 6 to 20 carbon atoms, or alkylaryl wherein alkyl has from 1 to 10 carbon atoms and aryl has from 6 to 20 carbon atoms, wherein at least one of R⁸, R¹⁴, R¹⁵, R¹⁶, R¹⁷, R¹⁸, R²⁰, R²¹, R²², and R²³ is substituted by —NO₂, —CF₃, —CF₂CF₃, —CH₂CF₃, halogen, —NR′₂, —OR′, or —SiR″₃.

14. The process compound of claim 12, wherein, in the first catalyst compound of formula (II), R⁸, R¹⁴, R¹⁵, R¹⁶, R¹⁷, R¹⁸, R²⁰, R²¹, R²², and R²³ is independently halogen, hydrogen, or C₁-C₂₂-alkyl, wherein C₁-C₂₂-alkyl is substituted with one or more halogen atoms.

15. The process of claim 12, wherein, in the first catalyst compound of formula (II), each of R⁸, R²⁰, R²¹, R²², and R²³ is halogen or trihalomethyl and each of R¹⁴, R¹⁵, R¹⁶, R¹⁷, and R¹⁸ is hydrogen, C₁-C₁₀ alkyl, or halogen.

16. The process of claim 12, wherein, in the first catalyst compound of formula (II), at least one of R⁸, R²⁰, R²¹, R²², and R²³ is halogen or trihalomethyl and at least one of R¹⁴, R¹⁵, R¹⁶, R¹⁷, and R¹⁸ is C₁-C₁₀ alkyl or halogen.

17. The catalyst compound of claim 1, wherein the first catalyst compound of formula (I) is one or more of:

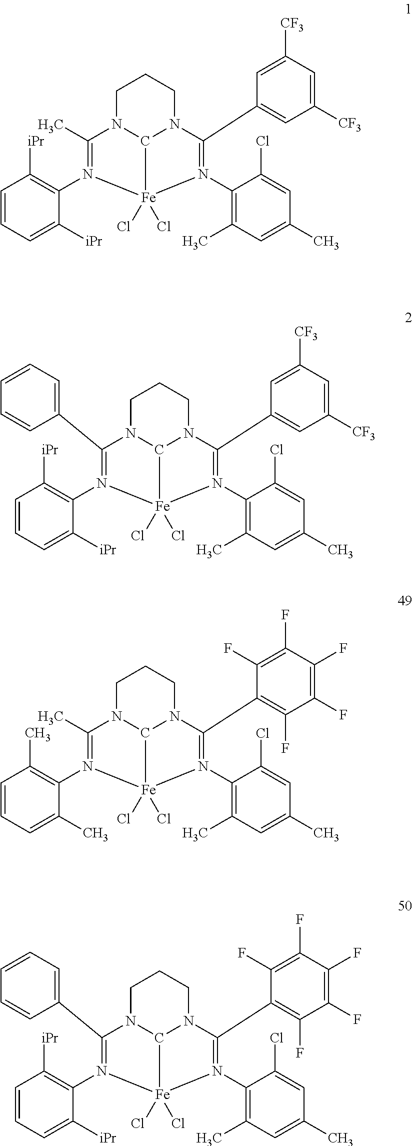

18. The process of claim 1, wherein the second catalyst compound of formula (IV) is symmetric because R⁴ and R⁵ are identical.

19. The process of claim 18, wherein t is 0.

20. The process of claim 1, wherein the second catalyst compound is represented by formula (V): 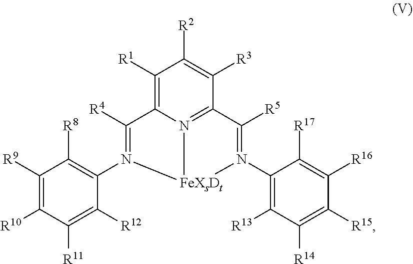
wherein:
each of R¹, R², and R³ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O and S; wherein any one or more of R¹, R², and R³ are optionally substituted by halogen, —CF₃, —CF₂CF₃, —CH₂CF₃, —NO₂, —NR′₂, —OR′, or —SiR″₃; wherein each R′ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or —SiR″₃; wherein any one or more R′ radicals is optionally substituted by halogen, or two R′ radicals optionally bond to form a five- or six-membered ring; wherein each R″ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms; wherein two R″ radicals optionally bond to form a five- or six-membered ring;
each of R⁴ and R⁵ is independently C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or five-, six-, or seven-membered heterocyclyl comprising at least one atom selected from N, P, O, and S; wherein each of R⁴ and R⁵ is optionally individually substituted by halogen, —NR′₂, —OR′, or —SiR″₃; wherein R⁴ optionally bonds with R¹, and/or wherein R⁵ optionally bonds with R³, in each case to independently form a five-, six- or seven-membered ring;
each of R⁶ and R⁷ is independently C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O and S; wherein each of R⁴ and R⁵ is optionally individually substituted by halogen, —CF₃, —CF₂CF₃, —CH₂CF₃, —NO₂, —NR′₂, —OR′, or —SiR″₃;
each of R⁸, R⁹, R¹⁰, R¹¹, R¹², R¹³, R¹⁴, R¹⁵, R¹⁶, and R¹⁷ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, alkylaryl where alkyl has from 1 to 10 carbon atoms and aryl has from 6 to 20 carbon atoms, —NR′₂, —OR′, halogen, —NO₂, —SiR″₃ or five-, six-, or seven-membered heterocyclyl comprising at least one atom selected from N, P, O and S; wherein any one or more of R⁸, R⁹, R¹⁰, R¹¹, R¹², R¹³, R¹⁴, R¹⁵, R¹⁶, and R¹⁷ is optionally substituted by halogen, —CF₃, —CF₂CF₃, —CH₂CF₃, —NO₂, —NR′₂, —OR′, or —SiR″₃;
each X is independently fluorine, chlorine, bromine, iodine, hydrogen, C₁-C₂₀-alkyl, C₂-C₁₀-alkenyl, C₆-C₂₀-aryl, arylalkyl where alkyl has from 1 to 10 carbon atoms and aryl has from 6 to 20 carbon atoms, —NR′″₂, —OR′″, —SR′″, —SO₃R′″, —OC(O)R′″, —CN, —SCN, β-diketonate, —CO, —BF₄⁻, —PF₆⁻, or bulky non-coordinating anions, wherein X radicals are optionally bonded with one another; wherein each R′″ is independently hydrogen, C₁-C₂₀-alkyl, C₂-C₂₀-alkenyl, C₆-C₂₀-aryl, arylalkyl where alkyl has from 1 to 10 carbon atoms and aryl has from 6 to 20 carbon atoms, or —SiR″″₃; wherein one or more R′″ is optionally substituted by halogen or nitrogen- or oxygen-containing groups, or two R′″radicals optionally bond to form a five- or six-membered ring; wherein each R″″ is independently hydrogen, C₁-C₂₀-alkyl, C₂-C₂₀-alkenyl, C₆-C₂₀-aryl or arylalkyl where alkyl has from 1 to 10 carbon atoms and aryl has from 6 to 20 carbon atoms; wherein one or more R″″ is optionally substituted by halogen or nitrogen- or oxygen-containing groups, or two R″″ radicals optionally bond to form a five- or six-membered ring;
s is 1, 2, or 3;
D is a neutral donor; and
t is 0, 1 or 2.

21. The process of claim 20, wherein t is 0.

22. The process of claim 20, wherein the second catalyst compound has the following structure:

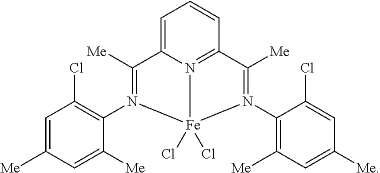

23. The process of claim 1, wherein the mixed catalyst system further comprises a support material.

24. The process of claim 23, wherein the support material is selected from Al₂O₃, ZrO₂, SiO₂, SiO₂/Al₂O₃, SiO₂/TiO₂, silica clay, silicon oxide/clay, or mixtures thereof.

25. The process of claim 1, wherein the at least one activator comprises an alkylalumoxane.
